(19) United States
(12) Patent Application Publication
(10) Pub. No.: US 2022/0331743 A1
(43) Pub. Date: Oct. 20, 2022

(54) BIOFOULING PROTECTION OF ELEVATED VOLUME/VELOCITY FLOWS

(71) Applicant: BioFouling Technologies, Inc., Aberdeen, NC (US)

(72) Inventors: Brian McMurray, Aberdeen, NC (US); Cliff Sharpe, Aberdeen, NC (US); Mike Termini, Palm Beach, FL (US); Emily Ralston, Melbourne, FL (US); Abraham Stephens, Melbourne, FL (US); Jerry Kaster, Milwaukee, WI (US); Lindsey Calcutt, Greenville, SC (US)

(21) Appl. No.: 17/732,333

(22) Filed: Apr. 28, 2022

Related U.S. Application Data
(63) Continuation of application No. PCT/US20/58450, filed on Nov. 1, 2020.
Application No. PCT/US20/58450 is a continuation-in-part of application No. PCT/US20/22782, filed on Mar. 13, 2020.
Application No. PCT/US20/22782 is a continuation-in-part of application No. PCT/US19/59546, filed on Nov. 1, 2019.
(60) Provisional application No. 63/020,826, filed on May 6, 2020.
(60) Provisional application No. 62/817,873, filed on Mar. 13, 2019.
(60) Provisional application No. 62/754,574, filed on Nov. 1, 2018.

(51) Int. Cl. B01D 65/08; B01D 67/00; C02F 1/44

(52) U.S. Cl. CPC B01D 65/08; B01D 67/0088; C02F 1/44; B01D 2321/16; C02F 2303/20

(57) ABSTRACT

Disclosed are devices, methods and/or systems for use in protecting items and/or structures that are exposed to, submerged and/or partially submerged in aquatic environments from contamination and/or fouling due to the incursion and/or colonization by specific types and/or kinds of biologic organisms and/or plants, including the protection from micro- and/or macro-fouling for extended periods of time of exposure to aquatic environments.

### CROSS-REFERENCE TO RELATED APPLICATIONS

This application is a continuation of Patent Cooperation Treaty (PCT) Patent Application No. PCT/US2020/058450 filed Nov. 1, 2020, entitled “BIOFOULING PROTECTION OF ELEVATED VOLUME/VELOCITY FLOWS,” which claims priority to and benefit thereof from U.S. Provisional Patent Application No. 63/020,826 filed May 6, 2020, entitled “BIOFOULING PROTECTION OF ELEVATED VOLUME/VELOCITY FLOWS.” The disclosures of these documents are hereby incorporated by reference herein in their entireties.

This application is a continuation-in-part of Patent Cooperation Treaty (PCT) Patent Application No. PCT/US20/22782, filed Mar. 13, 2020, and entitled “BIOFOULING PROTECTION” which claims priority to and benefit thereof from U.S. Provisional Patent Application No. 62/817,873 filed Mar. 13, 2019, entitled “BIOFOULING PROTECTIVE ENCLOSURES,” and Patent Cooperation Treaty (PCT) Patent Application No. PCT/US19/59546, filed Nov. 1, 2019 and entitled “DURABLE BIOFOULING PROTECTION” which claims priority to and benefit thereof from U.S. Provisional Patent Application No. 62/754,574 filed Nov. 1, 2018, entitled “DURABLE BIOFOULING PROTECTION.” The disclosures of these documents are hereby incorporated by reference herein in their entireties.

### TECHNICAL FIELD

The invention relates to improved devices, systems and methods for use in protecting items and/or structures that are exposed to, submerged in and/or partially submerged in and/or adjacent to aquatic environments that experience elevated velocity and/or high volume flows from contamination and/or fouling due to the incursion and/or colonization by specific types and/or kinds of biologic organisms. More specifically, disclosed are improved methods, apparatus and/or systems for protecting such structures and/or substrates from micro- and/or macro-fouling for periods of time of exposure to the aquatic environments.

### BACKGROUND OF THE INVENTION

The growth and attachment of various marine organisms on structures in aquatic environments, known as biofouling, is a significant problem for numerous industries, including both the recreational and industrial boating and shipping industries, the oil and gas industry, power plants, water treatment plants, water management and control, irrigation industries, manufacturing, scientific research, the military (including the Corps of Engineers), and the fishing industry. Most surfaces, such as those associated with boat hulls, underwater cables, chains and pilings, oil rig platforms, buoys, containment boom systems, fishing nets, piers and docks which are exposed to coastal, harbor or ocean waters (as well as their fresh water counterparts) eventually become colonized by animal species, such as barnacles, mussels (as well as oysters and other bivalves), bryozoans, hydroids, tubeworms, sea squirts and/or other tunicates, and various plant species. Biofouling results from the interaction between various plant and/or animal species with aspects of the substrates to which they ultimately attach, leading to the formation of adhesives that firmly bond the biofouling organisms to substrates leading to biofouling. Despite the appearance of simplicity, the process of biofouling is a highly complex web of interactions effected by a myriad of micro-organisms, macro-organisms and the ever-changing characteristics of the aquatic environment.

The economic impacts of biofouling are of paramount concern for many industries. Aside from biofouling induced corrosion of various surfaces exposed to the aquatic environment, another significant economic consequence of biofouling is the formation of biofouling and/or fouling induced scales on heat exchange surfaces and/or other wetted surfaces in many facilities with water consumptions or water movement. For example, large scale water systems are used in a wide variety of processes, and at their most basic these systems rely on heat transfer from a hotter fluid or gas to a colder fluid or gas, with this heat typically travelling through a “heat transfer surface,” which is often the metallic walls of heat transfer tubing which separate the hot and cold substances. Often, the fluid will comprise water, which in many cases may be salt water drawn from a bay, sea and/or the ocean, fresh water drawn from a river, lake or well/aquifer or wastewater from various sources. Water is a favorable environment for many life forms, and these fouling organisms will often colonize the wetted surfaces of heat transfer tubing, which can significantly reduce heat transfer rates of the system. In many cases, even thin biofilms formed on a heat transfer surface will significantly insulate this surface, reducing its heat transfer efficiency and greatly increasing the overall operating costs for the system.

A wide variety of methods have been used in attempts to halt and/or reduce biofouling build-up in various water systems. One common attempt at ameliorating biofouling is the use of intake filtration, but the large volumes and/or high-water velocities required for raw water intakes typically limit such efforts to filtering out fish and/or larger debris from the water flow. In addition to filtering, most water systems, especially water systems, treat the raw water flow with some form of oxidizing biocide or other additives, most commonly bleach but also possibly gaseous chlorine, bleach/sodium bromide, chlorine dioxide, monochloramine, and monobromamine. In addition to the high cost of purchasing and/or operating such systems, such caustic substances (which may be strong oxidizing agents in the case of chlorine) can cause deleterious effects far beyond their intended environment of use (i.e., once released they can damage organisms in the surrounding aquatic environment), and many of these substances can enhance corrosion and/or degradation of the very items or related system components they are meant to protect. An additional problem at many facilities, and particularly in the power generation industry, is that regulations developed for and by the United States Environmental Protection Agency (USEPA) typically allow no more than 0.2 ppm free available chlorine average residual for 2 hours per day as “Best Available Technology.” For plants so constrained, treatment is only allowed for less than 9 percent of any day, thus giving microbes and/or other fouling elements a chance to settle, colonize and form protective biofilm layers. Similar limits and/or safety concerns exist for many other toxins and/or chemicals that may be added to such water in attempts to limit fouling within the water system.

In many instances, industries will simply accept that fouling and/or scale formation is bound to occur within their water supply systems, and these industries will expect to bypass and/or remove the affected system(s)/subsystem(s) from service on a regular basis to clean, repair and/or otherwise address the effects of the fouling and/or scale formation. For example, water flow in a given supply system may be halted and/or reversed, with toxic and/or caustic agents injected into the system to desirably kill and/or remove some of the fouling organisms and/or other blockages. In various instances, cleaning and/or replacement of various components, such as valves, sensors, heat exchanger tubing and/or other components may be accomplished. Obviously, such activities can be quite expensive, labor intensive, time consuming and/or result in damage to fouled surfaces, and such actions may also require the business to purchase additional system resources (i.e., excess capacity) to accommodate system/subsystem down-time during such evolutions.

Therefore, there exists a need for improved devices, systems and methods that eliminate or reduce the amount of biofouling on surfaces exposed to an aquatic environment.

### SUMMARY OF THE INVENTION

The various inventions disclosed herein include the realization of a need for improved methods, apparatus and/or systems for protecting structures and/or substrates from micro- and/or macro-fouling for extended periods of time of exposure to aquatic environments, including in situations where it may be impractical, impossible and/or inconvenient to completely isolate an exposed substrate or other structure from the presence of fouling organisms and/or other effects within an aqueous environment. This could include both water flow-through and closed loop situations where environmental water in an aqueous environment is being circulated, consumed and/or being utilized (i.e., for water and/or distilled for fresh water), and/or situations where a sensor or other device is being utilized to record and/or sample the surrounding aqueous environment.

The various inventions disclosed herein further include the realization that a completely sealed environment and/or aqueous fluid “loop” which fully isolates a substrate from a surrounding aqueous environment may not adequately protect a substrate from a variety of negative effects of the aqueous environment, in that the “protected” substrate might suffer corrosion or other effects stemming from anoxic, acidic and/or other conditions (and/or other conditions relating to such surroundings, such as the actions of microbially induced corrosion) that may develop within a fully sealed enclosure and/or in proximity to the substrate. Accordingly, optimal protection of the substrate may be provided by an enclosure or similar device which “pretreats” or “treats” intake and/or recirculated water within the aqueous environment at a location somewhat “upstream” from a substrate to be protected.

In various embodiments, an anti-biofouling enclosure, filtration media, dosing device, pretreating device, mixing device and/or similar devices is described which can be positioned upstream from and/or otherwise in the proximity of a substrate or other object to enclose, protect, filter, segregate, separate, insulate, protect and/or shield the substrate from one or more features or characteristics of the surrounding aqueous environment, including the employment of various of the embodiments described in co-pending Patent Cooperation Treaty (PCT) Patent Application Serial No. PCT/US20/22782, filed Mar. 13, 2020 and entitled “BIOFOULING PROTECTION, and co-pending Patent Cooperation Treaty (PCT) Patent Application No. PCT/US19/59546, filed Nov. 1, 2019 and entitled “DURABLE BIOFOULING PROTECTION,” the disclosures of which are each incorporated by reference herein in their entireties. More specifically, various embodiments of enclosures, filtration media, dosing devices, pretreatment, and/or mixing devices will desirably interact with water and/or other aqueous fluid passing through and/or in proximity to the device(s), desirably serving to alter the water in various ways, optionally including filtration and/or screening of some fouling organisms from the fluid flow while potentially altering water chemistry and/or optionally applying various amounts of a biocide and/or other substance(s) directly to and/or in the proximity of any fouling organisms that may pass through the device. In various embodiments, the activities of the device may protect downstream substrates from direct biofouling by some varieties of micro and/or macro agents as well as, in at least some instances, promoting the formation of a relatively durable “artificial” surface biofilm, coating or layer on one or more substrates which can potentially inhibit, hinder, avoid and/or prevent the subsequent settling, recruitment and/or colonization of the substrate surface by unwanted types of biofouling organisms for extended periods of time, even in the absence of the device.

In various embodiments, the disclosed enclosure systems can desirably alter environmental conditions within a “protected” aqueous environment to inhibit and/or prevent a variety of biofouling organisms from settling and/or colonizing various substrate surfaces within the aqueous environment. In some embodiments, the enclosure systems can include features that alter type, quantity and/or “mix” of various biofilm producing organisms within the protected environment to reduce the thickness, speed and/or extent of biofilm formation, as well as potentially alter the biofilms formed thereby (for example, reducing the speed of film formation and/or forming a biofilm with minimal thermally insulative qualities), including changes in substrate biofilm composition, thickness, and structural integrity. Exemplary embodiments can include alterations to the aqueous environment to inhibit and/or prevent larvae and/or small organisms from being able to settle of substrate surfaces and/or reduce or retard such settlement. In various alternative embodiments, features of the disclosed enclosures can control and/or alter the volume of water flow and/or dwell time of water within certain regions of the protected aqueous environment, can include components that act as flow restrictors and/or flow directors, can include a fibrous matrix media that induces mixing and/or laminar/non-laminar flows of fluid within the aqueous environment, including within the fibrous media itself and/or within or between individual pores of the fibrous media (including turbulent flow, laminar flow and/or various combination thereof), can optionally include one or more biocide or other chemical/material dosing apparatus and/or components providing controlled biocide release profiles, including water soluble or degradable resins which encapsulate a biocide that is released as water flows through the dosing apparatus. In some embodiment, fibrous media may be utilized that can filter and/or shield the protected aquatic environment from larger organisms, as well as potentially preventing organisms from blocking or “clogging” various components of the enclosure system, including the fibrous matrix media itself.

In various embodiments of enclosures, filtration, dosing and/or mixing devices, the system components will desirably incorporate openings, voids and/or fenestrations that allow an amount of water or other aqueous fluid into the water system from an external aqueous environment, and in some embodiments the system may alter the water chemistry and/or turbidity of the liquid passing through the device and/or that is resident within the water system, potentially leading to differing levels of clay, silt, finely divided inorganic and organic matter, algae, soluble colored organic compounds, chemicals and compounds, plankton and/or other microscopic organisms suspended in the liquid within the aqueous fluid system as compared to those of the open aqueous environment that may be the fluid source (i.e., before passing through the device)—levels of which might contribute in various ways to varying levels of fouling and/or corrosion (and/or lack of fouling and/or corrosion) of the different substrates contained within the system.

In various embodiments, the devices described herein act to produce at least a partially “filtered,” “treated,” “dosed” and/or “differentiated” aquatic environment within a water supply system, with various water system components including enclosures, boundary walls, valves, heat exchangers, sensors and/or other devices within the system and in contact with the aqueous medium that may be considered “substrates” and/or surfaces to potentially be protected. Desirably, the devices described herein have a potential to cause various surfaces and/or system components to become unfavorable for settlement and/or recruitment of aquatic organisms that contribute to various types of biofouling (which may include surfaces that create “negative” settlement cues as well as surfaces that may be devoid of and/or present a reduced level of “positive” settlement cues for one or more types of biofouling organisms). The devices(s) and/or other constructs described in the various embodiments herein can also desirably filter, reduce and/or prevent many marine organisms that contribute to biofouling from entering the water system and/or inhibit these organisms from contacting and/or colonizing the submerged and/or partially submerged surfaces of a given substrate.

In various embodiments, an antifouling device can include a permeable, formable matrix and/or structure material, which in at least one exemplary embodiment can comprise a woven polyester structure made from spun polyester yarn. In at least one further embodiment, the employment of a spun polyester yarn could desirably increase the effective surface area and/or fibrillation of the structure material on a minute and/or microscopic scale, which can desirably (1) lead to a significant decrease in the “effective” or average size of natural and/or artificial openings extending through the structure, (2) decrease the amount and/or breadth of “free space” within openings through and/or within the structure, thereby potentially reducing the separation distance between microorganisms (within the inflowing/outflowing liquids) with surfaces of the structure, and/or (3) alter and/or induce changes in the water quality downstream from the device in various ways. The decreased average opening size of the structure will desirably increase “filtration” of the liquid to reduce and/or prevent various biologic organisms and/or other materials from freely passing through the structure as well as often increase the “dwell time” within the structure for a subset of the organisms that may eventually work their way through the structure, as well as significantly reduce the overall volume of water within a given local area and/or set of pores or other openings within the structure. These factors will desirably result in significant reductions or metering in the size and/or viability of micro- and macro-organisms (as well as various organic and/or inorganic foulants and/or other compounds) passing into/out of the walls of the structure. Moreover, these aspects will also desirably reduce the quantity, extent and/or speed of biofouling or other degradation that may occur on the fibrous matrix material itself and/or within the opening(s) therein, desirably preserving the flexibility, permeability and/or other properties of the structure of the enclosure for an extended period of time.

In some embodiments, at least a portion of the structure walls of the enclosure can be fenestrated and/or perforated to a sufficient degree to allow some amount of liquid and/or other substance(s) to pass and/or “filter” through the walls of the media in a relatively controlled and/or metered manner (i.e., from the external or “open” aqueous environment to a water system located “downstream” from the enclosure), which may include the creation of a “differentiated” aqueous environment located downstream from the enclosure but “upstream” from the water system to be protected. The movement of liquid and/or other compositions from the open environment to the differentiated aqueous environment, and subsequent movement of water from the differentiated aqueous environment to and/or through an intake of the water system, may desirably (in combination with various natural and/or artificial processes) induce, facilitate and/or create a relatively “different” or dynamic “artificial” environment within the “differentiated” aqueous environment, specifically having different characteristics in many ways from the dynamic characteristics of the surrounding aqueous environment, which desirably renders the differentiated environment “undesirable” for many biofouling organisms and thereby reducing and/or eliminating biofouling from occurring within and/or immediately downstream of the enclosure. In addition, the presence of numerous small perforations in the walls of the enclosure can desirably provide for various levels of filtration of the intake and/or exchange liquid(s), which can potentially reduce the number and/or viability of organisms entering the differentiated aqueous environment via wall pores as well as negatively affect organisms within and/or outside of the enclosure that may pass proximate to the media walls.

In various embodiments, the presence of the enclosure and any optional openings and/or perforation(s) therethrough may create an “enclosed” or “partially enclosed” aqueous environment downstream from the enclosure that may be less conducive to micro and/or macro fouling of substrates therein than the surrounding aqueous environment, which might include the existence and/or presence of biofilm local settlement cues within the “differentiated” aqueous environment that are at a lower positive level than the biofilm local settlement cues of the surrounding aqueous environment. Desirably, the enclosure and/or other components of the system may create “differences” in the composition and distribution of various environmental factors and/or compounds within the “differentiated” aqueous environment and/or the water system as compared to similar factors and/or compounds within the surrounding open aqueous environment, with these “differences” inhibiting and/or preventing significant amounts of biofouling from occurring (1) on the surface of any protected substrates, (2) on the inner wall surfaces of the enclosure, (3) within the interstices of openings and/or perforations in the walls of the enclosure and/or (4) on the outer wall surfaces of the enclosure. In some embodiments, the enclosure and/or other system components may create a gradient of settlement cues within the “differentiated” aqueous environment that induces and/or impels some and/or all of the micro and/or macro fouling organisms to be located somewhat distal to any protected substrates, while in other embodiments the enclosure and/or other system components may create a microenvironment proximate to one or more protected substrates which is not conducive to biofouling and/other degradation of the substrate. In still other embodiments, enclosure and/or other system components may be positioned proximate to and/or in directly upstream from substrate components, such as being directly adjacent to the inlet of a heat exchanger and/or heat exchange tubing within a water system, and still provide various of the protections described herein.

In various embodiments, an enclosure may comprise a plurality of fibrous matrix media having smaller openings, perforations and/or pores in the structure, as well as one or more larger openings such as an open bottom and/or top (or portions thereof) as well as various openings on the sides of a water Inlet. In various embodiments, a “large” opening can be defined as an opening in the enclosure that comprises as least 10% or greater of the surface area of the external surface area of the enclosure walls of a system, while in other embodiments a large opening may comprise areas that are 2% or greater, 5% or greater, 15% or greater, 20% or greater, 25% or greater, 30% or greater, 35% or greater and/or 40% or greater than the surface area of the external surface area of the enclosure walls. In various other embodiments, a plurality of relatively smaller openings (i.e., 0.25% to 2% of the surface area of the external surface area of the enclosure walls) may be somewhat equivalent in function and/or structure to one or more of the larger openings described herein.

In various of the disclosed embodiments, the unique protected environment within the aqueous environment downstream from the disclosed systems may induce a unique quantity and/or diversity of bacteria and/or other microorganisms within the protected water system that may induce or promote the formation of one or more biofilm(s) within the water system, wherein such biofilms may be “less tenaciously attached” to the substrate than biofilms normally encountered in unprotected environments. Such biofilms may facilitate the removal and/or “scraping off” of fouling organisms from the substrate and/or from intermediate biofilm layers. In such cases, the microflora and/or microfauna may comprise different phyla (i.e., different bacteria and/or cyanobacteria and/or diatoms) from those located in natural or untreated aqueous environments. In some embodiments, the resulting biofilms may be thinner or contain a compromised structural integrity. In some alternative embodiments, moving water in a pumping situation, depending upon the water volume and/or speed, may only permit the formation of more tenacious biofilms than in more quiescent or static environments, with these tenacious biofilms optionally may not contain especially inductive strains and/or may lack sufficient physical supporting structure and thickness as compared to more inductive naturally occurring biofilms.

In some embodiments of the present invention, some or all of the biofouling protections and/or effectiveness described herein for a protected substrate can desirably be provided by the enclosure and its permeable, formable matrix, fibrous matrix and/or structure wall materials without the use of various supplemental anti-biofouling agents, while in other embodiments the enclosure could comprise a permeable, formable fibrous matrix and/or structure wall material which incorporates one or more biocidal and/or antifouling agents into some portion(s) of the wall structure and/or coatings thereof. In some embodiments, the biocidal and/or antifouling agent(s) could provide biofouling protection for the walls and/or components of the system itself (with the enclosure providing a level of biofouling protection for the downstream substrate), while in other embodiments the biocidal and/or antifouling agent(s) might provide some level of biofouling protection for the substrate itself as well, while in still other embodiments the biocidal and/or antifouling agent(s) could provide biofouling protection for both the enclosure and substrate, and/or various combinations thereof.

In at least one exemplary embodiment, an enclosure can comprise a plurality of replaceable, modular components formed from a permeable, formable fibrous matrix of polyester material made from spun polyester yarn, which can be coated on at least one side (such as an externally facing surface of the enclosure) with a biocidal compound or coating or paint containing a biocidal agent, wherein at least some of the biocide compound penetrates at least a portion of the way into the body of the material. In at least one further embodiment, the employment of a ring spun polyester yarn could desirably increase the effective surface area and/or fibrillation of the structure material on a minute and/or microscopic scale, which can desirably (1) lead to a significant decrease in the average size of natural openings extending through the structure and/or (2) decrease the amount and/or breadth of “free space” within openings through and/or within the structure, thereby potentially reducing the separation distance between microorganisms (within the inflowing/outflowing liquids) and the biocide coating(s) resident on the structure. The decreased average opening size of the structure in such embodiments will desirably increase “filtration” of the liquid to reduce and/or prevent various biologic organisms and/or other materials from entering the enclosed or bounded environment, while the reduced “free space” within the opening(s) will desirably increase or amplify the effects of the biocide on organisms passing through the enclosure (including an increased potential for direct contact to occur between the biocide and various organisms) as they pass very close to the biocidal coating. These factors will desirably result in significant reductions in the size and/or viability of micro- and macro-organisms (as well as various organic and/or inorganic foulants) passing into the enclosure. Moreover, the presence of biocide coating(s) and/or paint(s) and/or additive(s) on and/or in the structure of the enclosure will desirably significantly reduce the quantity, extent and/or speed of biofouling or other degradation that may occur on the enclosure material itself and/or within the opening(s) therein, desirably preserving the flexibility, permeability and/or other properties of the structure of the enclosure for an extended period of time.

In some embodiments and/or some aqueous environments, the presence of an optional biocide coating on at least the outer surface of the flexible material will desirably reduce the thickness, density, weight and/or extent of biofouling and/or other degradation experienced on and/or within openings within the enclosure itself, which will optimally extend the useful life of the enclosure in its desired position upstream from the substrate. In many situations, biofouling of various components of an enclosure may significantly increase the weight and/or stiffness of the components, which can damage the enclosure, the enclosure and/or structures attached to the enclosure (which may include portions of the substrate itself), as well as adversely affect the buoyancy of the enclosure and/or any objects attached thereto. In addition, biofouling of the enclosure components can reduce the flexibility and/or ductility of various structure components, which can cause and/or contribute to premature ripping and/or failure of the structure and/or related attachment mechanisms. Moreover, biofouling formation on/within the enclosure can potentially “clog” or diminish the size of and/or close openings through and/or within the enclosure structure, which can potentially alter the permeability in an undesirable manner and/or inhibit the ability of intake water to flow freely through the enclosure.

In at least one embodiment, an antifouling enclosure may include a plurality of replaceable modules, which may include modular filtration and/or dosing elements of the same or different sizes, shapes, thicknesses and/or biocidal (or other material) coatings, including the use of biocide coated filter modules in some locations and uncoated filter modules in other locations of the system. Similarly, some modules may comprise a biocide coating which initially elutes and/or otherwise dispenses for a limited period of time after initiation of fluid flow, where the period of time is sufficient to allow the water system and/or upstream reservoir section to develop a differentiated environment, wherein the differentiated environment can generate various inhibitory substances to provide subsequent biofouling protection to the substrate after the initial biocide elution has dropped to lower and/or ineffective levels and/or has ceased eluting or dispensing.

### BRIEF DESCRIPTION OF THE SEVERAL VIEWS OF THE DRAWINGS

The foregoing and other objects, aspects, features, and advantages of embodiments will become more apparent and may be better understood by referring to the following description, taken in conjunction with the accompanying drawings, in which:

FIG. 1A depicts one exemplary embodiment of an antifouling system which includes an antifouling enclosure and/or structure;

FIG. 1B depicts a perspective view of a raceway in the antifouling system of FIG. 1A;

FIG. 2A depicts a series of exemplary raceways and associated components;

FIG. 2B depicts a side perspective view of one exemplary raceway of FIG. 2A;

FIG. 3 depicts a perspective view of an exemplary module or structure for use with various antifouling systems disclosed herein;

FIGS. 4A and 4B depict components of exemplary antifouling systems that incorporate deployable antifouling sheets or similar components;

FIG. 5 depicts another exemplary embodiment of an antifouling system utilizing sea and/or fresh water as a source of cooling fluid or other water source;

FIGS. 6A and 6B depict another exemplary embodiment of a system to reduce biofouling and facilitate the utilization of seawater, fresh water, brackish water, or some other aqueous liquid for various industrial purposes;

FIG. 7A depicts a perspective view of one exemplary embodiment of a natural or artificial reservoir or pond for use as a water source for once-through cooling or recirculating cooling systems.

FIG. 7B depicts one exemplary embodiments of a biofouling protection systems incorporating various arrangements of enclosure walls and/or other components for use with the reservoir of FIG. 7A;

FIG. 7C depicts another exemplary embodiments of a biofouling protection systems incorporating various arrangements of enclosure walls and/or other components for use with the reservoir of FIG. 7A;

FIG. 7D depicts another alternative embodiments of a biofouling protection systems incorporating various arrangements of enclosure walls and/or other components for use with the reservoir of FIG. 7A;

FIG. 8 depicts a perspective view of another exemplary embodiment of a system for protecting a water supply system from various biofouling effects which incorporates a wall structure having a plurality of layers;

FIG. 9 depicts one exemplary embodiment of a biofouling inhibition system which includes a supplemental pumping system for adding and/or removing aqueous liquids and/or other materials or substances to/from a reservoir;

FIG. 10A depicts a scanning electron microscope micrograph of an exemplary spun yarn for use in a fabric media;

FIG. 10B depicts a cross-sectional view of a central body of the yarn of FIG. 10A;

FIG. 10C depicts an enlarged view of a knit fabric comprising PET spun yarn;

FIG. 11A depicts an exemplary rolled sheet fabric for use in various antifouling enclosure designs;

FIG. 11B depicts one exemplary embodiment of a rolled-up sheet fabric that incorporates adhesive, hook-and-loop fastener material;

FIG. 12 depicts a cross-sectional view of one exemplary embodiment of a permeable structure with various pore openings and passages extending from a front face to a back face of the structure, with a biocide coating penetration at least partially into the fabric and pores thereof;

FIG. 13A depicts another exemplary embodiment of an uncoated polyester woven fabric;

FIG. 13B depicts the embodiment of 13A coated with a biocide coating;

FIG. 14A depicts a natural uncoated burlap fabric;

FIGS. 14B and 14C depict the fabric of FIG. 14A coated with a solvent based biocidal coating and a water based biocidal coating;

FIG. 15A depicts an uncoated polyester fabric;

FIG. 15B depicts the fabric of FIG. 15A coated with a biocidal coating;

FIG. 15C depicts an uncoated spun polyester fabric

FIG. 15D depicts the fabric of FIG. 15C coated with a biocidal coating;

FIG. 15E depicts an uncoated spun polyester cloth;

FIG. 15F depicts an uncoated side of the spun polyester cloth of FIG. 15E after coating;

FIG. 16 depicts a series of experimental raceways were constructed to determine the antifouling effects of various system embodiments in channeling various amounts of filtered, preconditioned and/or dosed environmental water;

FIGS. 17A through 17D depicts fouling effects of various substrates after seven days of immersion in the experimental raceways of FIG. 16;

FIG. 18 depicts a top down view of raceway fouling after seven days of immersion in the experimental raceways of FIG. 16;

FIG. 19 is a top down schematic view of the pump and tubing configuration of additional experimental raceways;

FIG. 20A depicts a top down view of raceway fouling after thirty days of immersion in the experimental raceways of FIG. 19;

FIG. 20B depicts perspective views of some of the additional experimental raceways of FIG. 19, including views of raceway fouling accumulation on various spillways;

FIG. 21A through 21D depicts views of biofouling accumulation on the control, protected (i.e., treated water), standard, and large raceways of FIG. 19;

FIG. 22A is a tabular view of dimensions and waterflow characteristics of the raceways of FIG. 19 during initial operation in early March;

FIGS. 22B through 22D are tabular views of chemistry characteristics for ambient water and the raceways of FIG. 19 for various sampling time periods;

FIGS. 22E and 22G are tabular views of various types and amount of biofouling on substrates within the raceways of FIG. 19 after 30 days of immersion;

FIGS. 22F and 22H are tabular views of various types and amount of biofouling on substrates within the raceways of FIG. 19 after two months of immersion;

FIG. 23 depicts another exemplary embodiment of a protective pumping system for adding and/or removing aqueous liquids and/or other materials or substances to or from a reservoir or tank;

FIG. 24A through 24D depict different fouling accumulation on various substrates after 2 months of immersion;

FIGS. 25A through 25D depict biofouling on an unprotected control pump and various associates components, a standard pump and raceway, a fast pump and raceway and a large pump and raceway after 2 months of immersion;

FIGS. 26A and 26B depict tabular views of various dimensions and performance characteristics of the raceways in the exemplary test setup;

FIG. 27 depicts one exemplary embodiment of folded or corrugated complex fabric structures such as undulating and/or accordion-like fabric surfaces which can dramatically increase the surface area and/or potentially alter a filtering ability of an antifouling enclosure.

FIG. 28 depicts an alternative antifouling unit including a plurality of fibrous structure modules in parallel to a fluid flow, which allows for the use of multiple modules for a single flow of water;

FIG. 29 depicts a top schematic view of another enclosure test, examining the preconditioning of water using multilayers of enclosures, including one layer of enclosure, two layers of enclosures and three layers of enclosures; and

FIG. 30 depicts another experimental test in which metal chains with various protective enclosure arrangements were suspended from a dock and/or barge at Cape Marina.

### DETAILED DESCRIPTION OF THE INVENTION

The disclosures of the various embodiments described herein are provided with sufficient specificity to meet statutory requirements, but these descriptions are not necessarily intended to limit the scope of the claims. The claimed subject matter may be embodied in a wide variety of other ways, may include different steps or elements, and may be used in conjunction with other technologies, including past, present and/or future developments. The descriptions provided herein should not be interpreted as implying any particular order or arrangement among or between various steps or elements except when the order of individual steps or arrangement of elements is explicitly described.

Disclosed herein are a variety of simple-to-assemble and/or use systems and/or devices which may be utilized in proximity to, around, within, on top of and/or below a substrate or other object that is located within (or that is placed within) an aqueous environment or aqueous holding tank that is susceptible to biofouling. In various embodiments, systems, devices and methods are disclosed that can protect a submerged and/or partially submerged substrate or other object (or portions thereof) from the effects of aqueous biofouling, including the creation and potential retention of biofouling resistance by the substrate for some extended period of time after various system components may be depleted and/or removed.

In various embodiments, the disclosed systems can utilize structures or enclosure components formed from relatively inexpensive and readily available materials such as polyester, nylon or rayon structures and/or natural materials such as cotton, linen or burlap structures (or various combinations thereof). Structures may be naturally or engineered to degrade over time, specifically degrade within the useful life of the structure or within any time before the useful life of the structure. In some embodiments, at least one active ingredient and/or biocide may be added on the surface of the structure or incorporated within the structure or enclosure. In non-limiting examples, the biocide may be incorporated within the polymer blend, fibers, filaments, yarns and/or yarns bundles of the structure with any process commonly known to one skilled in the art. In various embodiments, modular components of the system could be removeable and/or replaceable to allow the system to function indefinitely as a biofouling inhibitor, which in some embodiments may potentially include replaceability of some system components during normal operation of the system.

In various embodiments disclosed herein, the terms “differentiated aqueous environment,” “local aqueous environment” and/or protected or processed environment are meant to broadly encompass some and/or all of the intake water which may have passed through an antifouling enclosure and/or which may have been or will be altered due to the antifouling system's impact and/or presence, which may include one or more of the following (and/or any combinations thereof): 1) any water that has already passed through an enclosure or other component of the system, 2) any water within any pores or spaces between the inner and outer surfaces of the enclosure (i.e., “entrained” within the fibrous matrix), and/or 3) any water immediately proximate to an outer surface of the enclosure. In various embodiments, “aqueous water can refer to salt or marine water, fresh water and brackish water.

While in some embodiments an entire volume of intake water may pass through the antifouling system, in some alternative applications only a portion of an intake volume of water may pass through the antifouling system. In various embodiments, the “treated” or “differentiated” aqueous environment will desirably be positioned “downstream” of the antifouling system, such as within the interior piping of the water supply system and/or within the walls of water storage tanks, where the interior walls of the tank might constitute the “substrate” to be protected, and some or all of water being pumped from an external environmental source such as a stream, lake, well, harbor or reservoir constituting an “open aqueous environment” from which the substrate is sought to be protected.

In various embodiment, an antifouling system such as described herein may be utilized to provide biofouling protection to a protected substrate on a periodic basis, which may include an interruption of biofouling protection on occasions when waterflow proximate to the protected substrate may be increased, decreased and/or some other waterflow changes are desired (including cross-flow and/or reverse flow or “backwash” of fluid through a component or element of the antifouling system), with biofouling protection potentially resuming at time periods where waterflow proximate to the protected substrate has resumed at a “normal” or desired level (which may be the same or different from the pre-change waterflow level). Such an occasion could include a need for substantial levels of cooling and/or other water beyond the capacity of the system, which may reduce and/or obviate some or all of the biofouling protection provided by the system during the increased flow time period(s), but which may provide resumption of biofouling protection once the waterflow rate has reduced below a predetermined design threshold.

In at least one exemplary embodiment, an antifouling system design can be provided having particular utility as an anti-biofouling system for systems that use sea and/or fresh water as a source of water. In this embodiment, a floating or partially/fully submerged enclosure or “reservoir” in the aqueous environment can be provided, with the enclosure encompassing a larger amount of aqueous fluid than may be immediately required by the system on a normal use basis. The disclosed system may be positioned at a water inlet for the reservoir to desirably draw water through the enclosure into reservoir. During the time it takes for the bulk water molecules and/or droplets to transit through the water column within the reservoir, natural and/or artificial processes within the water column may desirably alter the water chemistry of the water within the reservoir (such as, for example, reducing a dissolved oxygen level in the water), such that at least one water chemistry factor has been increased and/or depleted prior to traveling to an inlet for the water system.

In at least one exemplary embodiment, a method for determining an appropriate design, size, shape and/or other features of a system can be utilized to determine a recommended minimum enclosed or bounded volume and/or water exchange rate to desirably reduce and/or eliminate biofouling downstream from the system. In some embodiments, such as in a membrane filter configuration, where the system may be utilized to provide a water source and/or other source water for a manufacturing plant (i.e., a power plant, a desalination plant, a refinery and/or other manufacturing facility), the disclosed methods can potentially be utilized to reduce and/or eliminate biofouling within the water and/or other conduits of the plant, and in some embodiments without the need for additional filtration and/or microfiltration of the water. In various embodiments, an enclosure or similar system can include a plurality of modular panels, wherein one or more of the panels can be replaced when desired. In some embodiments, the panels may be replaced while the system is in normal operation.

In various embodiments, the design and use of the system, under certain conditions, can potentially promote, induce and/or impel the formation of a layer, biofilm and/or deposit of material on the substrate and/or the system walls that reduces, repels, inhibits and/or prevents micro and/or macro organisms from subsequently attempting to colonize, recruit and/or foul some or all of the protected substrate (i.e., providing some level of “biofouling inoculation” to the substrate). For example, various embodiments of the system disclosed herein can cause the generation of a unique aqueous environment within the water system, resulting in the creation of a unique mixture of microbes and/or microflora within the environment, including within one or more aqueous layers proximate to the surface of the substrate. In many embodiments, the unique mix and/or distribution of microbes/microflora within the water system can induce and/or influence the creation of a microbial biofilm or other layer on the substrate which, in combination with various surface bacteria, may release compounds that affect the settlement, recruitment and/or colonization of fouling organisms on the substrate. In various embodiments, once the unique microbial biofilm layer is established, this layer may remain durable and/or may maintain its signature and/or self-replenishing which, in the absence of the system (i.e., where the system components may be removed and/or damaged, either temporarily and/or permanently) and could continue to protect the substrate from certain types and/or amounts of biofouling for extended periods of time. In various embodiments, the biofilm may contain different compositions and may have differing structural integrities, thicknesses, etc., based on (among other things) local environmental conditions including temperature, salinity, chemical composition, season of the year, type of protected substrate and/or the type of biofouling organisms from which the substrate is to be protected.

In various embodiments, chemicals and/or compounds that affect the settlement, recruitment and/or colonization of fouling organisms on the substrate could include toxins and/or biocides, as well as chemicals and/or compounds that deter such settlement, recruitment and/or colonization, as well as chemicals and/or compounds that may be void of positive settlement, recruitment and/or colonization cues, as well as chemicals and/or compounds that may produce a lower level of positive settlement, recruitment and/or colonization cues than those produced on surfaces within the surrounding aqueous environment and/or as compared to chemicals and/or compounds that produce positive settlement, recruitment and/or colonization cues for beneficial organisms (for example, organisms that may not be generally considered significant biofouling organisms). In some embodiments, it may be the lack of certain “welcoming cues” on the protected substrate and/or associated biofilm that may provide extended fouling protection for the substrate. In various embodiments, “welcoming cues” might encompass nutrients and/or chemicals that micro and/or macro flora require, desire and/or that facilitate settlement, recruitment, colonization, growth and/or replication on a given surface, and such “deterrence cues” may include waste metabolites and/or other chemicals that inhibit, deter and/or prevent micro and/or macro flora from settling, recruiting, colonizing, growing and/or replicating on a given surface.

A distinction can often be made among ‘microfouling’ (often referred to as ‘slime’) due to unicellular microorganisms such as bacteria, diatoms and protozoa, which form a complex biofilm; ‘soft macrofouling’ comprising macroscopically visible algae (seaweeds) and invertebrates such as soft corals, sponges, anemones, tunicates and hydroids; and ‘hard macrofouling’ from shelled invertebrates such as barnacles, mussels and tubeworms. Moreover, it is often possible that a given biocide or biocide dosing level may have differing effectiveness on juvenile and adult members of the same species, as well as differing effectiveness based on a host of water chemistry factors, including pH, dissolved oxygen levels, water temperature and/or many other factors.

In various embodiments, an inhibition of fouling can be represented by a reduction in total cover of the substrate and/or the enclosure surface(s)/interstices by fouling organisms, compared to the total fouling cover of a substantially similar substrate (without a protective enclosure) submerged and/or partially submerged in a substantially similar aquatic environment. This reduction in fouling could be a 10% reduction in fouling or greater, a 15% reduction in fouling or greater, a 25% reduction in fouling or greater, a 30% reduction in fouling or greater, a 40% reduction in fouling or greater, a 50% reduction in fouling or greater, a 60% reduction in fouling or greater, a 70% reduction in fouling or greater, an 80% reduction in fouling or greater, a 90% reduction in fouling or greater, a 95% reduction in fouling or greater, a 98% reduction in fouling or greater, a 99% reduction in fouling or greater, a 99.9% reduction in fouling or greater, and/or a 99.99% reduction in fouling or greater. Alternatively, the inhibition of fouling on the protected article(s) could be represented as a percentage of the amount of fouling cover and/or fouling mass (i.e. by volume and/or weight) formed on an equivalent unprotected substrate. For example, a protected article could develop less than 10% of the fouling cover of an unprotected substrate (such as where the protected substrate develops a fouling cover less than 0.1″ thick, and the unprotected equivalent substrate develops a 1″ thick or greater fouling cover), which would reflect a more than tenfold reduction in the fouling level of the protected substrate and/or enclosure walls as compared to the fouling level of the unprotected substrate. In other embodiments, the protected article could develop less than 1% fouling, or a more than one hundredfold reduction in the fouling level of the protected substrate and/or enclosure walls. In still other embodiments the protected article could develop less than 0.1% fouling, which is more than a thousand-fold reduction in the fouling level of the protected substrate and/or enclosure walls. In even other embodiments of the present invention, the protected substrate and/or walls of the system components may have no appreciable fouling in any affected area(s) of the substrate and/or enclosure walls, which could represent a 0.01% (or more) or even 0% fouling level of the protected substrate and/or enclosure as compared to an unprotected substrate (i.e., greater than a ten thousand fold reduction in the fouling level of the protected substrate and/or enclosure walls—or more). ASTM D6990 and the Navy Ship Technical Manual (NSTM) are known reference standards and methods used for measuring the amounts of fouling percent coverage and fouling thickness on a substrate.

In various additional embodiments, an inhibition of fouling can be represented by a reduction in total cover increase of both the substrate and the surfaces of the system components by fouling organisms, compared to the total increase in fouling cover of a substantially similar substrate (i.e., without a protective enclosure) submerged and/or partially submerged in a substantially similar aquatic environment, which could be measured by visual inspection, physical measurement and/or based on an increased weight and/or volume of individual components and/or the combined substrate and enclosure (i.e., with the increased weight due to the weight of the fouling organisms attached thereto) when removed from the aqueous medium. This reduction in fouling could be a 10% reduction in fouling or greater, a 15% reduction in fouling or greater, a 25% reduction in fouling or greater, a 30% reduction in fouling or greater, a 40% reduction in fouling or greater, a 50% reduction in fouling or greater, a 60% reduction in fouling or greater, a 70% reduction in fouling or greater, an 80% reduction in fouling or greater, a 90% reduction in fouling or greater, a 95% reduction in fouling or greater, a 98% reduction in fouling or greater, a 99% reduction in fouling or greater, a 99.9% reduction in fouling or greater, and/or a 99.99% reduction in fouling or greater. In various embodiments, exemplary weight increases may be determined in a wetted and/or dried state (or other humidity level), which may significantly affect the degree of total weight change for a given system design, especially where soft bodied fouling organisms and/or biofilms and their effects are being analyzed and compared.

Protective Systems and Structure Enclosure

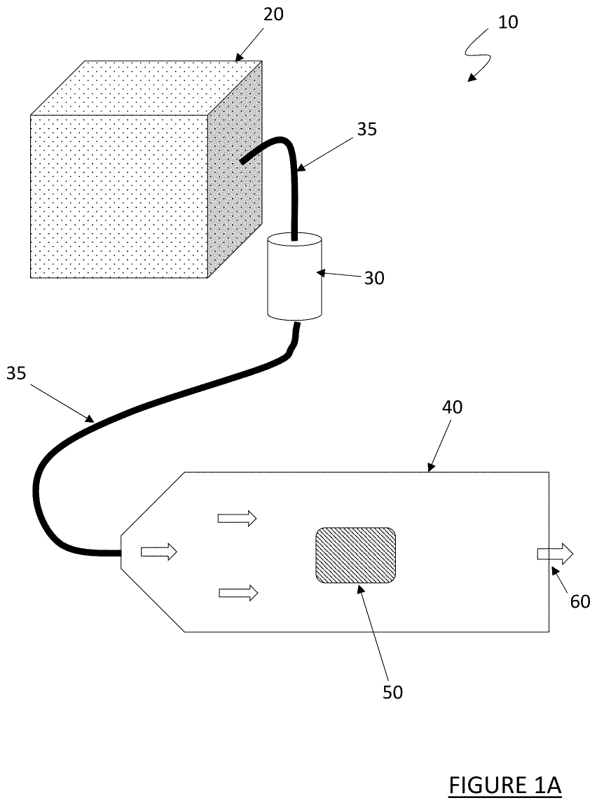

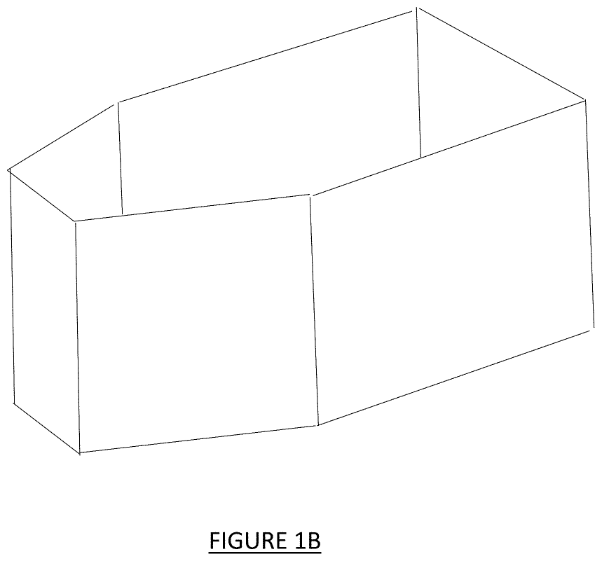

In various embodiments, the disclosed systems and/or system components will desirably alter the natural activity of biofouling organisms on “protected” wetted surfaces within a water intake and distribution system, thereby reducing, eliminating and/or altering natural biofouling of wetted surfaces within the system. FIG. 1 depicts an exemplary antifouling system 10 which can include an enclosure and/or structure 20, which in this embodiment is a three-dimensional “cube” having external enclosure walls, a pump 30 with fluid tubing 35, and a raceway 40 containing a substrate 50. In this embodiment, an aqueous fluid such as water is drawn from an external environment into the cube through the enclosure walls, with the treated water flowing through fluid tubes 35 and a pump 30 and subsequently into a raceway 40 containing the substrate 50 to be protected. Desirably, a constant flow of water passes into the raceway 40, with excess water passing out of a one-way valve 60 of the raceway 40.

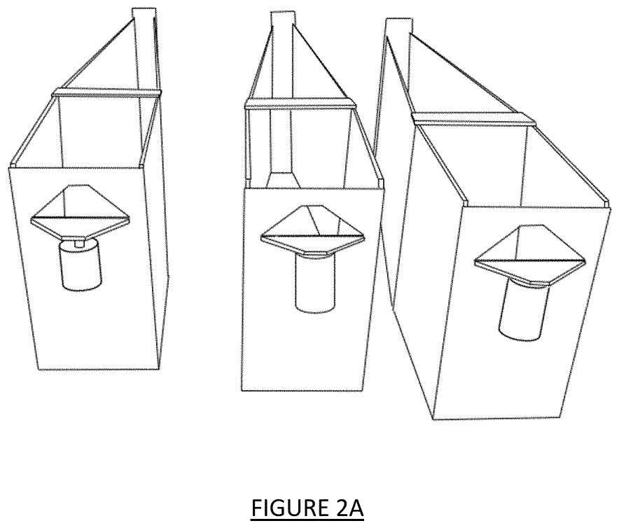

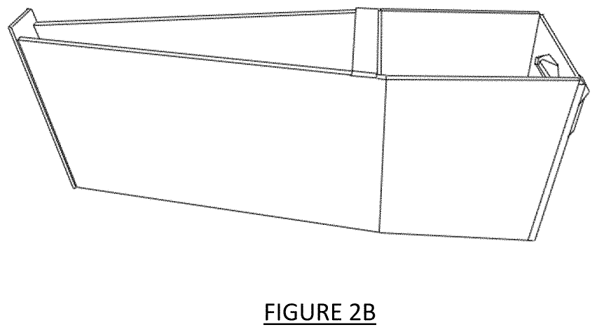

FIG. 1B depict a perspective view of the raceway 40 of FIG. 1A, in this embodiment, the raceway will desirably substantially surround the substrate (not shown), which inhibits environmental water from contacting the substrate in an undesirable manner. FIG. 2A depicts a series of raceways and associated components, and FIG. 2B depicts a side perspective view of one exemplary raceway.

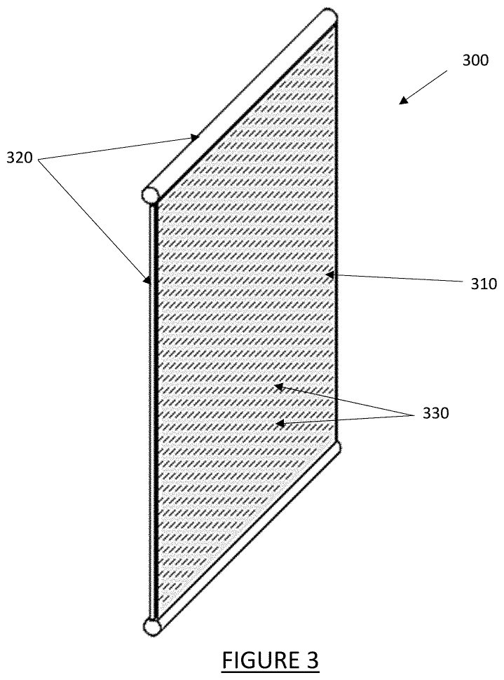

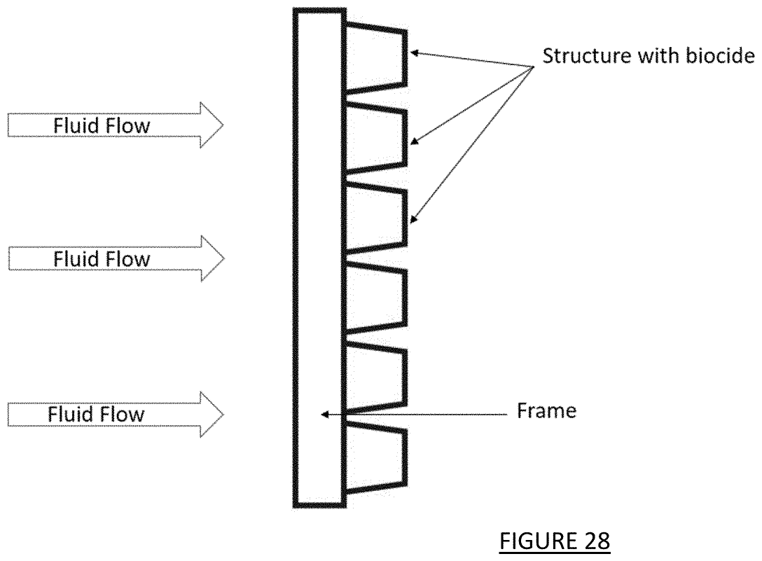

FIG. 3 depicts a perspective view of an exemplary module or structure 300, which can be used with the various systems disclosed herein. The module 300 can comprise a structure enclosure and/or structure 310, which can be secured at the outer edges by a support structure 320, which in this embodiment can comprise a flexible and/or rigid outer frame of support beams. In addition, this embodiment desirably can include a reinforcing material 330 which can be positioned on a downstream face of the media 310 (which material can be secured to and/or into the frame, if desired), such as an expanded metal or wire mesh or polymer or fabric, which may stiffen and/or otherwise support the media 310 against the flow forces from the fluid passing therethrough. If desired, the module 300 can be sized and configured to fit into a receiver of an antifouling unit, such as a fluid pipe and/or a submerged antifouling unit, with said unit(s) optionally including a plurality of modules or structures therein (not shown). In some embodiments, the antifouling unit may include a plurality of fibrous structure modules in series and/or parallel to the fluid flow, including the use of multiple modules for a single flow of water, if desired (See FIG. 28).

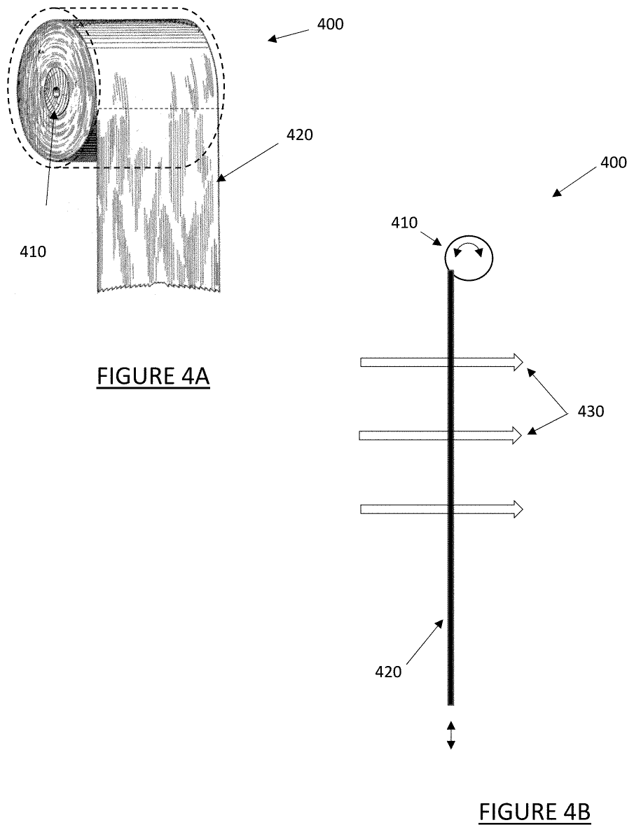

FIGS. 4A and 4B depict components of an antifouling system that include a plurality of deployable “roller” sheets 400, each roller sheet including a storage roll 410 and a deployable flexible sheet 420, where the flexible sheet 420 can be unrolled from the storage roll 410 and extended downward (i.e., desirably under the force of gravity in some embodiments). In various embodiments, the storage roll 410 can include a buoyant member (for example, a buoyant Styrofoam™ center tube) which desirably floats in the aqueous medium, while in other embodiments the storage roll 410 may be attached to a support mechanism, frame or similar structure (not shown). In various embodiments, a plurality of such deployable “roller” sheets could be provided across a water system intake or similar location, with the flexible sheets deployed to create an enclosure, filtration and/or dosing membrane for the water flow (depicted as arrows 430), as described herein. If desired, the various roller sheets could include attachment mechanisms to allow attachment of adjacent sheets to each other.

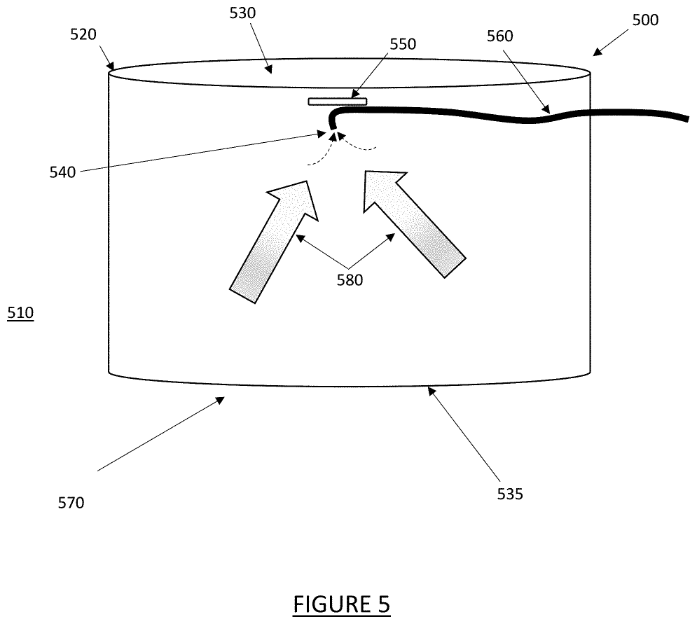

FIG. 5 depicts another exemplary embodiment of an antifouling system, which may have particular utility as an anti-biofouling system for water system utilizing sea and/or fresh water as a source of water. In this embodiment, a floating enclosure 500 or “reservoir” in the aqueous environment 510 is provided, with the enclosure having one or more peripheral walls 520 which can encompass a significantly larger amount of aqueous fluid than may be required by the system on a normal use basis. For example, if the system demands 1000 gallons of water per minute during normal operations, then the reservoir could desirably encompass at least 10,000 gallons, at least 20,000 gallons, at least 50,000 gallons, at least 100,000 gallons, at least 500,000 gallons and/or at least 1,000,000 gallons and/or more of water. Optional top and/or bottom covers 530 and 535 can be provided, if desired, to isolate the enclosed water from the atmosphere and/or deeper water, such as by using a structure, a flexible non-permeable membrane or plastic tarp material. A water inlet 540 may be positioned within the reservoir, with the inlet supported by a float 550 or other support, with connected flexible or rigid water piping 560 which carries water drawn from the inlet 540 (which in some embodiments may have a relatively different dissolved oxygen level or other desired water chemistry factor level in various embodiments) for transfer to cooling equipment or other uses. Desirably, water can enter the reservoir through the various permeable membranes in the walls, top and/or bottom. In some embodiments, during the time it takes for the water molecules to transit up and/or across the water column within the reservoir, natural and/or artificial processes may alter the water chemistry within the reservoir, such as by the activity of natural and/or artificial oxygen scavengers within the water column that may reduce the dissolved oxygen level in the water, such that the dissolved oxygen level is depleted prior to traveling into the inlet. In at least one alternative embodiment, however, the water inlet may be near the bottom of the enclosure and/or the bottom surface of the reservoir, which is generally the coldest water within the enclosure/reservoir for use in cooling equipment.

As previously noted, at least one exemplary embodiment includes a method for determining an appropriate design, size, shape and/or other features of the of reservoir and/or antifouling system can be utilized to determine a recommended minimum enclosed volume and/or water exchange rate to desirably reduce and/or eliminate biofouling within the reservoir. In some embodiments, such as in a membrane configuration, where the reservoir may be utilized to provide a water source and/or other source water for a manufacturing plant (i.e., a power plant, a desalination plant, a refinery and/or other manufacturing facility), the disclosed methods can potentially be utilized to reduce and/or eliminate biofouling within the water and/or other conduits of the plant, and in some embodiments without the need for additional filtration and/or microfiltration of the water.

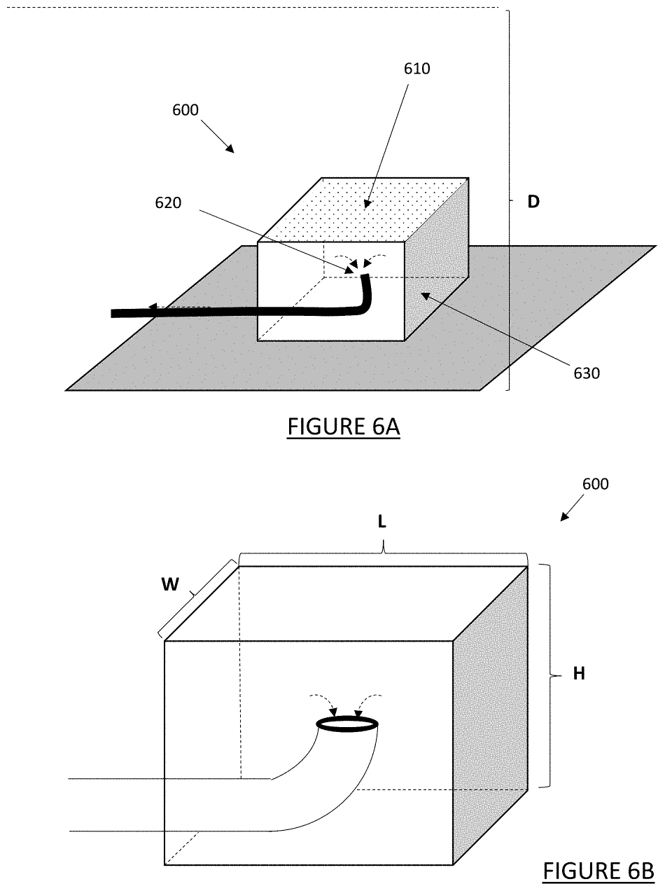

FIGS. 6A and 6B depict another exemplary embodiment of a system 600 that can be utilized to reduce biofouling and facilitate the utilization of seawater, fresh water, brackish water, or some other aqueous liquid by a manufacturing plant, a power plant or some other facility. In this embodiment, the system 600 can be positioned within a body of water and may even be fully submerged within the aqueous environment (i.e., an underwater “lanai”) to a depth “D”, such as shown in FIG. 6A. The system can include one or more replaceable impregnated structure enclosure 610 on one or more of the outer surfaces, with a water suction pipe or other inlet device 620 positioned within a reservoir 630 of the system 600, and when water is drawn into the suction device a flow of replacement water can enter the reservoir through the media 610 and/or any other openings and/or perforations in and/or between the walls of the reservoir (which may include the ceiling, side walls and/or floor surfaces of the reservoir).

In some embodiments, the volume of the reservoir may be sufficiently large to contain a significant reservoir of liquid, such that the liquid can remain within the reservoir for a desired “dwell time” to allow the desired water chemistry changes to occur to reduce and/or eliminate biofouling from occurring within the reservoir and/or the facility's water piping. In some other embodiments, the volume of the reservoir may be smaller and may not contain a significantly large reserve amount of liquid (as compared to the anticipated flow rate into the inlet during use), in which embodiments the liquid may not remain within the reservoir for a desired “dwell time” to allow the desired water chemistry changes, but may rather primarily rely on the enclosure and components thereof to desirably reduce and/or eliminate biofouling from occurring within the reservoir and/or the facility's water piping and/or heat transfer surfaces.

In various desired embodiments, a fully submerged system may particularly be useful where the reservoir retains and/or draws water from a lower or lowest point within the water column, which in some embodiments might be colder water (i.e., useful as cooling water) and/or which may contain lower and/or the lowest levels of dissolved oxygen (or other desirable water chemistry factors) within the body of water.

In various embodiments, a system design may desirably encompass a volume of water that equals or exceeds the daily (i.e., 24 hour) water use for the facility. For example, where a facility utilizes 100,000 gallons of water per hour over a 24-hour period, one preferred system design might encompass at least 2.4 million gallons of water. Assuming that 1 cubic foot of seawater contains approximately 7.48 gallons, one preferred design could encompass approximately 321,000 cubic feet, which could be a reservoir with a contained volume of approximately 113 feet wide by 113 feet long by 26 feet high (i.e., 331,994 cu ft). In other preferred embodiments, the volume of contained water may be sufficient to supply at least 8 hours of water usage, while still other preferred embodiments may provide 2 or more days of water usage. In some desirable embodiments, water present in the reservoir will desirably be granted a sufficient “dwell” time to alter the water chemistry in a desired manner (as previously disclosed) so as to create “conditioned” water of some type, which may include situations where the entire water needs for a given installation may be provided by the “conditioned” water, as well as situations where only a portion of a given installation's water needs may be provided by the “conditioned” water.

In some alternative embodiments, it may be desirous to modify an existing body of water to include various features of the present systems, such as where a natural or artificial water source is being utilized to provide water for cooling and/or some other water processes. For example, energy generating facilities will often utilize between 300,000 to 500,000 gallons of water (or more) per minute to cool the generating units, while a typical large petroleum refining plant may utilize 350,000 to 400,000 gallons per minute. In such cases it may not be economical, practical and/or desirable to construct a single reservoir or series of reservoirs that contain a full day's worth of water usage. Rather, various embodiments that incorporate “partial” reservoirs and/or antifouling components described herein (i.e., vertical sheets and/or skirts) may be utilized to create a tortuous path for the water within the existing natural and/or artificial reservoir to condition the water to meet a desired water chemistry level, and may include features that expose the surface of the flowing water to the atmosphere to promote evaporative cooling of the water reservoir and/or turbulent mixing of the water along the tortuous flow path.

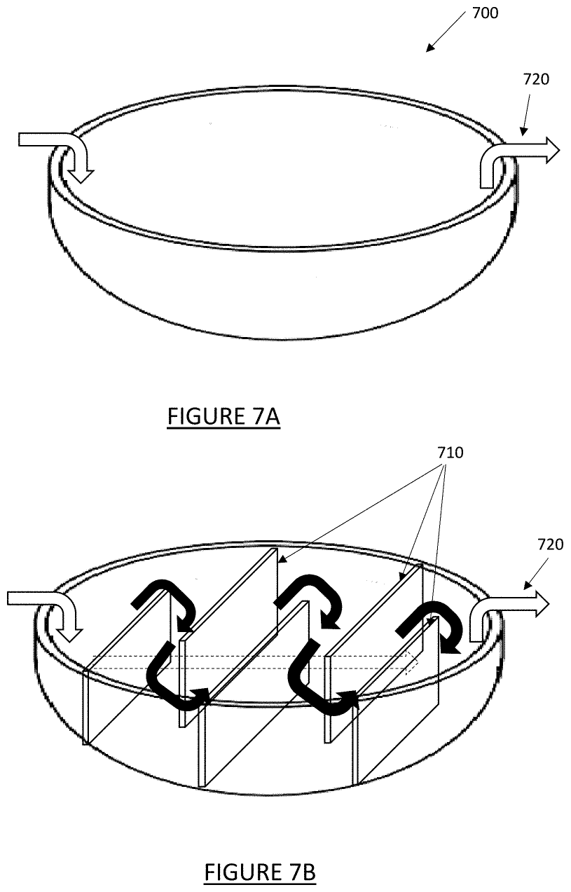

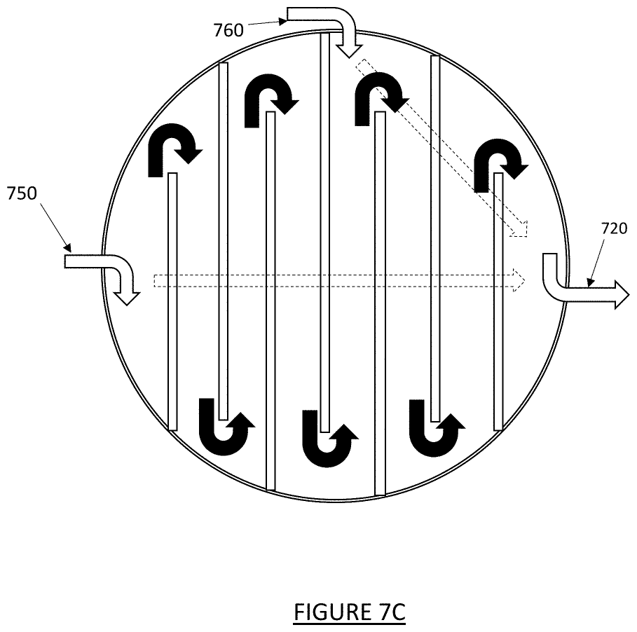

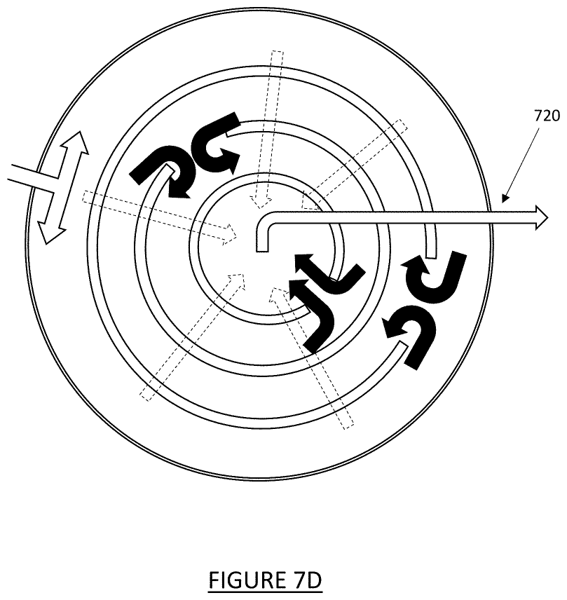

FIG. 7A depicts a simplified perspective view of one exemplary embodiment of a natural or artificial reservoir or pond 700, which could encompass a water source for once-through cooling as well as a recirculating water reservoir or “cooling pond” often used in recirculating systems. As best seen in FIGS. 7B and 7C, a biofouling protection system can include a plurality of enclosure walls 710 and/or a nonlimiting example of removable or replaceable floating boom structures or skirts, which can be positioned within the pond 700 to desirably create a labyrinth or tortuous path for the aqueous liquid within a body of water, such as by positioning the series of alternating walls 710 within the water basin, pond or harbor that alters the natural flow of the fluid towards an inlet 720. In this embodiment, the walls 710 can desirably redirect the liquid along a desired path or paths (following the path denoted by solid black arrows, for example) as well as filter and/or dose water passing through the walls (following the path denoted by the broken white arrow, for example), which may allow some portion or all of the water to be “conditioned” in a desired manner to obtain various of the disclosed improvements herein. For example, water passing through such a tortuous path could be granted a sufficient “dwell” time to alter water chemistry in a desired manner so as to create “conditioned” water of some type, which may include situations where the entire water needs for a given installation may be provided by the “conditioned” water, as well as situations where only a portions of a given installation's water needs may be provided by the “conditioned” water. If desired, different “streams” of water may be treated in different matters by the present invention, such as in the embodiment of FIG. 7C, in which a first stream of water 750 passes through an entirety of the labyrinth and/or through the permeable enclosure walls to the inlet 720, while a second stream of water 760 is added to a location of the labyrinth where it only travels through half of the labyrinth (or similarly passes through the enclosure walls) to the inlet 720. Such an arrangement may include water from varying sources which is added directly to conditioned water within an existing water system.

Another alternative arrangement of a labyrinth path is shown in FIG. 7D, wherein a series of circular enclosures are employed to create a tortuous path towards the center of the reservoir where the inlet 720 is located, from which the water can then be removed as previously described. Such an embodiment may be particularly useful where portions of the structure may become clogged or fouled over time, wherein the intake water may flow along the tortuous path around clogged sections of the structure, and eventually pass through an unclogged section further along the tortuous path.

If desired, an enclosure and/or other system design may incorporate one or more flow paths for the aqueous fluid that gradually increase and/or decrease in width and/or volume, with the water flow changing in cross-section as it approaches a water intake, which may be a particularly useful design feature in natural reservoirs and/or artificial tributaries or rivers to provide additional dwell time and/or more filtration/dosing activity for the flowing water.

In another embodiment, the structure or enclosure may be designed as a sheet or wall to protect at least one substrate. A sheet/curtain structure was designed to determine the effectiveness and efficacy of a freshwater biofouling of steel plates to prevent biofouling growth. The application could be useful for biofouling protection of a variety of underwater steel and other metal surfaces. In addition, the application could be useful for any metal, fabric, polymer or other substrate in fresh or salt waters. The experiment was designed with vertical sheet plates deployed at the seawall adjacent to the UWM School of Freshwater Sciences in mid-May and retrieved in mid-September to determine biofouling effectiveness. One plate was the control deployed without protective treatment and the other two plates had a structure protective treatment, one with the treated (biocide coating) fabric facing inward toward the steel plate and seawall; the other treated (biocide coating) fabric faced to the outside away from the steel plate and seawall.

Each plate was constructed with ⅛″ thick sheet steel. Each plate had a total dimension of 18.5 cm wide×155 cm long. The top of plates was at 1 m below the water surface. The plates were suspended by chain.

Results and data from the four month testing are presented in the Tables 1 and 2.

TABLE 1
Chemistry for vertical steel plates, June 2020.
Plates

| | | |
|---|---|---|
| | Treated | Treated |
| | Surface | Surface |
| Control | Outside | Inside |

Jun. 3, 2020

| | | | |
|---|---|---|---|
| Sonde Time | (12:13:17PM) | (12:16:02PM) | (12:17:14PM) |
| Depth m | 0.601 | 0.622 | 0.533 |
| Temperature C° | 24 | 16.4 | 17 |
| ODO % sat | 87.9 | 84.1 | 87.4 |
| ODO mg/L | 8.49 | 8.22 | 8.43 |
| Specific Cond μS/cm | 483 | 448 | 535 |
| pH | 7.86 | 7.62 | 7.64 |
| Turbidity FNU | 1.09 | 1.03 | 1.23 |
| BGA-PC RFU | 0.08 | 0.05 | 0.06 |
| BGA-PC μg/L | na | na | Na |
| Chlorophyll RFU | 1.34 | 0.86 | 0.91 |
| Chlorophyll μg/L | 4.21 | 3.47 | 3.67 |

Jul. 27, 2020

| | | | |
|---|---|---|---|
| Sonde Time | (12:07:??PM) | (12:06:34PM) | (12:08:25AM) |
| Depth m | 0.754 | 0.485 | 0.536 |
| Temperature C° | 24.011 | 24.01 | 24.013 |
| ODO % sat | 74 | 73.7 | 73.1 |
| ODO mg/L | 6.22 | 6.19 | 6.17 |
| Specific Cond μS/cm | 583 | 583 | 584 |
| pH | 7.85 | 7.85 | 7.84 |
| Turbidity FNU | 0.59 | 0.9 | 0.83 |
| BGA-PC RFU | −0.09 | 0.079 | 0.065 |
| BGA-PC μg/L | −0.05 | 0.12 | 0.11 |
| Chlorophyll RFU | 1.289 | 1.496 | 1.485 |
| Chlorophyll μg/L | 5.22 | 6.05 | 6.07 |

TABLE 2
Chemistry for vertical steel plates, September 2020.
Plates
Sep. 10, 2020

| | | Treated | Treated |
|---|---|---|---|
| | | Surface | Surface |
| | Control | Outside | Inside |
| Sonde Time | (10:45:13AM) | (10:49:59AM) | (10:55:21AM) |
| Depth m | 1.138 | 1.164 | 0.5361.137 |
| Temperature C° | 17.11 | 17.11 | 17.12 |
| ODO % sat | 71.6 | 69.6 | 70.4 |
| ODO mg/L | 6.9 | 6.7 | 6.3 |
| Specific Cond μS/cm | 557 | 558 | 552 |
| pH | 6.84 | 7.48 | 7.41 |
| Turbidity FNU | 2.57 | 7.65 | 5.1 |
| BGA-PC RFU | 0.222 | 0.206 | 0.206 |
| BGA-PC μg/L | 0.19 | 0.18 | 0.1 |
| Chlorophyll RFU | 0.956 | 0.955 | 0.944 |
| Chlorophyll μg/L | 3.79 | 3.78 | 3.73 |

In this experiment, both the control and treatments had many native taxa in low abundance including small nematodes, crustacean such as cladocerns, rotifers, gastrotrichs, oligochaete worms, diatoms, and protozoa. In freshwater these small forms are not considered as a biofouling contributor.

The major biofouling organisms, specifically dreissenid quagga/zebra mussels, and ectoproct bryozoans. The treated fabric facing inward (189/m²) was more effective at preventing mussel biofouling than the fabric facing outward (1108/m²). The previous experiments, a similar experiment had a control mussel count of 1200/m² (these observations will be reexamined). The previous similar experiment with fabric facing inward had 0 m² mussels. The bryozoan percent coverage was less (5.8%) in the fabric with treated side to the inside compared to higher coverage for treated fabric side facing outward (13.3%). The control had a lower coverage that treated fabric.

The plate study suggests that treated fabrics designed as a sheet, curtain, or shield substantially reduce the number of biofouling mussels. The treated side facing in mussel abundance was 189/m² compared to the control at 1399/m² and for the treatment side facing out 1104/m². This is substantiated with data from a similar study. The previous similar study had a control with 1200 m² mussels. The impact on bryozoan fouling is less clear in that this study since the control had less percent coverage than either treated fabric, oriented in or out. The considerable reduction of mussels indicates possible success of commercial applications with additional refinements.

Treated enclosures design as a sheet or wall provide at least 4 months of reduced settlement of biofouling organisms on steel plates. Enclosure substantially reduces settlement and colonization of quagga and zebra mussels by 86% compared to the control. Treatment side of fabric facing towards the substate (biocide coated side of fabric on inside) contained 6× less (83% fewer) mussels on the steel plate compared to treatment side of fabric facing away from the substrate (biocide coated side of fabric on outside). Skirt or sheet structure can prevent settlement and colonization of mature quagga mussels and zebra mussels for at least 4 months on a substrate. Early veligers zebra mussels are capable of settling but fail to grow from juvenile to adult stage. The point of impact may be between metamorphosis from the early veliger to the pediveliger stage. Attached photosynthetic algae growth may be present on the outer (treated side) of the structure due to exposure of light.

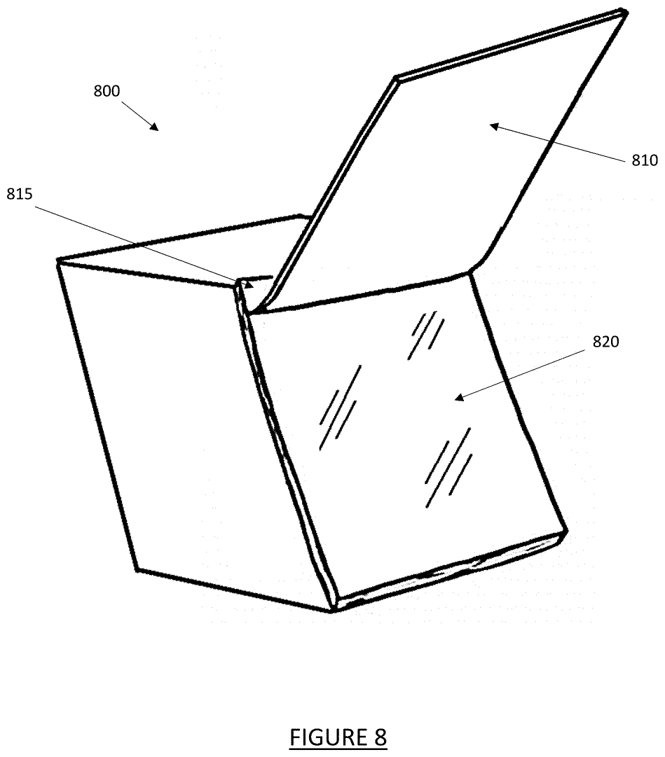

FIG. 8 depicts a perspective view of another exemplary embodiment of a system 800 for protecting a water supply system from biofouling that incorporates a wall structure having a plurality of layers, which could include wall structures incorporating multiple layers having the same, similar or differing permeabilities in each layer, same, similar or different materials in each layer and/or same, similar or differing thicknesses in each layer. In another embodiment, layers may be spaced with minimal or no distance of spacing between each layer or a significant distance of spacing between each layer. In various embodiments, some layers may be in direct contact with one or more adjacent layers while in other embodiment, adjacent layers may be separated by spacing of 1/10 of an inch or less, 0.25 inches or less, 0.5 inches or less, 1 inch or less, or greater separations. In some other embodiments, layers may be separated by larger distances such as 1 inch or more, 6 inches or more, 1 foot or more, 10 feet or more or 100 feet or more. If desired, some layers could be separated by a porous intermediate material or filler.

If desired, a first overlayer 810 could be removable, with removal of the first overlayer (which may include a “tear away” or other type of connection section 815) thus revealing an intact second underlayer 820, and removal of the second underlayer revealing an intact third underlayer (not shown), etc., all upstream from the protected substrate. If desired, a first overlayer could be removable, with the remaining underlayer(s) left intact, and then a replacement first overlayer could be positioned around the intact underlayer(s), such as where the first overlayer may become sufficiently fouled to justify removal and/or replacement. Alternatively, the multiple over and/or underlayers could comprise a plurality of sacrificial layers, with each layer removed as it becomes sufficiently fouled, revealing a virgin or semi-virgin layer below (i.e., still surrounding and protecting the substrate). In some embodiments, the underlayers could remain in position for an extended period of time, can be changed or replaced or removed every day, week, month, 3 months, 6 months even 1, 2, 3, 4 and/or 5 years or more, with periodic removal, replacement, and/or refreshing of the exterior layer and/or underlayer(s) as previously described (i.e., removal of a fouled layer and immediate and/or delayed replacement with a new overlayer). Such a system could have applications in salt, fresh and/or brackish water, if desired.

In at least one additional alternative embodiment, an antifouling enclosure may include a plurality of layers or “stages” of fibrous matrix media through which a stream of water may pass, with each layer or section of layer contributing to different conditioning properties for the water. For example, a three-stage antifouling system might include a first layer to protect the structure, a second layer to condition water, and a third layer to dose the water and/or kill organisms passing therethrough, etc. If desired, the multiple layers may be incorporated into a single replaceable module, or each layer may be removeable and/or replaceable individually.

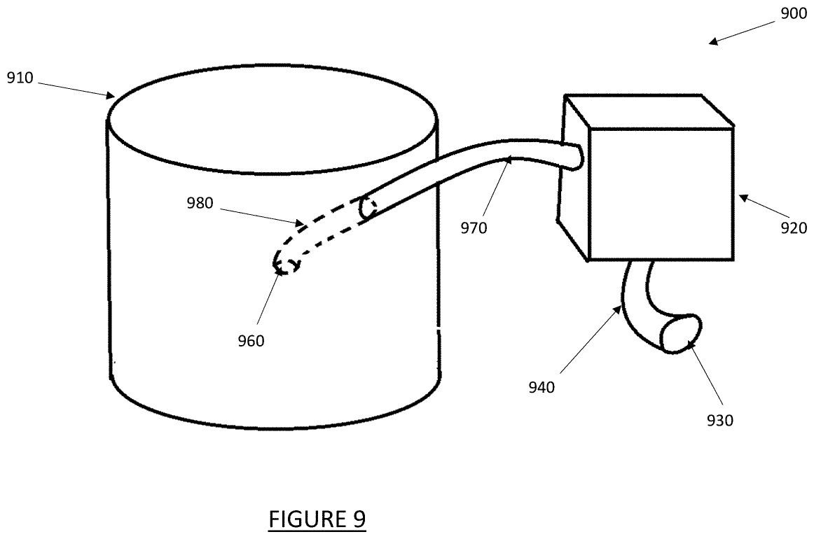

FIG. 9 depicts one exemplary embodiment of an aqueous flow mechanism of a supplemental pumping system 900 for adding and/or removing aqueous liquids and/or other materials or substances to/from the reservoir 910. In this embodiment, the system includes an outer wall or boundary, which in some embodiments may comprise one or more permeable walls, and in other embodiments may comprise one or more semi-permeable and/or non-permeable walls (which in some embodiments may include some or all walls of the enclosure being non-permeable). A pumping mechanism 920 with a flow cavity or intake 930 and intake tube 940 can be provided, with the pump further including an outlet 960 and outlet tube or flow cavity or flow path tube 970 extending from an outlet of the pump, through at least one wall of the reservoir, and through/into the aqueous environment within the reservoir. In various embodiments, at least some flow cavity portion 980 of the outlet tube can extend some distance within the reservoir, with the outlet potentially positioned proximate and/or distal from a protected substrate or water supply system (not shown) and/or one or more walls of the reservoir. During use, the pumping mechanism may be activated to supply outside water into the reservoir in a desired manner, and/or the pump operation may be reversed to draw water from the reservoir to be released in the environment outside of the reservoir, if desired. Alternatively, the pumping mechanism could be utilized to supply additional oxygen or other water chemistry factors to the reservoir. If desired, some or all of the pumping mechanism and/or flow cavity and/or intake 930 could be positioned within the reservoir, or alternatively within and/or through some portion of the reservoir walls, or could be positioned outside of the reservoir, if desired. In another embodiment, the aqueous flow mechanism may be a propeller system, pedal system, flow pipes, flow canals, or flow tunnels that may be used in a similar manner to move water or create desired flow characteristics as the pump system.

In various embodiments, system components can incorporate permeable walls of varying configuration, including (1) an enclosure that fully encloses a water intake or protected substrate (i.e., a “box” or “flexible bag” enclosure), (2) an enclosure having lateral walls that surround a periphery of an intake or substrate (i.e., a “skirt” or “drape” that encloses the sides of the substrate, but which may have an open top and/or bottom), (3) an enclosure formed from modular walls that can be assembled around the water intake or substrate, which may incorporate various openings and/or missing modular sections (i.e., an “open geodesic dome” enclosure), (4) an enclosure that surrounds only a submerged portion of the water intake and/or substrate (i.e., a “floating bag” enclosure with open top), and/or (5) an enclosure that protects only a single side of a water intake and/or substrate (i.e., a “drape” enclosure), as well as many other potential enclosure designs. In addition, the enclosure walls could be relatively smooth or flat or curved and/or continuous, or the enclosure walls and/or enclosure could comprise much more complex structures such as undulating surfaces, corrugated or accordion-like surfaces (i.e., see FIG. 27), folded, “crumpled” or “scrunched” surfaces and/or other features which can dramatically increase the surface area and/or potentially alter a filtering ability of the enclosure walls, if desired.

In various embodiments, an antifouling system can incorporate one or more walls which comprise a 3-dimensional flexible structure including fibrous filaments and having an average base filament diameter of about 6 mils or less (i.e., 0.1524 millimeters or less). In various alternative embodiments, an enclosure could comprise textured polyesters. In addition, a natural fiber material such as 80×80 burlap might be useful in an enclosure, even if the natural material degrades relatively quickly in the aqueous environment and the underlying degradation process contributes to a significant measurable pH difference within the system, which may be useful in various aqueous environments. If desired, various embodiments could incorporate degradable and/or hydrolysable materials and/or linkages (i.e., between components and/or along the polymer chains of the component materials) that allow the components to degrade after a certain time in the aqueous medium.

In some embodiments, an antifouling system or various components thereof may contribute to a measurable change in pH level of the protected environment, especially where one or more “target” fouling organisms (i.e., organisms meant to be affected in some manner by the antifouling system) may be sensitive to increases or decreases in pH levels and respond “negatively” to them. In many cases, marine organisms are very sensitive to slightly acidic pH changes (pH<8). In contrast, freshwater organisms typically live well in the range of 7 pH to 8.4 pH and start responding negatively once ammonium levels increase. In some embodiments, an effective change in pH to accomplish some or all of the objectives of the present invention may be a level of change that can be much less than what would negatively affect metals and other materials within a protected system. If desired, a pH controlled antifouling system can provide an added benefit of reduced scale formation with a decrease in pH in a given fluid system, which may be provided at a lower level than would negatively affect materials from which the water system is constructed.

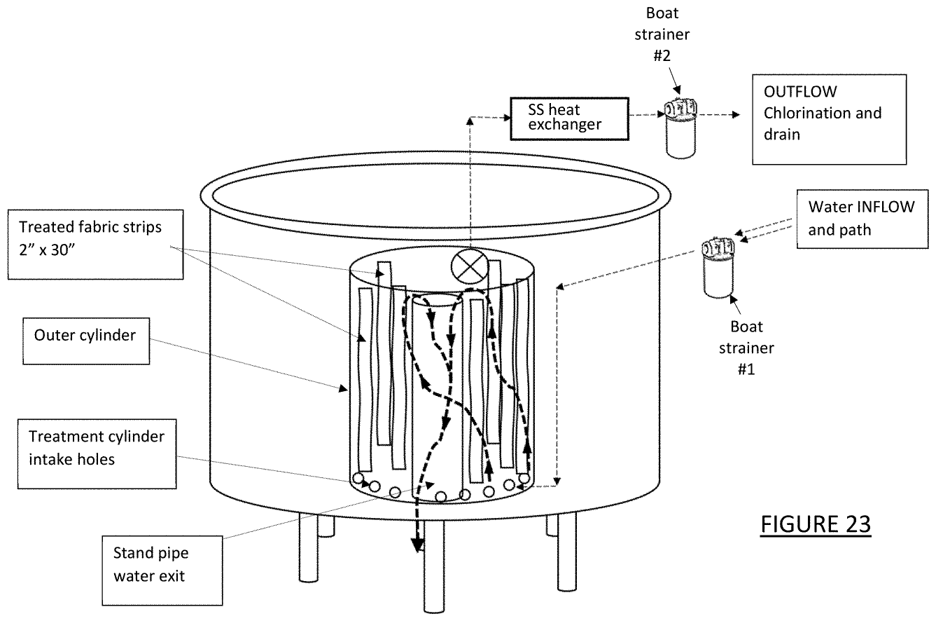

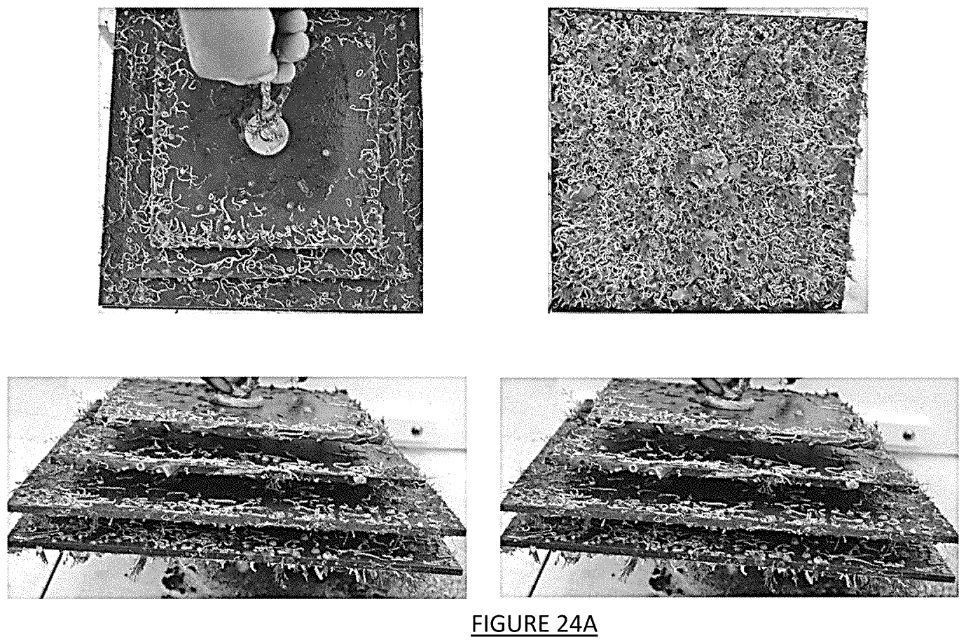

FIG. 23 depicts another exemplary embodiment of a protective pumping system for adding and/or removing aqueous liquids and/or other materials or substances to or from a reservoir or tank. In this embodiment, the system includes an optional outer reservoir or tank, which comprise of a solid material, and an inner reservoir or holding tank, which in some embodiments may comprise one or more permeable walls, and in other embodiments may comprise one or more semi-permeable and/or non-permeable walls (which in some embodiments may include some or all walls of the inner reservoir being non-permeable). A pumping mechanism with a flow cavity or water strainer or intake and intake tube can be provided, with the pump further including an outlet and outlet tube or flow cavity or flow path tube extending from an outlet of the pump, through at least one wall of the inner reservoir, and through/into the aqueous environment within the reservoir. In various embodiments, at least some flow cavity portion can extend some distance within the reservoir, with the flow path entering into the inner reservoir through or near an inner reservoir intake hole or holes. The flow path is introduced to conditioned or treated structure strips. Liquid or other materials in the flow path are exposed to treated structure strips and pass around the strips, on top of the strips, under the strips, or through the strips. The inner reservoir may contain one or more treated structure strips that are permeable or non-permeable. Treated structure strip(s) may be sized to line the inner surface of the inner reservoir or sized to be fit multiple structure strips within the inner reservoir. Multiple structure strips may be sized and positioned vertical, horizontal or diagonal within inner reservoir or cylinder. Conditioned or treated structure strips are attached to the inner reservoir on at least one side of the strip and may be positioned tight to contain tension or loose for material flexibility. The amount of tension needed for strip attachment to the reservoir depends on the flow rate, volume of reservoir and other factors. Treated structure strips provide mixing in a laminar or flow application. The flow path outlet may be positioned proximate and/or distal from a protected substrate or water supply system and/or one or more walls of the reservoir. An optional fluid strainer or filter may be positioned at the outlet. During use, the pumping mechanism may be activated to supply outside water into the reservoir in a desired manner, and/or the pump operation may be reversed to draw water from the reservoir to be released in the environment outside of the reservoir, if desired.

In a preferred embodiment, multiple (which in some embodiments can be between 125 and 250) treated structure strips (i.e., 2″×30″) can be positioned in a vertical configuration (which may include non-tensioned suspension) within a 25 gallon cylinder reservoir. Water flows through a preconditioning filter then enters into the cylinder reservoir through intake holes positioned at the bottom of the reservoir. Once the cylinder reservoir fills, the water passes on top and through to the multiple permeable treated structure strips then spills over into the reservoir outlet. The reservoir outlet may contain an optional containing step with treated structure or “bio balls” or similar. The water can flow into an additional strainer/filter or heat exchanger or used for a similar application. Such a system can be utilized in fresh, slat and/or brackish water, or another other liquid contemplated herein.

Experiment for Skirt Tank and the Strip Tank each have a potentially different application role in reducing biofouling. Both the Skirt and Strip Tanks had a considerable reducing effect on mussels, bryozoans, snails and sponges. The skirt tank showed to be a considerable deterrent to biofouling especially nearer the treated fabric lining the tank wall and especially for preventing mussel, bryozoan, sponge and snail biofouling as compared to the strip tank wall that served as a control. Low numbers of mussel veligers were found in the debris accumulation on the skirt fabric, but they apparently did not metamorphose to juveniles as juveniles nor adults were present on the skirt.

The strip tank using a central treatment cylinder proved an impressive inhibition of invertebrate biofouling organisms including zebra mussels, bryozoans, sponges, and pulmonated snails at a suppression level of zero biofouling. Compared to the outer untreated portion of the tank receiving harbor water inflow (including tank wall, central cylinder outside wall, cooling tubes external surface, multiplate artificial substrates) that had large populations of these same organisms.

In a study, a protective pumping system for adding and/or removing aqueous liquids and/or other materials or substances to or from a reservoir or tank was analyzed. This study was designed to determine the effectiveness of two independent biofouling treatment systems with high velocity water or pumped waters. One, the “strip tank” used a centralized cylinder with high density treated fabric strips that were designed to maximize exposure contact and time. The other system, the “skirt tank” used a treated fabric skirt that wrapped around the inside wall of the tank. Each fiberglass/gel coat tanks (495 gallons (1874 liters) with a water depth of 30 inches (76 cm). Lake Michigan Harbor water was pumped into the building and split nearly equally to each tank. Inflow water was directed to a Groco brand water strainer prior to entering the tank. The water then flowed into a central cylinder via holes and a sampling portion was captured at the standpipe by an accessory pump. The water in each tank was then delivered to a series of vertical stainless steel tubes as a proxy for cooling tubes that might be used in industrial settings. The tubes were each composed of sections of SS316 (polished) and SS304 unpolished. From these tubes the water flowed to a second outflow Groco brand water strainer and finally to the drain for disposal. This system provided several points of possible biofouling attachment: 1) The inflow Groco strainer that was raw water from the harbor that supply an array of potential biofouling organisms, 1-month periods. 2) The surface of the tank's wall (limited in the skirt tank as the skirt was loosely attached to the wall), 4-months. 3) The outer and inner walls of the central treatment cylinder, 4-months. 4) the outsider wall of the pvc standpipe, 4-months. 5) The 304 SS tubes both outer and inner walls, 4-months. 6) The 316 SS tube sections both outer and inner walls 4-months. 7) The aluminum manifold that held the SS tubes in place, 4-montrhs. 8) The outflow Groco brand water strainer, 1-month periods. Both the inflow and outflow Groco brand strainer baskets held two microscope slides, and four artificial substrate bioballs. 9) Each tank contained a 4-plate artificial substrate, coined a Christmas tree, on the bottom of the tank, 4-month. FIG. 23 approximates the water flow through the Strip Tank.

Tables 3 through 7 below present data from the strip and skirt tank experiments relating to the amount of fouling.

TABLE 3
Tank strip Biota. Note number/ml is derived from a 1 ml sample collected from the control and test GROCO strainers.
Biofouling Technologies Tank Strip Biota
Tank size: 495 gal // 1874 liters
Treatment cylinder size: 29.1 gal // 110.2 liters
Treated side surface area 7.48 m²
(Treated + untreated surface area 14.96 m²)

| | Slide | Slide | Bioball | Bioball | Bioball | | Strainer |
|---|---|---|---|---|---|---|---|
| Colonization | Inflow | Outflow | Fouling | Fouling | Differential | Diversity | Diversity |
| Period | % coverage | % coiverage | control (gdwt) | test (gdwt) | ± | Metric | Inflow |
| May 24, 2020 | 15 | 16 | 9.52 | 9.48 | −0.04 | Simpson 1-D | 0.788 |
| to | | | | | | Simpson E_{1-D} | 0.586 |
| Jun. 25, 2020 | | | | | | Shannon H¹ | 2.548 |
| | | | | | | Brillouin H | 2.502 |
| Jun. 26, 2020 | 15 | <5 | 9.23 | 9.07 | −0.16 | Simpson 1-D | 0.831 |
| to | | | | | | Simpson E_{1-D} | 0.731 |
| Jul. 25, 2020 | | | | | | Shannon H¹ | 2.738 |
| | | | | | | Brillouin H | 2.687 |
| Jul. 26, 2020 | 20 | 10 | 9.89 | 9.23 | −0.66 | Simpson 1-D | 0.831 |
| to | | | | | | Simpson E_{1-D} | 0.746 |
| Aug. 8, 2020 | | | | | | Shannon H¹ | 2.514 |
| | | | | | | Brillouin H | 2.477 |
| Aug. 9, 2020 | 20 | 15 | 10.26 | 9.39 | −0.87 | Simpson 1-D | 0.755 |
| to | | | | | | Simpson E_{1-D} | 0.579 |
| Sep. 15, 2020 | | | | | | Shannon H¹ | 2.514 |
| | | | | | | Brillouin H | 2.202 |

| | Strainer | Diversity | Strainer Pre-treatment | | Strainer Post-treatment | |
|---|---|---|---|---|---|---|
| Colonization | Diversity | Differential | Inflow Living Taxa | | Out Flow LivingTaxa | |
| Period | Outflow | ± | number/ml | | number/ml | |
| May 24, 2020 | 0.784 | −0.004 | Nematoda | 53 | Nematoda | 53 |
| to | 0.655 | 0.069 | Ciliata | 200 | Ciliata | 173 |
| Jun. 25, 2020 | 2.471 | −0.077 | Rotifera | 40 | Rotifera | 53 |
| | 2.423 | −0.079 | Gastrotricha | 53 | Gastrotricha | 40 |
| | | | Oligochaeta | 27 | Oligochaeta | 27 |
| | | | Diatoms | 160 | Diatoms | 120 |
| | | | Dreissinidae | 53 | Dreissinidae | 27 |
| | | | Bryozoa | 13 | Bryozoa | 0 |
| | | | Sponges | 0 | Sponges | 0 |
| | | | Pulmonate Snails | 0 | Pulmonate Snails | 0 |
| Jun. 26, 2020 | 0.681 | −0.15 | Nematoda | 67 | Nematoda | 27 |
| to | 0.773 | 0.042 | Ciliata | 147 | Ciliata | 40 |
| Jul. 25, 2020 | 1.786 | −0.952 | Rotifera | 53 | Rotifera | 0 |
| | 1.716 | −0.971 | Gastrotricha | 40 | Gastrotricha | 0 |
| | | | Oligochaeta | 40 | Oligochaeta | 0 |
| | | | Diatoms | 120 | Diatoms | 67 |
| | | | Dreissinidae | 67 | Dreissinidae | 13 |
| | | | Bryozoa | 13 | Bryozoa | 0 |
| | | | Sponges | 0 | Sponges | 0 |
| | | | Pulmonate Snails | 0 | Pulmonate Snails | 0 |
| Jul. 26, 2020 | 0.681 | −0.15 | Nematoda | 173 | Nematoda | 199 |
| to | 0.712 | −0.034 | Ciliata | 160 | Ciliata | 147 |
| Aug. 8, 2020 | 1.985 | −0.529 | Rotifera | 67 | Rotifera | 53 |
| | 1.953 | −0.524 | Gastrotricha | 67 | Gastrotricha | 0 |
| | | | Oligochaeta | 67 | Oligochaeta | 13 |
| | | | Diatoms | 133 | Diatoms | 107 |
| | | | Dreissinidae | 0 | Dreissinidae | 0 |
| | | | Bryozoa | 0 | Bryozoa | 0 |
| | | | Sponges | 0 | Sponges | 0 |
| | | | Pulmonate Snails | 0 | Pulmonate Snails | 0 |
| Aug. 9, 2020 | 0.761 | 0.006 | Nematoda | 133 | Nematoda | 120 |
| to | 0.756 | 0.177 | Ciliata | 107 | Ciliata | 133 |
| Sep. 15, 2020 | 1.985 | −0.529 | Rotifera | 27 | Rotifera | 27 |
| | 1.772 | −0.43 | Gastrotricha | 13 | Gastrotricha | 27 |
| | | | Oligochaeta | 13 | Oligo chaeta | 0 |
| | | | Diatoms | 120 | Diatoms | 93 |
| | | | Dreissinidae | 13 | Dreissinidae | 0 |
| | | | Bryozoa | 0 | Bryozoa | 0 |
| | | | Sponges | 0 | Sponges | 0 |
| | | | Pulmonate Snails | 0 | Pulmonate Snails | 0 |

TABLE 4
Tank Skirt Biota. Note number/ml is derived from a 1 ml sample collected from the control and test GROCO strainers.
Biofouling Technologies Tank Skirt Biota
Tank size: 495 gal // 1874 liters
Treatment skirt perimeter size: 5.75 m
Treated skirt surface area 4.38 m²

| | Slides | Slides | Bioball | Bioball | Bioball | | Strainer |
|---|---|---|---|---|---|---|---|
| Colonization | Inflow | Outflow | Fouling | Fouling | Differential | Diversity | Diversity |
| Period | % coverage | % coiverage | control (gdwt) | test (gdwt) | ± | Metric | Inflow |
| May 24, 2020 | 15 | 15 | 9.31 | 9.17 | −0.14 | Simpson 1-D | 0.797 |
| to | | | | | | Simpson E_{1-D} | 0.699 |
| Jun. 25, 2020 | | | | | | Shannon H¹ | 2.524 |
| | | | | | | Brillouin H | 2.477 |
| Jun. 26, 2020 | 15 | 10 | 9.69 | 9.23 | −0.46 | Simpson 1-D | 0.775 |
| to | | | | | | Simpson E_{1-D} | 0.628 |
| Jul. 25, 2020 | | | | | | Shannon H¹ | 2.367 |
| | | | | | | Brillouin H | 2.306 |
| Jul. 26, 2020 | 20 | 10 | 9.86 | 9.58 | −0.28 | Simpson 1-D | 0.753 |
| to | | | | | | Simpson E_{1-D} | 0.575 |
| Aug. 8, 2020 | | | | | | Shannon H¹ | 2.367 |
| | | | | | | Brillouin H | 2.252 |
| Aug. 9, 2020 | 15 | 15 | 9.9 | 9.73 | −0.17 | Simpson 1-D | 0.795 |
| to | | | | | | Simpson E_{1-D} | 0.69 |
| Sep. 15, 2020 | | | | | | Shannon H¹ | 2.477 |
| | | | | | | Brillouin H | 2.422 |

| | Strainer | Diversity | Strainer Pre-treatment | | Strainer Post-treatment | |
|---|---|---|---|---|---|---|
| Colonization | Diversity | Differential | Inflow Living Taxa | | Out Flow LivingTaxa | |
| Period | Outflow | + | number/ml | | number/ml | |
| May 24, 2020 | 0.761 | −0.036 | Nematoda | 93 | Nematoda | 133 |
| to | 0.593 | −0.106 | Ciliata | 80 | Ciliata | 80 |
| Jun. 25, 2020 | 2.341 | −0.183 | Rotifera | 40 | Rotifera | 27 |
| | 2.297 | −0.18 | Gastrotricha | 27 | Gastrotricha | 27 |
| | | | Oligochaeta | 27 | Oligochaeta | 13 |
| | | | Diatoms | 173 | Diatoms | 199 |
| | | | Dreissinidae | 67 | Dreissinidae | 27 |
| | | | Bryozoa | 0 | Bryozoa | 0 |
| | | | Sponges | 0 | Sponges | 0 |
| | | | Pulmonate Snails | 0 | Pulmonate Snails | 0 |
| Jun. 26, 2020 | 0.773 | −0.002 | Nematoda | 80 | Nematoda | 53 |
| to | 0.624 | −0.004 | Ciliata | 120 | Ciliata | 107 |
| Jul. 25, 2020 | 2.404 | 0.037 | Rotifera | 40 | Rotifera | 27 |
| | 2.346 | 0.04 | Gastrotricha | 13 | Gastrotricha | 27 |
| | | | Oligochaeta | 13 | Oligochaeta | 27 |
| | | | Diatoms | 80 | Diatoms | 133 |
| | | | Dreissinidae | 13 | Dreissinidae | 13 |
| | | | Bryozoa | 0 | Bryozoa | 0 |
| | | | Sponges | 0 | Sponges | 0 |
| | | | Pulmonate Snails | 0 | Pulmonate Snails | 0 |
| Jul. 26, 2020 | 0.772 | 0.019 | Nematoda | 147 | Nematoda | 120 |
| to | 0.621 | 0.046 | Ciliata | 80 | Ciliata | 107 |
| Aug, 8, 2020 | 2.404 | 0.037 | Rotifera | 40 | Rotifera | 40 |
| | 2.281 | 0.029 | Gastrotricha | 13 | Gastrotricha | 13 |
| | | | Oligochaeta | 27 | Oligochaeta | 13 |
| | | | Diatoms | 107 | Diatoms | 93 |
| | | | Dreissinidae | 13 | Dreissinidae | 13 |
| | | | Bryozoa | 0 | Bryozoa | 0 |
| | | | Sponges | 0 | Sponges | 0 |
| | | | Pulmonate Snails | 0 | Pulmonate Snails | 0 |
| Aug. 9, 2020 | 0.795 | 0 | Nematoda | 80 | Nematoda | 67 |
| to | 0.691 | 0.001 | Ciliata | 107 | Ciliata | 133 |
| Sep. 15, 2020 | 2.488 | 0.011 | Rotifera | 40 | Rotifera | 53 |
| | 2.433 | 0.011 | Gastrotricha | 27 | Gastrotricha | 13 |
| | | | Oligochaeta | 13 | Oligochaeta | 27 |
| | | | Diatoms | 120 | Diatoms | 93 |
| | | | Dreissinidae | 27 | Dreissinidae | 27 |
| | | | Bryozoa | 0 | Bryozoa | 0 |
| | | | Sponges | 0 | Sponges | 0 |
| | | | Pulmonate Snails | 0 | Pulmonate Snails | 0 |

TABLE 5
Tank Cooling Tube Debris.
Tank Strip and Skirt Tube Study
SS Cooling Tubes
Debris Content
Date Sep. 17, 2020

| | | |
|---|---|---|
| 316SS | 304SS | Total |
| wet wgt, g | wet wgt, g | g |

Strip Tank

| | | | |
|---|---|---|---|
| Tube 1 | 0.6 | 3.8 | 4.4 |
| Tube2 | 1.5 | 3.1 | 4.6 |
| Tube 3 | 1.2 | 2.9 | 4.1 |
| Tube 4 | 1.7 | 3 | 4.7 |

Skirt Tank

| | | | |
|---|---|---|---|
| Tube 1 | 4.9 | 12.8 | 17.7 |
| Tube2 | 3.6 | 13.7 | 17.3 |
| Tube 3 | 3.2 | 13.3 | 16.5 |
| Tube 4 | 3.5 | 13.4 | 16.9 |

TABLE 6
Tank Artificial Substrate Biota.
Biofouling Technologies Tank Strip Artificial Substrate Study
Multiplate Artificial Substrates - fouling organisms

| | | |
|---|---|---|
| | Number | Coverage |
| Taxa | dcm² | % |

Strip Tank - Pre-treatment

| | | |
|---|---|---|
| Zebra Mussels | 15.7 | na |
| Bryozoa | 6* | 28 |
| Snails, Pulmonate | 5.4 | na |
| Sponges | <1 | na |

Skirt Tank - Treated

| | | |
|---|---|---|
| Zebra Mussels | 3.1 | na |
| Bryozoa | 2* | 9 |
| Snails, Pulmonate | 2.2 | na |
| Sponges | 0 | na |

*Colonies

TABLE 7
StripTank Fouling Biota.
Biofouling Technologies Tank Strip Artificial substrate Study
Strip Tank - fouling organisms
Strip Tank Wall

| | Number |
|---|---|
| Taxa | m² |
| Zebra Mussels | 2710 |
| Bryozoa | 51* |
| Snails, Pulmonate | 598 |
| Sponges | 68 |
| *Colonies | |
| Strip Tank Cylinder - Treated | |
| | Number |
| Taxa | m² |
| Zebra Mussels | 0 |
| Bryozoa | 0 |
| Snails, Pulmonate | 0* |
| Sponges | 0 |

*1 snail at water/air interface

The strip tank showed a clear inhibition of invertebrate biofouling organisms including zebra mussels, bryozoans, sponges, and pulmonated snails, with all being absent post-treatment in the central cylinder. The control outer untreated portions of the tank receiving harbor water inflow (tank wall, central cylinder outside wall, cooling tubes external surface, multiplate artificial substrates) had large populations of these organisms, zebra mussels (>1575/m2); bryozoans (>28% surface coverage); sponges (>45/m2); snails (>540/m2).

The strip tank treated portions that included the inner wall of the central cylinder, the standpipe outer wall, and the cooling tube inner wall were had no colonization of the same invertebrate biofouling organisms (zebra mussels, bryozoans, sponges, and pulmonated snails), except for a single snail specimen living at the water/air interface in the central cylinder. Freshwater pulmonated snails are tolerant to adverse conditions to a large part because they lack gills but rather have a pulmonated mantle cavity that uptakes oxygen taken up from the atmospheric air. Thus, they are able to tolerate low oxygen environments and avoid gill susceptibility to harsh chemicals.

The strip tank cooling tube lumens had no biofouling organisms; however, there was slight accumulation of debris on the wall (cf. figures). In comparison, the skirt tank cooling tube lumen had considerably more accumulation of debris on the wall (cf. figures) than the strip tank tube lumen. This differential could be related to the presence of a microfilm (bacteria?) on the inner wall of both the strip and skirt tank, and also to greater biological activity of small invertebrates, especially nematodes and rotifers that were present in the tubes of the skirt tank (a single nematode was noted in the central cylinder of the strip tank).

A comparison of the diversity changes in the strip tank (Table C6) indicated that during the course of the 4-month experiment, the system disproportionately decreased rare taxa relative to common taxa suggesting a skewed spectrum impact of the biofouling treatment. Relative to the skirt tank diversity (cf. below), this could be due to the greater surface treatment area and confined contact of the water within the central cylinder. This is suggestive of greater induced stress (the treatment) as compared to the skirt system. Also, this may be supported in reference to the skirt tank system (below) where there was greater fouling away from the peripheral tank treated fabric, i.e. less treatment contact with the water. These diversity related inferences are preliminary suggestions based on limited data.

The skirt tank showed a considerable deterrent to biofouling especially nearer the treated fabric lining the tank wall and especially for preventing mussel, bryozoan, sponge and snail biofouling as compared to the strip tank wall that served as a control. Low numbers of mussel veligers were found in the debris accumulation on the skirt fabric, but they apparently did not metamorphose to juveniles as juveniles nor adults were present on the skirt.

The arrangement of the skirt tank treated fabric, the multiplate artificial substrate and the central cylinder provided an opportunity to observe biofouling differences over 65 cm ranging from close to the wall fabric to the multiplate and to the central cylinder most distant from the treated fabric. Zebra mussels were effectively zero on the fabric skirt, 7/m2 on the multiplate and 31/m2 on the central cylinder. Bryozoan biofouling was zero at the fabric, to ˜1% coverage on the multiplate, to ˜10% coverage on the central cylinder. Sponges and snails were consistently absent on the multiplates and central cylinder. In general, the biofouling was considerably lower in the skirt tank than in the control strip tank (outer area).

A comparison of the diversity changes in the skirt tank (Table C7) indicated that during the course of the 4-month experiment, the system proportionately impacted rare and common taxa suggesting a broad spectrum impact of the biofouling treatment.

Treated fabric skirt provides at least 4 months of protection from settlement biofouling organisms. Biofouling was considerably lower in the skirt tank compared to the control unprotected tank. Skirt tank shows a considerable deterrent of invertebrate biofouling organisms including zebra mussels, bryozoans, sponges, and pulmonated snails. Low numbers of mussel veligers were found in the debris accumulation on the skirt fabric but never metamorphosed to juveniles or adults. Zebra mussels were present 7/m² on the multiplate and 31/m² on the central cylinder. Sponges and snails were consistently absent on the skirt fabric, multiplates and central cylinder. The cooling tube inner walls exposed to treated water from the skirt experiment contain more debris accumulation compared to the cooling tube inner walls exposed to treated water from the strip experiment. Treated water turbidity was significantly higher in skirt tank compared to the treated water turbidity in the strip tank. The tank inner wall for the skirt experiment contained greater presence of microfilm compared to the tank inner wall for the strip experiment.

The treated water in the strip experiment contained less biological activity of biofoulers compared to the treated water in the skirt experiment. Strip tank shows clear inhabitation of invertebrate biofouling organisms including zebra mussels, bryozoans, sponges, and pulmonated snails. The cooling tube inner walls exposed to treated water from the strip experiment contain 74% less debris accumulation compared to the cooling tube inner walls exposed to treated water from the skirt experiment. Organism diversity changes in the strip tank indicated that the system disproportionately decreased rare taxa relative to common taxa suggesting a skewed spectrum impact of the biofouling treatment. This could be due to the greater surface treatment area and confined contact of the water within the central cylinder which leads to greater induced stress as compared to the skirt treatment. The strip tank bioball substrates showed a 15.6% reduction in microfouling over the 4 month period.

Residence Time and Dwell Time

In some cases, it may be possible to create a reservoir of water or other aqueous fluid that is significantly more than a few seconds, a few minutes, a few hours, a single day or a week's worth of fluid usage by a given water system, wherein a variety of water chemistry “differences” such as those described herein may be induced within the reservoir to create, maintain and manage the various desired antifouling effects on substrates within the water system. In other situations, however, it may be necessary and/or desirous to construct a system having little or no reservoir capacity, such as directly drawing water from a natural source for immediate usage and/or a incorporating a reservoir that supplies significantly less than a single day or even a few hours of water usage, especially where design constraints may be limited by the amount of available real estate, environmental concerns and/or other concurrent uses of the aqueous medium. In such cases, it may be desirous to provide a continuous and/or periodic water conditioning treatment, such as previously described, which may artificially induce and/or accelerate the various water chemistry factors described herein. In such a case, the water chemistry within the reservoir may be monitored on a periodic and/or continuous basis, with one or more water conditioning treatments being applied to the water within the reservoir on an as-needed basis.

For example, it can be possible to determine a desired minimum enclosure size and related components by comparing an amount of anticipated needs in a day or so and the required time to allow the water chemistry to reach a desired and/or acceptable level within some or all of the water system (which may be referred to as “dwell time,” “residence time” and/or “turn over time” in various alternative embodiments). The terms “Residence time” and/or “dwell time” and/or “turn over time” and similar may be used interchangeable for some preferred embodiments. “Residence time” is a well-known term applied to fluid retention times within fluid reservoirs and is generally a measure of the average time a molecule of water spends in a reservoir. The residence time defined for steady-state systems can be equal to the reservoir volume divided by the inflow or outflow rate, although in some systems (including various embodiments disclosed herein), the residence time may optionally incorporate a certain amount of “mixing” of liquid within the reservoir into the equation. The residence time of a fluid parcel can alternatively be the total time that the parcel has spent inside a control volume (e.g.: within a reservoir, within a water system, within a chemical reactor, within a heat exchanger or other component, within a lake and/or even within a human body). The residence time of a “set” of parcels can be quantified in terms of the frequency distribution of the residence time in the set, which is known as residence time distribution (RTD), or in terms of its average, known as mean residence time.

“Dwell time” can have a similar definition, but is typically applied (i.e., used in military and/or computer applications) specifically as “residence time”. In general, residence time is a mathematical relationship of volume and flow rate (volume/flow rate)—moreover, residence time can be generally treated as the inverse of turnover rate.

In various embodiments of antifouling systems, the system components may include one or more components providing a sufficient dwell time and/or residence time in protected waters of the water system, such as where there is sufficient time for the dissolved Oxygen (DO) and/or other water quality elements to change to desired levels as well as desirably provide sufficient time for fouling organisms to assess and evaluate settlement attractiveness within the protected environment. Where preconditioning of the water can occur for a sufficient dwell time, this may allow fouling organisms to make an assessment in some embodiments to avoid settlement and/or colonization.

In various embodiments, the amount of dwell time sufficient to inhibit and/or prevent fouling of a substrate and/or water system component may vary with a variety of factors, including water flow, temperature, bio-floral type, growing season, salinity, sunlight, available nutrients and/or oxygen, pollutants, etc. In some cases, a minimal amount of water chemistry changes may be necessary to achieve a desired result, while in other embodiments more significant water chemistry changes may be necessary to achieve a desired result. In some cases, only a few seconds, minutes, or hours of dwell time after passing into and/or through an antifouling enclosure may create sufficient water chemistry changes, while longer dwell times, days or months or years, may be desirous and/or necessary to achieve desired results. The dwell time needed for optimum results may be tuned or modified based on the application. Some applications require a dwell time of 10 seconds, 30 seconds, 1 minute, 4 minutes, 10 mintues, 30 minutes, 1 hour, 2 hours, 4 hours, 6 hours, 12 hours, 24 hours, 3 day, 7 days, 10 days, 14 days, 30 days, 60 days, 3 months, 6 months, 9 months, or 12 months.

For example, one exemplary embodiment of an antifouling system can comprise a filtration and/or dosing unit comprising at least one layer of a permeable structure having an outer surface, an inner surface and a plurality of pores extending therebetween, the permeable structure having a biocide coating on the outer surface which extends at least partially into the plurality of pores, the filtration unit being positioned proximate to a water intake location of the water circuit, wherein some or all of a water passing through the water circuit passes through the filtration unit, with the water requiring an average dwell time to travel through the filtration and/or dosing unit and the water circuit and be expelled from a water discharge of the water circuit, where the biocide coating can elute a biocide into the water passing through the filtration and/or dosing unit, the biocide contacting a plurality of fouling organisms in the water and inhibiting an ability of at least one species of the plurality of fouling organisms to colonize one or more substrate surfaces within the water circuit for at least the average dwell time.

In some embodiments (such as in higher flow rate systems), it may be sufficient for the antifouling system to merely reduce and/or limit the amount of time that organisms have to assess and/or “reject” the environmental aquatic conditions to sufficiently deter colonization and/or settlement, which may optionally coincide with various water chemistry changes and/or other effects provided by the antifouling system. In some other cases, however, higher flow rates in a water system may force and/or pull fouling organisms into and/or through a protected environment before said “assessment” by the organisms can be accomplished and/or the desired water chemistry changes take effect, which may result in an increase in fouling due to “opportunistic” settlement and/or colonization occurring at a higher rate, which may be further exacerbated by alteration of the rates of natural detachment of the organisms as well as differing levels of opportunistic “grazing” of the fouling organisms by microscopic predators and/or the like. In many cases, a “sweet spot” for a desired flow rate (or range or flow rates) will desirably be obtained that minimizes settlement and/or colonization by fouling organisms while increasing and/or promoting fouling organism detachment and/or consumption of fouling organisms by microscopic predators, etc.

In some embodiments, an antifouling system will desirably create one or more conditions that prevent and/or inhibit a variety of fouling activities within the protected environment, such as by inducing the creation of anti-fouling biofilms within the protected environment, killing and/or injuring fouling organisms and/or inducing behavior of various organisms within the protected environment that may inhibit settlement, colonization and/or growth of fouling organisms on substrates. For example, such inhibitory activities could include direct effects on the fouling organisms themselves (i.e., inhibiting colonization and/or growth or promoting detachment) as well as effects on organisms that may create and/or develop biofilms within the protected environment and/or on predatory organisms that may prey on fouling organisms within the protected environment. Such inhibitory effects may be permanent, durable and/or long lasting, or may be temporary for a desired period of time, such as for 2 seconds or less, for 5 seconds or less seconds, for 30 seconds or less, for 1 minute or less, for 5 minutes or less, for 10 minutes or less, for 30 minutes or less, for 1 hour or less, for 6 hours or less, for 12 hours or less, for 1 day or less, or for other lengths of time within some or all of the protected environment or various portions thereof.

In some instance where a minimum reservoir size cannot be attained, or where the water chemistry changes require an undesirable amount of time to attain, it may be desirous to condition the water on an as-needed basis, which may include periodic “refresher” treatments as the water within the reservoir is drained and/or otherwise replaced. Moreover, where the use of a large reservoir is not desired, the various water conditioning treatments described herein may be utilized in smaller reservoirs and/or even within the suction piping of the facility on a continuous basis, if desired. In such a case, the various water conditioning treatments described herein could be used to condition the water continuously (such as in a water plant) with Nitrogen or other gases and/or chemicals. Such treatments may be particularly useful where there is not enough dwell time within a given reservoir to accomplish batch processing, or where a closed loop processing technique to continuously treat water may be desirous (i.e., with a closed testing and treatment loop to determine and/or maintain a desired water chemistry level (oxygen level, etc.) within certain ranges. In various embodiments, the various system designs and/or water conditioning treatments described herein may be utilized separately and/or together on an as-needed basis, which could include the sole use of the reservoir during low water demand periods, and the use of both techniques concurrently during periods of higher water demand, if desired. In a similar manner, the water conditioning treatments described herein may be utilized alone during low water demand periods, with the use of both water conditioning with a concurrent enclosure during periods of higher water demand. It should also be understood that different environmental conditions may necessitate different treatments for the aqueous medium, including seasonal and/or other differences in temperature, sunlight, salinity, high/low water levels, high/low fouling season, etc.).

In many instances, specific species of fouling organisms will survive and thrive within an optimal range or ranges of conditions, including ranges of temperature, oxygen or other dissolved gas levels, dissolved solid levels, pH, water flow rate and other conditions. With regards to water flow rates, the specific optimal flow rates will often depend on the type of fouling organism. Many fouling organisms have adapted to “higher” flowing waters to survive; for example, zebra mussels were originally river species and thrive in high flow rates. The optimal flow rate for many fouling organisms can be dependent on the organisms' ability to swim and what they eat (i.e. high flow rates often help to deliver food to immobile or less mobile organisms). Often, if a flow rate gets too low or below a critical low flow level for the organism, the organism may “starve,” start to breakdown and become unhealthy due to lack of food and nutrients (including dissolved Oxygen, Nitrogen and/or other factors). If a flow rate becomes too high, some organisms may not have the time or means to settle and/or flourish on a substrate. In general, most organisms have a “sweet spot” for their optimal flow rate, which may be exploited in some embodiments as part of an antifouling enclosure system.

Large Water Systems and Heat Exchanger Efficiencies

Large scale fluid systems are used in a wide variety of processes, and at their most basic process, these systems rely on fluid movement and fluid consumption. Often, the fluid will comprise water, which in many cases may be salt water drawn from a bay, sea and/or the ocean, fresh water drawn from a river, lake or well/aquifer or wastewater from various sources. Some facilities utilize a once-through or single-pass cooling process, in which water is drawn into the system of the plant and utilized for a single pass through the process and/or equipment, and then the water is discharged to the environment, while other facilities use water recirculating systems that include a tower or reservoir before the water goes into the process, equipment or apparatus that seeks to withdraw unused or unconsumed water, allowing this unconsumed water to be passed back through the process or equipment multiple times. While recirculating water systems draw less water from outside sources as compared to single pass systems, recirculating systems still typically require significant amounts of “make-up” or replacement water to replenish water lost to evaporation (for open recirculating systems) and “blow-down” or discharge of liquids containing concentrated dissolved solids.

In some cases, a once-through or single pass system can utilize between 20 to 40 times more water to remove waste, heat, or other undesired parameters as a reservoir system operating with 5 cycles of recirculation. For a non-limiting example, an electrical power generating plant using once-through cooling may withdraw 20,000 to 50,000 gal/MWh produced, while a comparable plant using recirculating cooling may draw only 500 to 1,200 gal/MWh. While the water load for a once-through plant is immense, on the order of 3,500,000 to 8,750,000 gallons per hour to supply a 175 MWh power plant, even recirculating plants still require significant amounts of water, on the order of 87,500 to 210,000 gallons per hour for an equivalent 175 MWh.

Water is a favorable environment for many life forms. In a single-pass system, the water drawn into the system generally teems with adult and/or juvenile fouling organisms, and/or larval, many of whom will seek to colonize various submerged surfaces. Even for recirculating systems without or with reduced water intake (as compared to the single-pass systems), any replacement or “make-up” water entering the system will typically contain numerous living organisms, and the flow characteristics of the recirculating water systems often encourage colonization by sessile organisms to use the circulating supply of food, oxygen and nutrients, and in some embodiments, water temperatures may become high enough to support thermophilic populations in various parts of the system. These organisms will often colonize the wetted surfaces of any surface or material within the water system, including tubing, valves, grates, filters, pumps, etc., which can significantly reduce water consumption rates of the system or any desired production rate of the system. In many cases, even thin biofilms formed on a system surface will significantly insulate this surface, reducing its efficiency and greatly increasing the overall operating costs for the system. In various embodiments, the disclosed systems can significantly improve the efficiency, functionality and/or durability of any desired process in small-scale or large-scale water systems, for a non-limiting example, cooling water systems. For a non-limiting example, cooling water systems for heat exchanger where heat transfer from a hotter fluid or gas to a colder fluid or gas, with this heat typically travelling through a “heat transfer surface,” which is often the metallic walls of heat transfer tubing which separate the hot and cold substances.

### Percentage Reduction in Heat Transfer

TABLE 8
Film Thickness and Surface Heat Transfer Efficiency
Additional Energy Costs Per Year Due to Bio Fouling

| Tons of Chiller | Bio Film Thickness (mm) | | | |
|---|---|---|---|---|
| Capacity | 0.2 | 0.3 | 0.6 | 0.9 |
| 300 | $7,906 | $15,811 | $35,575 | $53,363 |
| 500 | $13,176 | $26,352 | $59,292 | $88,938 |
| 900 | $23,717 | $47,434 | $106,726 | $160,088 |
| 1200 | $31,622 | $63,245 | $142,301 | $213,451 |
| 2000 | $52,704 | $105,408 | $237,168 | $355,752 |

### Table 9: Increased Operating Costs Due to Biofouling

In various embodiments, the disclosed antifouling systems can include methods of reducing biofilm formation within any water system, such as, a heat transfer tubing of a heat exchanger and/or cooling tower, with system components including a flexible porous structure component (with an optional biocide coating applied to a first surface of the flexible porous structure), the flexible porous structure having a plurality of pores extending from the first surface to a second surface of the flexible porous structure, and placing the structure in a water stream of the cooling tower at a location upstream from the heat exchange/heat transfer tubing, wherein the water stream flows through the plurality of pores from the first surface to the second surface (and the optional biocide elutes from the coating into the water stream in some embodiments), wherein water chemistry changes and/or the optional biocide contacts a plurality of biofouling organisms within the water stream and thereby creates a reduced thickness biofilm on an interior surface of the heat exchanger/heat transfer tubing as compared to an untreated biofilm thickness from an untreated water flow.

In addition to directly reducing heat transfer efficiency, biofouling also typically causes and/or leads to scaling and/or corrosion on wetted metallic surfaces because, as the biofilm thickens, less oxygen may be accessible to the materials of and/or cells next to the tube wall. Bacteria such as sulfate-reducing strains and others can generate metabolites that attack the metal in a process called microbiologically influenced corrosion (MIC). In studies carried out in the 1980s and early 1990s, it was estimated that the costs of cleaning, fluid treatment, replacement of parts and loss of production due to heat exchanger fouling was approximately 0.25% of the GDP of all industrialized countries. For a process plant, the estimated cost for repairing heat exchangers and boilers was approximately 15% of the maintenance costs of the entire plant, with about half of this value due solely to fouling. In 2016, the Worldwide Corrosion Authority (NACE International) estimated that the global cost of corrosion was 2.5 trillion US Dollars.

In many systems, heat exchanger components are typically overdesigned by at least 70% to 80%, which amount desirably includes compensation for anticipated efficiency reductions of 30% to 50% due to fouling of heat exchange surfaces. In addition to reducing heat transfer, the buildup of fouling can also reduce the cross-sectional area of the tubes or flow channels, which increases the resistance of fluid passing over the heat transfer surfaces. Continued reduced flow can dramatically increase the pressure drop across the heat exchanger, further reducing flow rates and aggravating heat transfer problems (including eventual blocking of the heat exchanger tubing). By controlling and/or ameliorating the effects of biofouling in many of these systems, however, the present systems allow an operator to reduce this required “overdesign” by a significant level, which can result in substantial savings in capital equipment.

Similarly, biofouling which occurs in various elements of any recirculating water system, such as, cooling towers which can significantly alter flow distribution and dramatically reduce evaporative cooling rates. Biofouling in these systems may also create undesirable effects, such as oxygen concentrations that increase corrosion rates in the metallic walls of the system, as well as facilitate the growth and distribution of potentially deadly organisms such as Legionella bacteria which live within amoebas. In various embodiments, biofouling protective system embodiments can include a device for reducing the occurrence of legionella in a water flowing in a water circuit of a manufacturing or power plant, comprising an enclosure unit comprising at least one layer of a permeable structure having an outer surface, an inner surface and a plurality of pores extending therebetween, the permeable structure having a biocide coating on the outer surface which extends at least partially into the plurality of pores, and an oxygen removal system that removes at least a portion of the dissolved oxygen in water passing through the enclosure unit; the enclosure unit positioned at a water filtration location of the water circuit, wherein at least some portion of the water in the water circuit passes through the enclosure unit, wherein the biocide coating elutes a biocide into the water passing through the enclosure unit, the biocide contacting a plurality of legionella organisms in the water and inhibiting an ability of the plurality of legionella organisms to thrive or colonize one or more substrate surfaces within the water circuit.

In various embodiments, biofouling protective system embodiments are disclosed that can significantly reduce the thickness and/or extent of biofouling films formed on any surface of a water system, for a non-limiting example, heat exchanger tubing, thereby reducing the insulating effects of biofouling and ensuring the maintenance of optimal heat transfer efficiency levels within the system. In some embodiments, the biofouling protective systems described herein may provide fouling protection for the entirety and/or multiple portions of a system, while other embodiments may provide “localized” or particularized protection for specific areas and/or “modules” of the system, such as, wetted heat transfer surfaces of one or more heat exchangers in the system, for a non-limiting example.

In one exemplary embodiment, a biofouling protective system can include an optional biocide impregnated enclosure or “biocidal filter” element through which some or all of a water flow may pass. Desirably, the element can inhibit and/or “filter out” some and/or all of various “larger” fouling organisms, including adult organisms of many fouling species, and larger settling larvae, like tunicates, while the biocide in the element will desirably kill, injure and/or inactivate various “smaller” and/or immature fouling organisms. Such inhibition can desirably include inhibition against colonizing wetted surfaces for a limited period of time, such as, for example, the amount of time necessary for a targeted fouling organism to pass through heat exchange tubing and/or the entirety of a water system (in a single-pass system, for example). In various embodiments, the environmental changes potentially induced by the antifouling system (which may include effects from the optional biocide impregnated fibrous matrix medium) can induce the formation of a thin, minimal and/or thermo-conductive biofilm on any system surfaces, for a non-limiting example wetted heat transfer surfaces, which will desirably provide an increase in thermal transfer efficiencies and/or the useful life of the heat transfer components as compared to the thermal transfer efficiencies/components of existing heat transfer systems which may be negatively impacted by biofouling. In various alternative embodiments, the antifouling system can induce the formation of an easily removeable or reducible biofilm on any system surface, for a non-limiting example wetted heat transfer surfaces, which may be removed using less expensive and/or less invasive cleaning methods as compared to existing biofilms.

For a non-limiting example, an antifouling system positioned upstream from a heat exchanger unit may include a water treatment enclosure including a flexible porous structure with a coating comprising a biocide applied to a first surface of the flexible porous structure, the flexible porous structure having a plurality of pores extending from the first surface to a second surface of the flexible porous structure, where the coated structure is placed into the water stream having a first average temperature, wherein the water stream flows through the plurality of pores from the first surface to the second surface at a first average water temperature and the biocide elutes from the coating into the water stream, the biocide contacting the plurality of biofouling organisms, wherein the water stream is heated to a second temperature which is higher than the first average temperature and the biocide inhibits the plurality of biofouling organisms from colonizing a substrate surface in contact with the water at the second temperature of the water stream. In various embodiment the effectiveness of the biocide at providing fouling protection for the water at both the first and second water temperatures may be equivalent, may be improved to some degree from the first temperature to the second temperature and/or may be degraded to some degree from the first temperature to the second temperature. In various other embodiments, the temperature of the water may alter the rate at which a biocide elutes from the coating, including increased temperatures that increase biocide elution as well as increased temperatures that decrease elution of one or more biocides (which may include differing alteration of individual biocide elution rates for multiple-biocide formulations within a single coating).

Various embodiments may include components that contribute to a reduction of microbiologically influenced corrosion (MIC) from a plurality of biofouling organisms in a water stream of a water system, where the system can include a flexible porous structure (with an optional coating comprising a biocide that is applied to a first surface of a flexible porous structure, the flexible porous structure having a plurality of pores extending from the first surface to a second surface of the flexible porous structure), and placing the coated structure in the water stream, wherein the water stream flows through the plurality of pores from the first surface to the second surface and induces water chemistry changes and/or optionally elutes the biocide from the coating into the water stream, with the water chemistry changes and/or biocide inhibiting the plurality of biofouling organisms from colonizing a substrate surface positioned downstream from the structure.

In various embodiments, the biocide impregnated enclosure will desirably inhibit biofouling growth onto and/or within the enclosure itself, which will greatly enhance the performance, service life and/or serviceability of the enclosure in the disclosed systems. The presence of the biocide will desirably inhibit attachment, settling and/or growth of organisms on the outer and/or inner surfaces of the enclosure, which can maintain flexibility of the enclosure as well as significantly reduces the chance for ripping, tearing and/or other failure of the fibrous matrix due to the presence and/or increase in gross weight caused by the fouling organisms. In addition, the presence and distribution of the biocide will further desirably prevent and/or inhibit fouling organisms (especially spores, propulgates, larvae and/or juvenile forms) from attaching, settling and/or growing within the openings and/or “pores” of the enclosure. In many cases, a biocide may have very different levels of effectiveness on adult and juvenile members of the same species, with a significantly higher dosage of a given biocide often required to prevent fouling activities by larger and/or mature organisms as compared to the dosages needed to protect against smaller and/or juvenile organisms. By inhibiting the passage of larger organisms through the enclosure, and applying highly effective doses of biocide directly to the smaller organisms as they pass through the biocide coated pores of the enclosure, the present system provides for highly effective fouling protection without requiring highly toxic levels of biocide and/or other system components.

In various embodiments disclosed herein, the inclusion of one or more biocides and/or other chemicals/toxins within a coating which is applied to and penetrates the surface of a flexible fibrous matrix can significantly improve the dosing and effectiveness of a given biocide into an aqueous medium such as environmental water flowing through the matrix of an antifouling enclosure. In many instances, the bulk water flow which contacts the matrix will be “broken” or fragmented into numerous individual “streams” of water passing through openings, pores and/or gaps in the structure (i.e., between the individual threads of the structure weave, in some embodiments). These individual streams of water will desirably pass by the individual threads of the matrix, with many of the threads having a coating which elutes the biocides and/or other chemicals/toxins into the water flowing directly alongside. These stream of water and eluted biocide will continue passing through the fibrous matrix, wherein the tortuous path through the matrix will desirably continually mix, agitate and distribute the water with biocide or other chemicals throughout the various water streams and the fouling organisms contained therein. Once the water leaves the matrix, the water streams will recombine into a bulk flow of “treated” water, wherein the vast majority of fouling organisms will have contacted and been affected by the biocide or other chemicals during and/or after their passage through the fibrous matrix. In this manner, the individual stream dosing accomplished by the biocide impregnated matric in the disclosed antifouling systems represents a significant improvement over existing biocide or other chemical dosing systems currently in use.

Because there can be an extremely large number of “pores” or other openings within a given area or volume of enclosure structure, with the walls of these “pores” potentially coated with a biocide eluting coating, the effective elutive surface area of the structure within the water flow can be many times greater than that of an equivalent flat surface. In many instances, an amount of biocide eluted into a water flow through such porous media can be a factor of 1.1, 1.5, 2, 3, 4, 5, 6, 7, 8, 9, 10, 100, 1000 or more times greater than the amount eluted from an equivalently sized flat surface. Moreover, because the biocide can be eluted directly into each of the myriad water streams passing through the structure pores, the distribution and uniformity of biocide within the water stream is greatly enhanced as compared to bulk or periodic dosing from one or more locations along the water stream. In addition, a flexible enclosure structure can be manipulated (i.e., compressed and/or expanded) in a variety of ways to further enhance its utility in various environments (i.e., compressing and/or “scrunching” a structure media to reduce its overall size but retain its larger effective surface area).

In various embodiments, a significant portion and/or all of the aqueous medium “downstream” of a disclosed antifouling device will have desirably passed through one or more biocide impregnated enclosure components, while in other embodiments some portion of a fluid flow may have bypassed and/or not passed through a biocide impregnated enclosure. For example, a “skirt” or other biofouling protective device may incorporate peripheral “walls” of a biocide impregnated enclosure, while various openings and/or the bottom of the device may be open to the surrounding environment. In such a case, biofouling may still be effective for any protected substrates, because the enclosure present and the effects thereof may still provide some reduction in fouling of protected substrate as compared to an unprotected substrate. In a similar manner, an aqueous flow of water or other liquid may benefit from partial “filtering” of the waterflow through the biofouling protective devices disclosed herein (i.e., which may incorporate one or more antifouling units comprising biocide impregnated enclosure), as such filtration can desirably remove and/or inactivate both larger and/or smaller fouling organisms within the water stream, while some amount of eluted biocide within the water stream will mix with the remaining untreated water to potentially inhibit the activity of biofouling organisms within areas downstream of the fibrous matrix. Such “partial filtration” of similar antifouling systems may have particular utility in recirculating water streams such as cooling towers and/or the like.

Structure Design and Material Properties

In various embodiments, a wide variety of structures and/or other structures are described which can be incorporated into some or all of the fouling protective systems described herein. In many of these embodiments, a coating or paint may be incorporated into the structure, with the coating or paint including one or more biocidal and/or bio-toxic substances which can be released and/or elute into fluid flowing through the structure and/or pores thereof.

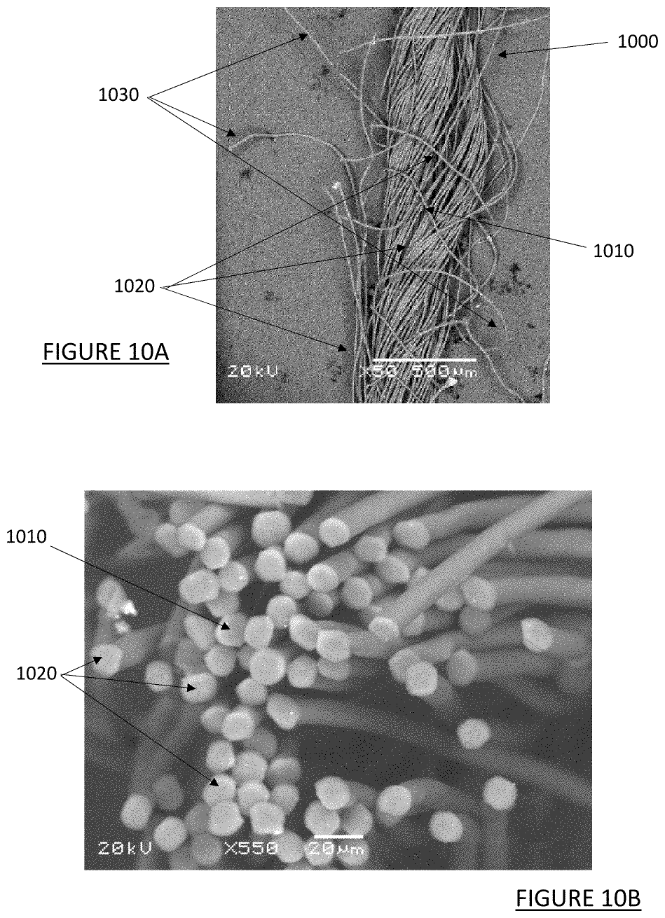

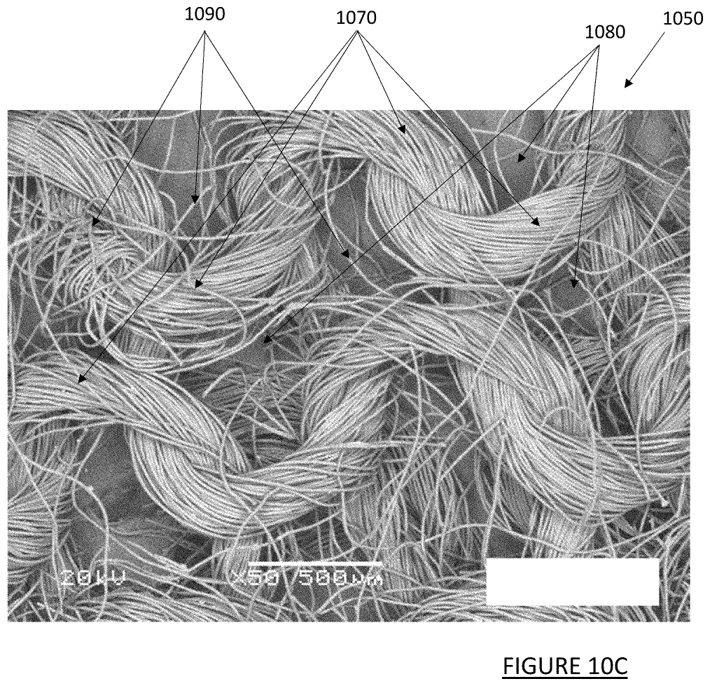

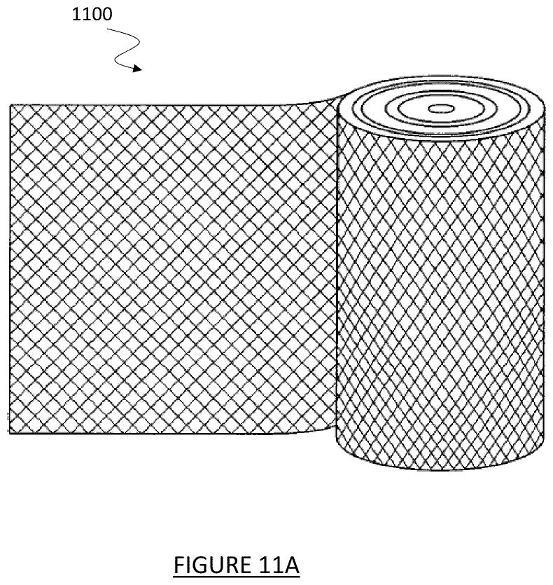

FIG. 10A depicts one exemplary scanning electron microscope (SEM) micrograph of an exemplary spun yarn 1000, which depicts a central body or yarn bundle 1010 of intertwined filaments 1020, with various filament ends 1030 extending laterally relative to the central body 1010. FIG. 10B depicts a cross-sectional view of the central body 1010, highlighting the very fine size of the individual filaments 1020 within the yarn bundle 1010. As best seen in FIG. 10C, which depicts an enlarged view of a knit structure 1050 comprising PET spun yarn, a series of interstices or openings 1080 are positioned between the yard bundles 1070 during the knitting process, with one or more extending fibers or fiber ends 1090 extending across various of the openings (with multiple fiber ends desirably traversing each opening in various embodiments).

In various embodiments, the structure or enclosure and the substrate(s) protected therein can be separated and/or spaced apart by a minimum spacing (i.e., between an inner wall of the enclosure and an outer surface of the substrate) of about 200 inches, or about 150 inches, or about 144 inches, or of about 72 inches or less, or about 36 inches or less, or about 24 inches or less, or about 12 inches or less, or about 6 inches or less, or about 1 inch or less, or about 1 inch or greater, or about 6 inches or greater, or from about 1 inch to about 24 inches, or from about 2 inches to about 24 inches, or from about 4 inches to about 24 inches, or from about 6 inches to about 24 inches, or from about 12 inches to about 24 inches, or from about 1 inch to about 12 inches, or from about 2 inches to about 12 inches, or from about 4 inches to about 12 inches, or from about 6 inches to about 12 inches, or from about 1 inch to about 6 inches, or from about 2 inches to about 6 inches and/or from about 4 inches to about 6 inches. In various alternative embodiments, at least some or all of the enclosure may be in direct contact with the substrate in one or more areas (including, but not limited to, a closure portion of the enclosure), and thus there may be substantially little or no distance between the media and substrate in some embodiments.

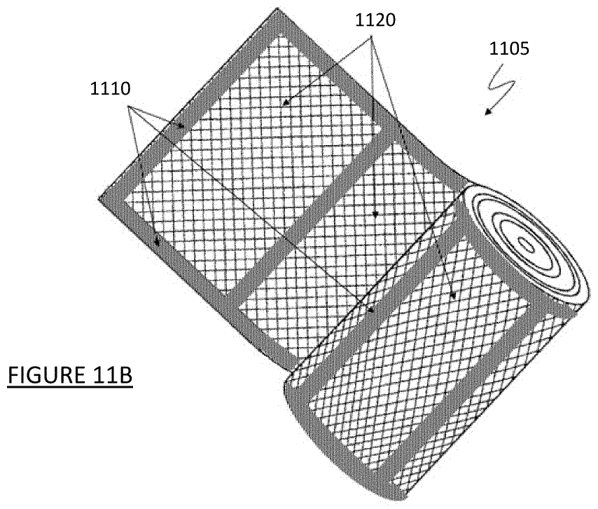

FIG. 11A depicts an exemplary structure material 1100 in a rolled sheet form, which can be used in a variety of ways to form various antifouling systems and/or elements described herein. In this embodiment, the material desirably comprises a flexible fibrous material, in this case a structure material, which can include natural fiber cloth as well as woven, knitted, felted, non-woven and/or other structures of polyester or other synthetic fibers, and/or various combinations thereof. In various embodiments, the structure may be utilized to construct the various embodiments described herein, and/or it may be possible and/or desirous to wrap or otherwise “cover” an elongated substrate with such rolled sheet material, especially where the unrolled and wrapped sheet may overlap other sheet sections (i.e., along a piling or support girder) which may create an “enclosure” comprising a progressively wrapped substrate or water intake wherein the structure material is wrapped around the substrate in an overlapping “barber pole” or maypole-type technique or lining inner walls of water tank or irrigation pipes. In such a case, it may be desirous for the structure to directly contact the protected substrate or intake, with a very thin layer of liquid between the structure enclosure walls and the substrate surface (as well as optionally the liquid within the structure itself) constituting a “differentiated environment” as described herein.

In one embodiment, one or more structure and/or enclosure wraps may fully or partially enclose a substrate or portions of a substrate. In a non-limiting example, wrapping wood pilings with enclosure material in a “barber pole” technique eliminates or significantly reduces fouling on the wood substrate when the substrate is completely submerged, partially submerged or positioned at the waterline for at least eighteen months, or at least 12 months, or at least 6 months, or at least 3 months.

In an experiment, Pilings with loose enclosure bags that cover the entire length (Bag), a tight enclosure wrap on the entire length of the piling (Wrap), a tight enclosure wrap partially covering the piling at the waterline (Waterline) and unprotected pilings (Open) were randomized and suspended from a line so that they would maintain a section above the highest tides. Treated enclosure bags and enclosure wraps significantly reduce fouling on wood pilings for at least 18 months. Enclosed and wrapped wood pilings contained light fouling consisting of tube worms and barnacles with no outward signs of boring. Further, treated enclosures and wraps contained fouling on the fabric after 18 months of immersion. Structures, enclosure wraps and bags reduce the cover of fouling significantly, even after more than 1.5 years.

Enclosure wraps have shown to eliminate or reduce the presence of boring organisms on wood pilings for at least 18 months, or at least 12 months, or at least 6 months, or at least 3 months. Treated enclosures fully closed around a wood piling prevented boring on wood pilings, whereas fabric wrapped around wood pilings significantly reduced boring on the wood for at least 18 months; whereas boring had occurred on the wood not protected by the enclosure or wrap. Boring was significantly decreased under enclosure wraps and prevented by the bags where there was no way in for the teredos. The amount of biofouling and boring on wood pilings or other wood substrates may be reduced by 100%, or 99%, or 75%, or 50%, or 25%, or 10% when fully or partially enclosed by at least one bag or wrap after submersion in salt or fresh water for at least 18 months.

FIG. 11B depicts another exemplary embodiment of a rolled-up sheet structure 1105 that incorporates adhesive, hook-and-loop fastener material 1110 (and/or sewn seams) along various portions of the structure, which can desirably self-adhere to other structure portions and/or to other devices and/or components, with the majority of the structure comprising perforated or permeable portions 1120 as described herein (and in various embodiments the fastener materials themselves could comprise permeable and/or non-permeable portions as well). If desired, a material flap covering some other structure portion could be non-permeable and protect underlying structures.

In use, the structure could be wrapped around a water intake or support girder or other structure to form an enclosure around some portion of the intake or protected substrate, which could include a progressive wrapping method (i.e., a “barber-pole” type wrapping) or a circular wrapping method (i.e., a “round-robin” type wrapping) to create various enclosures similar in function to those described herein, to protect various portions of the water intake and/or water system from biofouling organisms and/or other degradation. In various embodiments, attachment using hook and loop, or similar fasteners may be particularly desirable, as such fastening techniques can be rendered permeable and allow water exchange therethrough in a manner similar to the various permeable materials described herein.

In another embodiment, the structure or enclosure (fully or partially enclosed) may protect metal chains or other metal substrates from fouling and corrosion. Treated structures and enclosures provide effective protection and greatly decrease fouling and decrease corrosion on metal chains for at least 19 months, or at least 18 months, or at least 12 months, or at least 6 months, or at least 3 months.

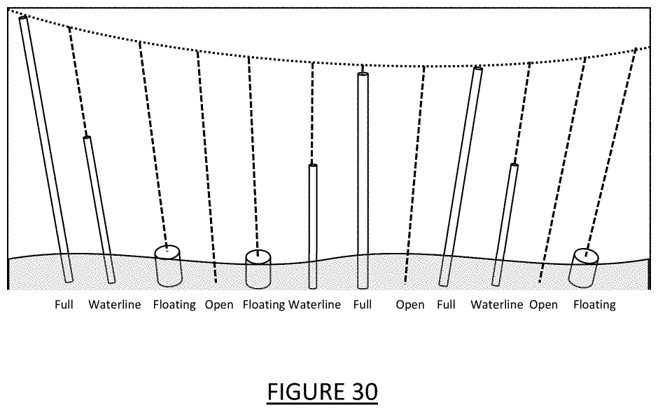

In one experimental test, metal chains were suspended from an 18′ dock at Cape Marina or from a 10′ barge at the same marina. The chains on the dock are fixed with relation to the tide so have a fully exposed, fully immersed, and intertidal (immersed/immersed) section. The chains on the barge float with the changing tide to have a fully immersed, fully exposed and waterline section. As shown in FIG. 30, four treatments for the chains and one control were tested with three replicates each: (1) Chains with fully enclosed structures/enclosures that cover the entire length (Full), (2) Chains with structures/enclosures that are fixed around the waterline (Waterline), (3) chains with structures/enclosures that are floating (via boom) at the waterline, i.e. the protective structures move with the tide (Float) and (4) control that is unprotected (Open). Chains fixed on the dock were randomized and suspended from a line so that they would maintain a section above the highest tides. Chains fixed on the barge were suspended from cleats and were placed in a block design due to space constraints. All chains were immersed mid-February.

Chains fully enclosed with at least one structure contained very light fouling consisting of tube worms scattered on the length of the chain after 19 months. Treated structures/enclosures provide effective protection for at least 19 months for metal chains positioned at the waterline in areas covered by the enclosure. Light fouling started to accumulate on the chains protected the enclosure. Floating waterline enclosures started to degrade and contain holes with fouling on the nonprotected chains by 19 months.

Corrosion may become present anywhere there is an oxygen cell forming on metal when immersed in water. Oxygen cells occur in areas with an oxygen or other chemical gradient in water. Protective structures or enclosures (bagged or wrapped) can reduce or eliminate the effect of corrosion on metal when immersed in water for at least 19 months, or at least 18 months, or at least 12 months, or at least 6 months, or at least 3 months. In the experiment, minimal corrosion was present on the fully enclosed chains and the enclosed chains at the waterline, whereas the unprotected chain was fully covered with biofouling and corrosion. Corrosion may be caused by the oxygen gradient inside of the enclosure and/or loss of chalk on the chain from the enclosure rubbing on the chain. Moreover, corrosion was observed in areas where the enclosure was damaged and in areas with enclosure material loss.

If desired, a system may be constructed using individual components sections that can be assembled into a three-dimensional (3D) construct. For example, individual walls sections of an enclosure can be provided to be attached to each other in a variety of configurations, including triangular, square and/or other polygonal shapes. If desired, the wall sections could be supported by a relatively rigid underframe, or the sections could be highly flexible and/or provided on a roller or other carrier, which could be unrolled to release each individual section prior to assembly. In at least one alternative embodiment, an open enclosure frame or support could be provided, with an elongated sheet or enclosure wall material provided that could be wrapped around and/or overlain over the frame segments (and applied to the frame in a manner similar to taping or “ship wrapping” of an object for shipment by common carrier, for example).

Fibrous Structure Matrix and Filtration

In various alternative embodiments, the enclosure, system and/or component materials thereof may comprise a three-dimensional structure matrix and/or fibrous matrix structure fashioned from interwoven and/or intertwined strands of thread formed in a lattice-like, mesh, mat or fenestrated structure arrangement, which in various embodiments could incorporate one or more non-flat and/or non-smooth structure layer(s). In one very simplified form, the enclosure could contain a plurality of horizontally positioned elements interwoven with a plurality of vertically positioned elements (as well as various combinations of other fiber elements aligned in various directions), which can include multiple separated and/or interwoven layers. The flexible materials may include one or more spaced apart layers, which may include baffles or various interconnecting sections. Desirably, each yarn or other thread element(s) in the enclosure material will include a preselected number of individual strands, with at least a portion of the strands extending outward from the thread core elements at various locations and/or directions, thereby creating a three-dimensional tortuous network of interwoven threads and thread strands in the structure. In various embodiments, the various elements of the fibrous matrix may be arranged in virtually any orientation, including diagonally, or in a parallel fashion relative to each other, thereby forming right angles, or in virtually any other orientation, including three dimensional orientations and/or randomized distributions (i.e., felt matting) and/or patterns. In addition, while in some embodiments there may be a significant spacing between the individual elements, in other embodiments the spacing can be decreased to a much tighter pattern in order to form a tight pattern with little or no spacing in between. In various preferred embodiments, the elements, such as threads and/or fibers, may be made of natural or synthetic polymers, but could be made of other materials such as metals, nylons, cotton, or combinations thereof.

Various aspects of the present invention can include the use of a fibrous matrix and/or flexible material that is highly ciliated, which means that the material can include tendrils or hair-like appendages (i.e., fibers) projecting from its surface or into the pores or open spaces in the 3-dimensional flexible structure that create a fibrous matrix and/or “filtering” media. The tendrils or hair-like appendages may be a portion of or incorporated into the material that makes up the 3-dimensional flexible material. Alternatively, the tendrils or hair-like appendages may be formed from a separate composition adhered or attached to the flexible material. For example, the tendrils or hair-like appendages may be attached to and project from an adhesive layer, which is itself attached to the surface of the flexible material. In aspects of the invention, the tendrils or hair-like appendages may project from the surface of the fibrous matrix material, while in other aspects the tendrils or hair-like appendages may extend inward from the fibrous materials and/or inwards towards and/or into other threads and/or fibers of the material matrix and/or structure. In various aspects of the invention, the tendrils or hair-like appendages may be resilient and/or may vibrate and/or sway due to enclosure and/or water movement. In various embodiments, the combination of the ciliation itself and/or the movement of the tendrils or hair-like appendages may also discourage the settlement of biofouling organisms on or in the surface of the enclosure.

In various embodiments, the presence of numerous small fibers in the permeable material of a system can provide a substantial increase in the complexity of the 3-dimensional structure of the material, as these structures can extend into and/or around open interstices in the woven pattern. This arrangement of fibers can further provide a more tortuous path for organisms trying to traverse the depth of the structure and enter the internal environment protected by the enclosure, and/or or may provide a much higher surface area of the structure to which the optional biocide coating may adhere. In various embodiments, it has been determined that spun polyester has highly desirable characteristics as an enclosure material, as the shape and/or size of the 3-dimensional “entry paths” into the enclosure (i.e., as the microorganisms pass through the openings and/or pores of the material) will desirably provide a longer pathway, a larger surface area and/or may prove more effective in impeding the flow of fouling organisms into the enclosure and/or retaining larger amounts of biocide coating therein.

In various embodiments, the three-dimensional topography of the enclosure in the system will desirably contribute to the anti-biofouling effects of the system, in that such structure construction can increase a desired “filtration effect” of the walls and/or could negatively affect the ability for various fouling organisms to “latch onto” the structure and/or protected substrate. In other embodiments, however, enclosure walls and/or other components could comprise “flatter” and/or “smoother” materials such as textured yarn or other materials (and/or other material construction techniques) and still provide many of the anti-biofouling effects disclosed herein. While such materials may be significantly flatter, smoother and/or less ciliated than materials incorporating spun polyester yarns, these materials may still provide an acceptable level of biofouling protection for a variety of applications.

In some embodiments, a flexible fibrous matrix may be highly desirable for incorporation into various components of an antifouling enclosures, especially where they matrix can be folded and/or collapsed into differing configurations to accommodate a desired size, shape and/or permeability/density. For example, a relatively large flexible fibrous matrix may be collapsed and/or folded such that the matrix has a higher effective surface area/volume for a liquid to pass through. Such arrangements can include pleating and/or folding the matrix material in a manner similar to pleated air filters, which may increase the effective filtering of the matrix and/or reduce its tendency to clog under certain conditions. Alternatively, the fibrous matrix may be expanded and/or enlarged to fit within a larger volume, if desired.

A variety of materials that may be suitable to varying degrees for constructing the system components described herein, include various natural and synthetic materials, or combinations thereof. For example, burlap, jute, canvas, wool, cellulosics, silk, cotton, hemp, and muslin are non-limiting examples of possible useful natural materials. Useful synthetic materials can include, without limitation, the polymer classes of polyolefins (such as polyethylenes, ultra-high molecular weight polyethylenes, polypropylenes, copolymers, etc.), polyesters, nylons, polyurethanes, rayons, polyamides, polyacrylics, and epoxies. Fiberglass compositions of various types may also be used. Combinations of polymers and copolymers may also be useful. These three-dimensional flexible materials may be formed into textile structures, permeable sheets, or other configurations that provide a structure capable of providing the anti-fouling properties as described herein. Examples of potentially suitable flexible materials for use in constructing the systems described herein include, but are not limited to, burlap, canvas, cotton structures, linen, muslin, permeable polymeric sheets, structures constructed from polymeric fibers or filaments, and permeable films and membranes. In aspects of the invention, the flexible material may be selected from natural or synthetic structures, such as, burlap, knitted polyester or other structures, woven polyester or other structures, spun polyester or other structures, various combinations thereof, or other structures having a variety of characteristics, including those disclosed herein.

In various embodiments, the flexible material forming one or more enclosure may have a structure formed by intertwined fibers or bundles of fibers (i.e., yarns). As used herein, “intertwined” means the fibers may be non-woven, woven, braided, knitted, or otherwise intermingled to produce a fibrous matrix capable of various of the antifouling and/or water permeability and/or water exchange features discussed herein. The matter in which the fibers are intertwined can desirably create a pattern of open and closed spaces in the 3-dimensional flexible material, the open spaces therein defining interstices. Desirably, the fibers that may make up the flexible material are, for example, single filaments, bundles of multiple filaments, filaments of a natural or a synthetic composition, or a combination of natural and synthetic compositions. In aspects of the invention, the fibers have an average diameter (or “average filament diameter”) of: about 50 mils or less, about 25 mils or less, about 10 mils or less, about 6 mils or less, about 5 mils or less, about 4 mils or less, about 3 mils or less, about 2 mils or less, about 1 mil or less, about 0.5 mils or less, about 0.4 mils or less, about 0.3 mils or less, about 0.2 mils or less, or about 0.1 mils or less.

In some aspects of the invention, the flexible material could comprise a woven or knitted structure. For example, the woven structure may have picks per inch (“ppi” or weft yarns per inch) of from about 3 to about 150, from about 5 to about 100, from about 10 to about 50, from about 15 to about 25 from about 20 to about 40 and/or approximately 20 ppi. In other aspects of the invention, the woven structure has ends per inch (“epi” or warp yarns per inch) of from about 3 to about 150, from about 5 to about 100, from about 10 to about 50, from about 15 to about 25, from about 20 to about 40 and/or approximately 20 epi or approximately 24 epi. In still other various other aspects of the invention, a knitted structure may have courses per inch (“cpi”) of from about 3 to about 120, from about 5 to about 100, from about 10 to about 50, from about 15 to about 25, from about 20 to about 40 and/or approximately 36 cpi or approximately 37 cpi. In even other aspects of the invention, the knitted structure has wales per inch (“wpi”) of from about 3 to about 80, from about 5 to about 60, from about 10 to about 50, from about 15 to about 25, from about 20 to about 40 and/or approximately 36 wpi or approximately 33.7 wpi.

Accordingly, in at least one aspect of the invention the woven structure has a yarn size density (i.e., the weft multiplied by the warp yarns per unit area) of from about 9 to about 22,500, from about 100 to about 20,000, from about 500 to about 15,000, from about 1,000 to about 10,000, from about 2,500 to about 8,000, from about 4,000 to about 6,000, from about 2,500 to about 4,000, from about 5,000 to about 15,000, from about 10,000 to about 20,000, from about 8,000 to about 25,000, from about 20 to about 100, form about 30 to about 50, about 45, or about 40 yarns per square inch.

In another aspect of the present invention, the yarns of the woven or knit structure may have a size of from about 40 denier to 70 denier, about 40 denier to 100 denier, about 100 denier to about 3000 denier, about 500 to about 2500 denier, about 1000 to about 2250 denier, about 1100 denier, about 2150 denier, or about 2200 denier.

In still another aspect of the invention, the woven or knit structure may have a base weight per unit area from about 1 to about 24 ounces per square yard (about 34 to about 814 g/m2), from about 1 to about 15 ounces per square yard, from about 2 to about 20 ounces per square yard (about 68 to about 678 g/m2), from about 10 to about 16 ounces per square yard (about 339 to about 542 g/m2), about 12 ounces per square yard (about 407 g/m2), or about 7 ounces per square yard (about 237 g/m2), or about 3 ounces per square yard. In another aspect of the present invention, a desirable spun polyester fiber based woven structure can be utilized as an enclosure material, with the structure having a BASIS WEIGHT (weight of the base structure before any coating or modifications are included) of approximately 410 Grams/Meter² (see Table 5).

In various exemplary embodiments, the thickness of a suitable enclosure and/or structure wall can range from 0.025 inches to 0.0575 inches or greater, with desirable embodiments being approximately 0.0205 inches thick, approximately 0.0319 inches thick, approximately 0.0482 inches thick and/or approximately 0.0571 inches thick. Depending upon the size of perforations and/or openings in the enclosure, as well as the shape, size and/or degree of tortuosity of the various openings in the system, an enclosure wall of greater and/or lesser thicknesses than those specifically described may be utilized in various system designs with varying degrees of success and various materials. In various alternative embodiments, the flexible base materials, fibers and/or threads utilized in construction of the disclosed fibrous matrices may have a wide variation in thickness and/or length depending on the desired substrate to be protected or specific application. For example, in some aspects of the invention the thickness of the flexible material may be from about 0.001 to about 0.5 inch, from about 0.005 to about 0.25 inch, from about 0.01 to about 0.1 inch, about 0.02 inch, about 0.03 inch, about 0.04 inch, about 0.05 inch, or about 0.06 inch. Variations in thickness and in permeability within a single structure are contemplated, such as in membrane structures, as well as multiple layers thereof.

It should be understood that a wide variety of materials and/or material combinations could be utilized as system materials to accomplish various of the objectives described herein. For example, a film or similar material may be utilized as one alternative to a structure wall material, which may include permeable and/or non-permeable films in some or all of the enclosure walls. Similarly, natural and synthetic materials such as rubbers, latex, thin metals, metal films and/or foils and/or plastics or ceramics might be utilized with varying results.

Whichever type of materials are used, the enclosure may optionally be constructed such that the enclosure may be formable to be capable of being expanded and/or contracted three-dimensionally, radially, longitudinally and/or various combinations thereof. This type of construction would desirably allow positioning over and/or around a variety of reservoir and/or water intake embodiments in a variety of configurations, which could include positioning such that the enclosure walls might mirror the contour of the surface of any underlying object for which it is attached thereto, if desired. In some embodiments, the enclosure may be formed in a mirror shape of one or more surface of the reservoir and/or water intake and will generally be of at least slightly larger size to accommodate the substrate therein.

In some exemplary embodiments, a system or enclosure could be constructed of completely natural enclosure materials such as burlap or hemp, and deployed to protect substrates in particularly sensitive waters such as drinking water reservoirs and/or wildlife refuges, where the use of artificial materials and/or biocidal toxins may be prohibited and/or discouraged. In such a case, the enclosure would desirably provide protection to the underlying substrate and/or water intake for a desired period of time without posing a significant potential to pollute the water and/or harm the local aquatic environment, even if the enclosure may become detached from the substrate and/or relevant supporting structure (as the additional opening(s) in the detached structure might now prevent the development of the protected aqueous environment and its attendant advantages). In such a case, once the substrate no longer requires protection, or where the enclosure becomes fouled and/or damaged for a variety of reasons, the system components could be removed and/or replaced with new enclosure and/or other components of similar materials, with fouling protection restored to the substrate as desired.

In various embodiments, “permeability” is desirably utilized as a metric for some aspects of the enclosure and/or other system components, as it may be somewhat difficult to measure and/or determine an “effective” porosity of the openings in the entirety of a spun poly and/or burlap material due to the “fuzziness” and/or randomness in the architecture of this structure, which may be compounded by variations in the flexibility and/or form of the structure in wet and/or dry conditions, which Applicant believes can optionally be important to the effectiveness of various embodiments of the disclosed systems and devices. In various embodiments, the system can comprise one or more walls comprising a flexible material with openings and/or pores formed therethrough. In some desirable embodiments, some or all of the openings through the wall(s) can comprise a tortuous or “crooked” flow path, where the tortuosity ratio is defined as a ratio of the actual length of the flow path (Lt) to the straight line distance between the ends of the flow path:

$$T = \frac{{L}_{t}}{L}$$

In one exemplary embodiment, a woven structure made from Textured Yarn or Spun Polyester Yarn may be highly desirous for use in creating the exemplary antifouling system, with the Spun Polyester Yarn potentially having a significant number of fiber ends that extend from the yarn at various locations (i.e., a relatively higher level of “hairiness” or ciliation) and in multiple directions—desirably leading to a more complicated 3-dimensional macro-structure and/or more tortuous path(s) from the external to internal surfaces of the structure. In various preferred embodiments, these fiber ends can extend into natural openings that may exist in the structure weave, potentially reducing and/or eliminating some “straight path” openings through the structure and/or increasing the tortuosity of existing paths through the structure (which in some instances may extend a considerable distance through the topography of the 3-dimensional structure). In various embodiments, it may be desirable for portions of the structure to incorporate openings having a tortuosity ratio greater than 1.25, while in other embodiments a tortuosity ratio greater than 1.5 for various openings in the structure may be more desirable.

In many embodiments, it is highly desirable to incorporate permeable elements, components and/or structures into some and/or all of the system components, which allow some bulk transport of water through the enclosure in a controlled manner and/or rate. Desirably, the material or materials selected for the enclosure will include one or more walled structures having a level of permeability that allows for fluid flow from the surrounding aqueous environment into the water intake and/or reservoir. This permeability will desirably be optimized and/or suited to the local environment within which the system will be placed, although in general the enclosure may incorporate a moderate to high level of permeability, as materials with very low permeabilities may be somewhat less effective providing sufficient water flow to accommodate required uses. In many cases, the local environmental conditions (i.e., water flow, temperature, bio-floral type, growing season, salinity, available nutrients and/or oxygen, pollutants, etc.) and/or local water conditions/velocity (i.e., due to currents and/or tides) could affect the desired permeability and/or other design considerations—for example, the impingement of higher velocity liquids on an enclosure may create an increased water exchange rate for a given permeability of material, which may require or suggest the use of a lower permeability material in such conditions.

In various embodiments, the system components can desirably inhibit biofouling on a substrate or substrate portion at least partially submerged in an aquatic environment, with the enclosure including a material which is or becomes water permeable during use, said enclosure adapted to receive said substrate and in some embodiments form a differentiated aquatic environment which extends from an interior/exterior surface of the enclosure to an intake or the water system or other protected substrate, wherein the enclosure or portions thereof are water permeable, upon positioning the structure about the substrate or thereafter, of at least 100 ml of water per second per square centimeter of substrate or less. In various embodiments, water permeability of the structure may be achieved by forming the structure to allow water to permeate through, such as by manufacturing a textile to have a desired permeability. In some embodiments, the structure may be designed to become water permeable over time as it is used. For example, an otherwise water permeable structure may include a coating that initially makes it substantially non-permeable, but as the coating ablates, erodes, or dissolves, the underlying permeability increases and/or becomes useful.

In various embodiments, an optimal and/or desired permeability level for an enclosure can approximate any of the structure permeabilities identified in Table 10 (below), and in some embodiments can include permeabilities ranging from 100 ml/s/cm² to 0.01 ml/s/sm². In various alternative embodiments, a structure or other permeable material may be utilized in or on one or more walls of the enclosure, including materials having a permeability range from 0.06 ml/s/cm² to 46.71 ml/s/cm², or from 0.07 ml/s/cm² to 46.22 ml/s/cm², or from 0.08 ml/s/cm² to 43.08 ml/s/cm², or from 0.11 ml/s/cm² to 42.54 ml/s/cm², or from 0.13 ml/s/cm² to 42.04 ml/s/cm², or from 0.18 ml/s/cm² to 40.55 ml/s/cm², or from 0.19 ml/s/cm² to 29.08 ml/s/cm², or from 0.32 ml/s/cm² to 28.16 ml/s/cm², or from 0.48 ml/s/cm² to 25.41 ml/s/cm², or from 0.50 ml/s/cm² to 22.30 ml/s/cm², or from 0.77 ml/s/cm² to 21.97 ml/s/cm², or from 0.79 ml/s/cm² to 20.46 ml/s/cm², or from 0.83 ml/s/cm² to 15.79 ml/s/cm², or from 0.90 ml/s/cm² to 14.72 ml/s/cm², or from 1.05 ml/s/cm² to 14.19 ml/s/cm², or from 1.08 ml/s/cm² to 14.04 ml/s/cm², or from 1.11 ml/s/cm² to 13.91 ml/s/cm², or from 1.65 ml/s/cm² to 11.27 ml/s/cm², or from 2.09 ml/s/cm² to 11.10 ml/s/cm², or from 2.25 ml/s/cm² to 10.17 ml/s/cm², or from 2.29 ml/s/cm² to 9.43 ml/s/cm², or from 2.36 ml/s/cm² to 9.20 ml/s/cm², or from 2.43 ml/s/cm² to 9.02 ml/s/cm², or from 2.47 ml/s/cm² to 8.24 ml/s/cm², or from 2.57 ml/s/cm² to 8.16 ml/s/cm², or from 2.77 ml/s/cm² to 8.11 ml/s/cm², or from 3.68 ml/s/cm² to 6.04 ml/s/cm², or from 3.84 ml/s/cm² to 5.99 ml/s/cm², or from 4.43 ml/s/cm² to 5.40 ml/s/cm², and/or from 4.70 ml/s/cm² to 4.77 ml/s/cm².

TABLE 10
Exemplary Wall Structure
Permeabilities

| | | Average |
|---|---|---|
| | | Permeability |
| Structure | Coating | (ml/s/cm2) |
| 1/64 Poly | Un | 43.08 |
| | SW | 42.04 |
| | HC | 28.16 |
| 23 × 17 | Un | 8.11 |
| | SW | 0.83 |
| | HC | 1.65 |
| 23 × 23 | Un | 0.79 |
| | SW | 0.18 |
| | HC | 0.08 |
| 61588 | Un | 20.46 |
| | SW | 2.29 |
| | HC | 0.50 |
| 61598 | Un | 25.41 |
| | SW | 0.19 |
| | HC | 2.57 |
| 900d | Un | 14.04 |
| | SW | 0.07 |
| | HC | 8.24 |
| 6/1 Poly | Un | 40.55 |
| | SW | 29.08 |
| | HC | 22.30 |
| A21 | Un | 46.71 |
| | SW | 46.22 |
| | HC | 42.54 |
| Text | Un | 11.10 |
| | 40 MB | 14.19 |
| | 50 MB | 13.91 |
| Spun Poly | Un | 10.17 |
| | SW | 0.32 |
| | HC | 1.08 |
| | MB(out) | 2.47 |
| | MB(in) | 2.09 |
| | 154-30-v | 9.20 |
| | 154-30-nv | 0.90 |
| | 154-40-v | 11.27 |
| | 154-40-nv | 0.77 |
| | 153-30-v | 9.02 |
| | 153-30-nv | 2.36 |
| | 153-40-v | 9.43 |
| | 153-40-nv | 1.11 |
| 60 × 60 Bur | Un | 21.97 |
| | SW | 14.72 |
| | HC | 4.43 |
| 60 × 70 Bur | Un | 15.79 |
| | SW | 5.99 |
| | HC | 3.68 |
| 80 × 80 Bur | Un | 8.16 |
| | SW | 2.77 |
| | HC | 0.48 |
| | SW(HVY) | 2.25 |
| | HC(HVY) | 0.06 |
| | MR(HVY) | 0.11 |
| | MB(HVY) | 0.13 |
| Poly | 152 | 2.43 |
| | 9696-7W | 5.40 |
| | 9696-7C | 4.77 |
| | 9696-7M | 4.70 |
| | 154-40/25 | 1.05 |
| | 10311803 | 3.84 |
| | 03061907 | 6.04 |

The water permeability of a material can be a function of numerous factors, including the composition of the material, the method and type of construction of the material, whether the material is coated or uncoated, whether the material is dry, wet, or saturated, whether the material is itself fouled in some manner and/or whether the structure has been “pre-wetted” prior to testing and/or use in the aqueous environment. Moreover, because permeability of a given material may alter over time, even for a single material there may be a range of acceptable and/or optimal water permeabilities. In various aspects of the present invention, the water permeability of a given enclosure may be an initial minimum permeability sufficient to desirably avoid the creation of a constant anoxia condition in the local (i.e. protected) aquatic environment, while in other embodiments the permeability may be greater. In various aspects of the invention, the material may have a water permeability (milliliters of water per second per square centimeter of substrate) as measured by the above test method, either prior to use or achieved during use of: about 100 or less, about 90 or less, about 80 or less, about 70 or less, about 60 or less, about 50 or less, about 40 or less, about 30 or less, about 25 or less, about 20 or less, about 10 or less, about 5 or less, about 4 of or less, about 3 or less, about 2 or less, about 1 or less, about 0.5 or less, about 0.1 or less, about 1 or greater, about 0.5 or greater, about 0.1 or greater, from about 0.1 to about 100, from about 0.1 to about 90, from about 0.1 to about 80, from about 0.1 to about 70, from about 0.1 to about 60, from about 0.1 to about 50, from about 0.1 to about 40, from about 0.1 to about 30, from about 0.1 to about 25, from about 0.1 to about 20, from about 0.1 to about 10, from about 0.1 to about 5, from about 0.5 to about 100, from about 0.5 to about 90, from about 0.5 to about 80, from about 0.5 to about 70, from about 0.5 to about 60, from about 0.5 to about 50, from about 0.5 to about 40, from about 0.5 to about 30, from about 0.5 to about 25, from about 0.5 to about 20, from about 0.5 to about 10, from about 0.5 to about 5, from about 1 to about 100, from about 1 to about 90, from about 1 to about 80, from about 1 to about 70, from about 1 to about 60, from about 1 to about 50, from about 1 to about 40, from about 1 to about 30, from about 1 to about 25, from about 1 to about 20, from about 1 to about 10, or from about 1 to about 5.

Experimental Results—Test 1

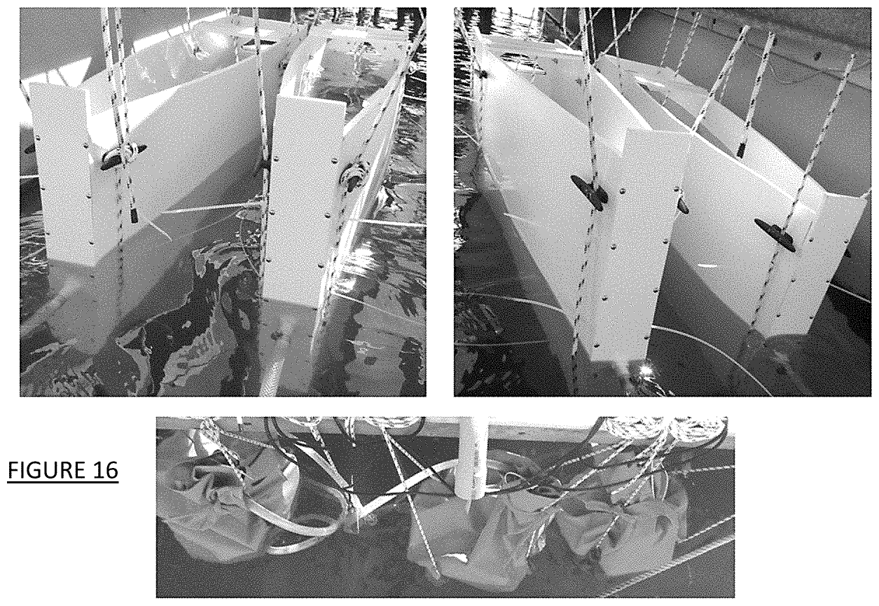

In an exemplary set of experiments made during winter months in a southern climate (i.e., Melbourne, Fla., USA), four raceways were constructed to channel various amounts of filtered, preconditioned and/or dosed environmental water. These raceways were attached to pumps by flexible tubing. Each raceway contained a PVC “Christmas tree” settlement substrate, which was chosen because this configuration is very attractive to settling larvae. Three pumps were placed in bags constructed from flexible structure material incorporating biocidal coatings as described here, and a fourth pump was left open to fouling (which desirable acted as a control). One pump was allowed to flow full force (at 748 gal/hr), one pump was set to approximately ½ flow (approximately 367 gal/hr), and the third pump was set to approximately ¼ flow (approximately 160 gal/hr). The control pump was set to approximately Mz flow (around 373 gal/hr). The four raceways were set in the water and pumping started during early October. The depth for each raceway was set to have approximately 6″ of water in the raceways above the port water level, with a one-way outlet at the rear of each raceway. FIG. 16 depicts various views of the experimental set-up.

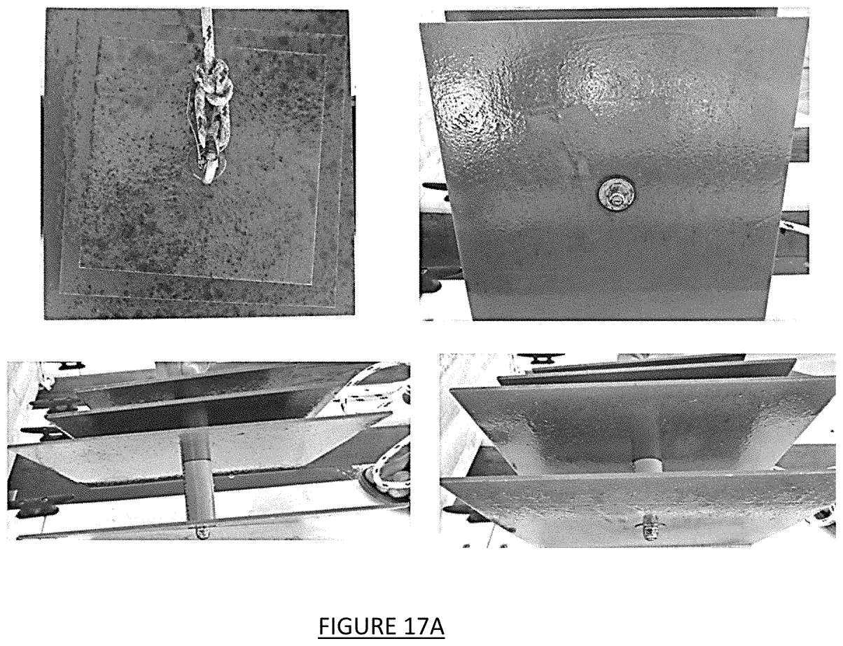

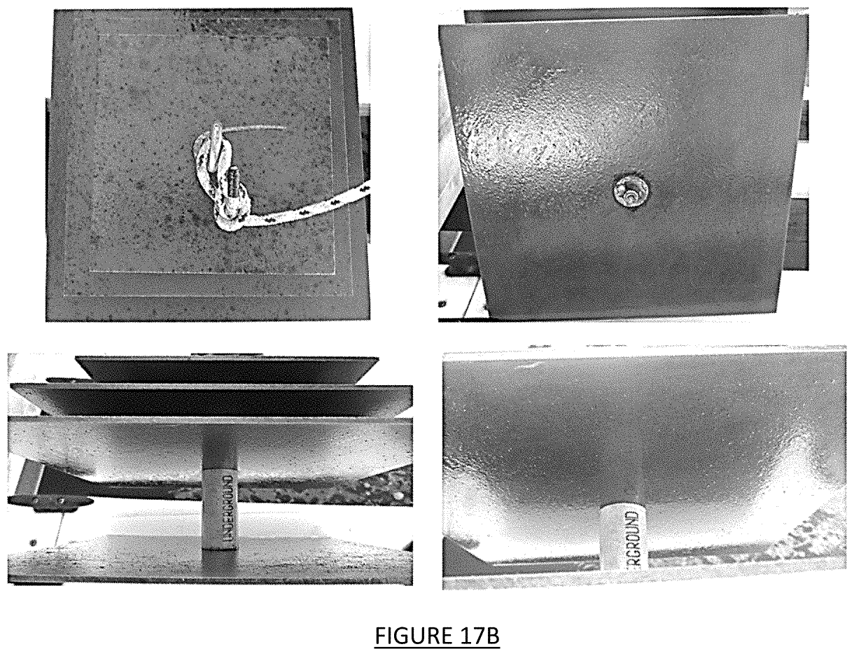

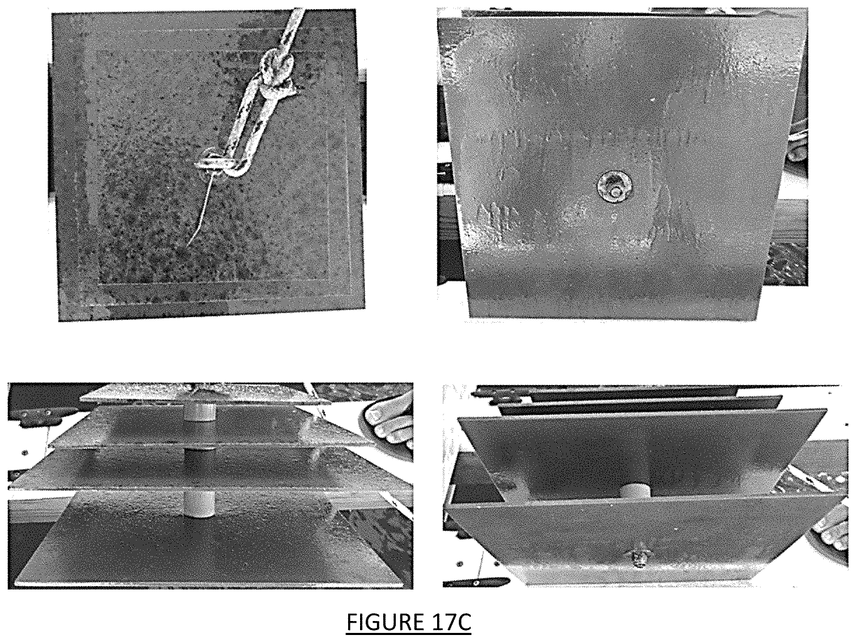

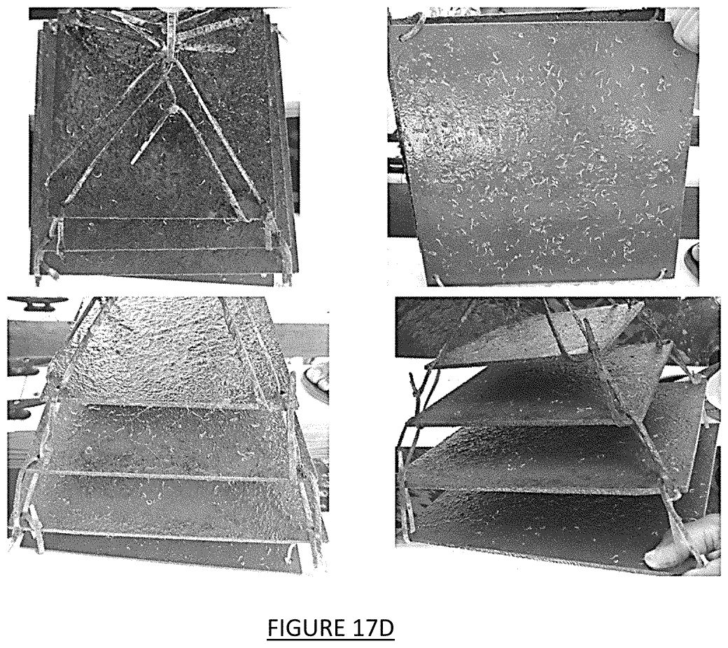

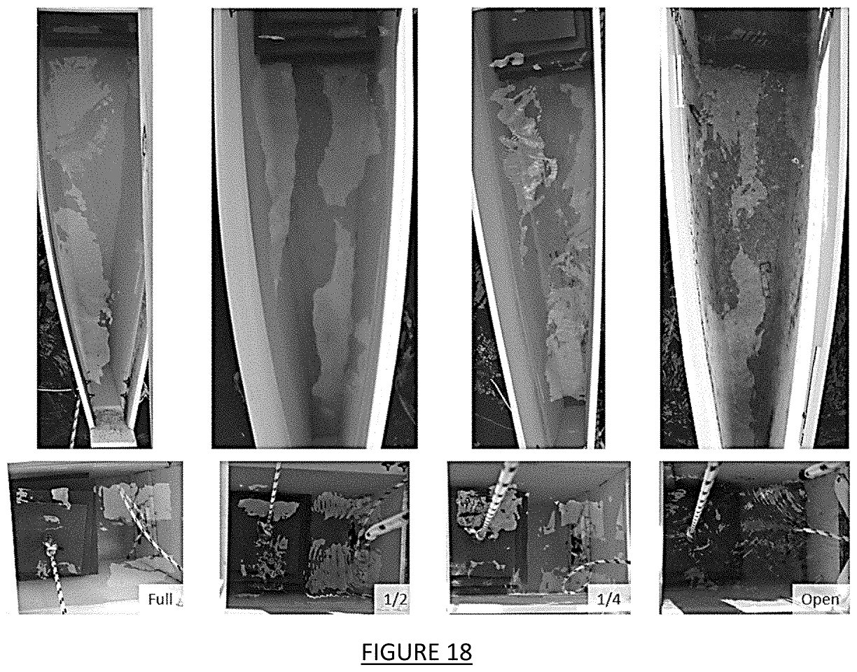

After seven (7) days of immersion, raceway fouling was different between the bagged and unbagged pumps (See FIG. 18). The open pump (FIG. 17D) had more and thicker biofilm after 7 days. After 10 days, there was visible macrofouling in the open pump raceway which consisted of hydroids and spat (likely barnacles and tube worms). The raceways with bagged pumps only had light biofilms and sediment at the inlet, with no obvious differences by pumping rate. Fouling on the Christmas trees substrates in the bagged raceways (Full force —FIG. 17A, ½ force—FIG. 17B and ¼ force—FIG. 17C) consisted of only light, fluffy, silty biofilms, while fouling on Christmas tree substrate in the open pump raceway consisted of heavier biofilms, hydroids, tube worms, tunicates and spat (probably small barnacles). The water quality was similar in all raceways and was similar to conditions in the Port outside of raceways. The greatest difference was between the Full-strength pump and the static open water but appeared to be less than 4% difference in water quality for measured characteristics. The open pump also appeared to have accumulated light macrofouling in 10 days, while the bagged pumps only had visible biofilms. The biofilms were lighter and covered less in the raceways and on the Christmas trees where pumps were protected by the enclosure bags.

Experimental Results—Test 2

In another exemplary set of experiments, four additional raceways were constructed to channel various amounts of treated and/or protected environmental water flowing through three of the raceways, with untreated water flowing through a fourth raceway (the “control”). The raceways were attached to pumps by flexible tubing. Each raceway contained a PVC “Christmas tree” settlement substrate, chosen because this configuration is very attractive to settling larvae. Three raceways (control, and 2 pumping speeds) contained 40 gallons of water, the fourth contained 190 gallons of water.

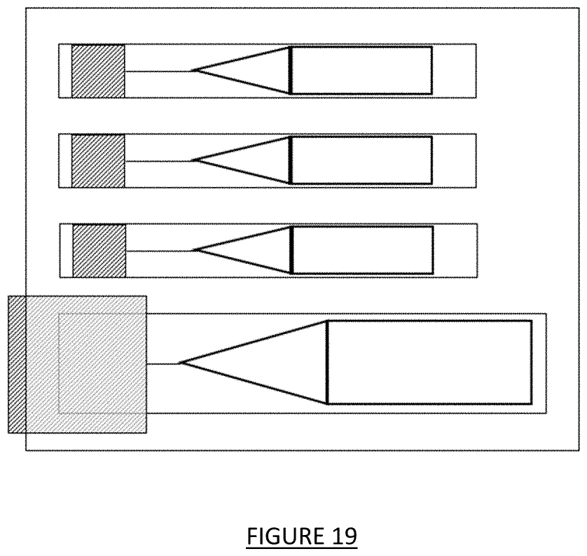

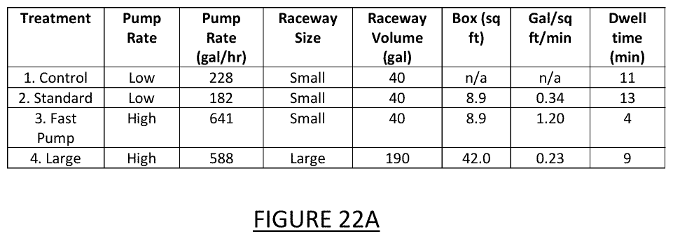

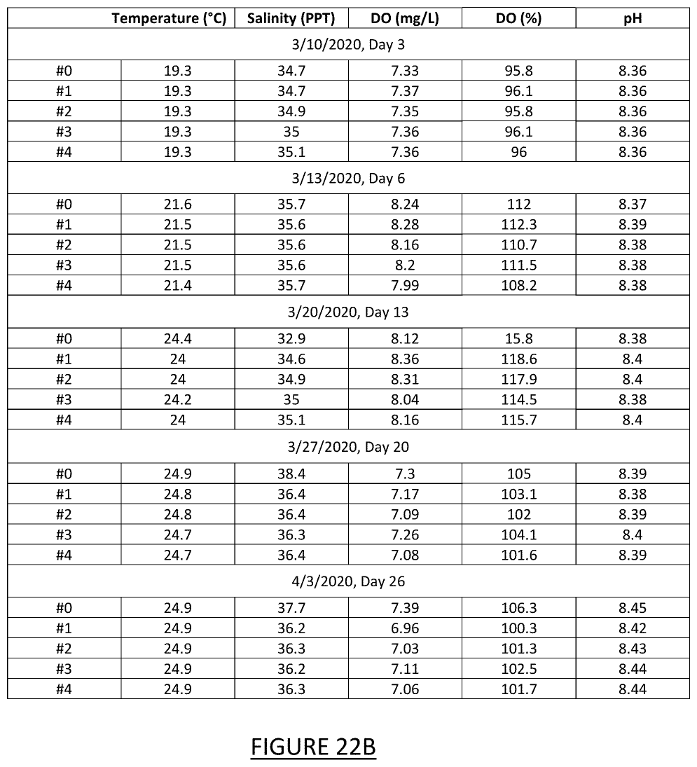

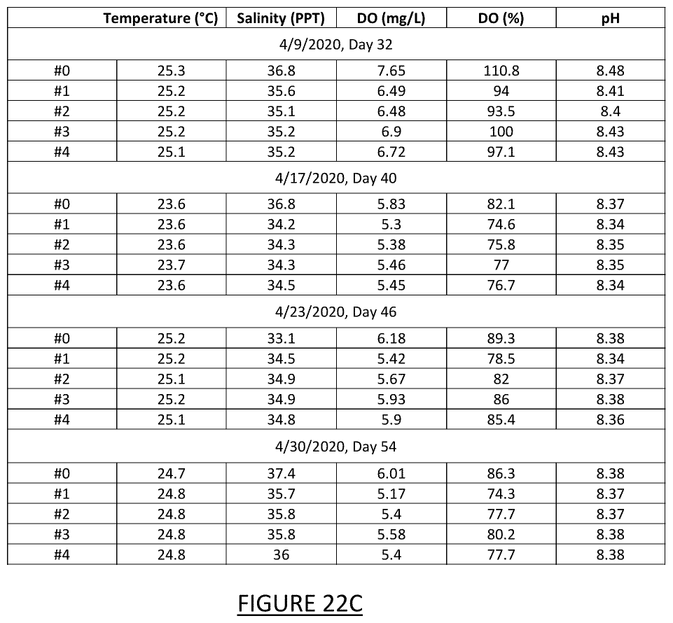

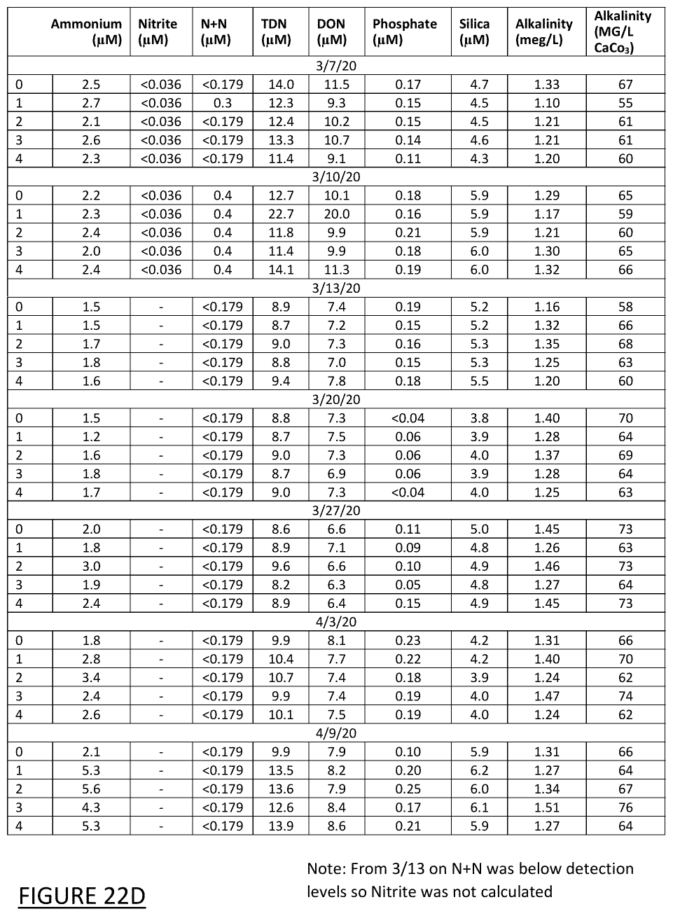

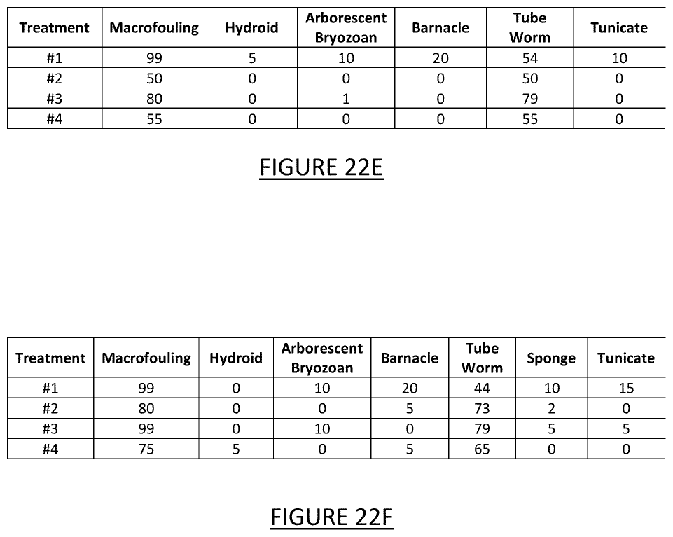

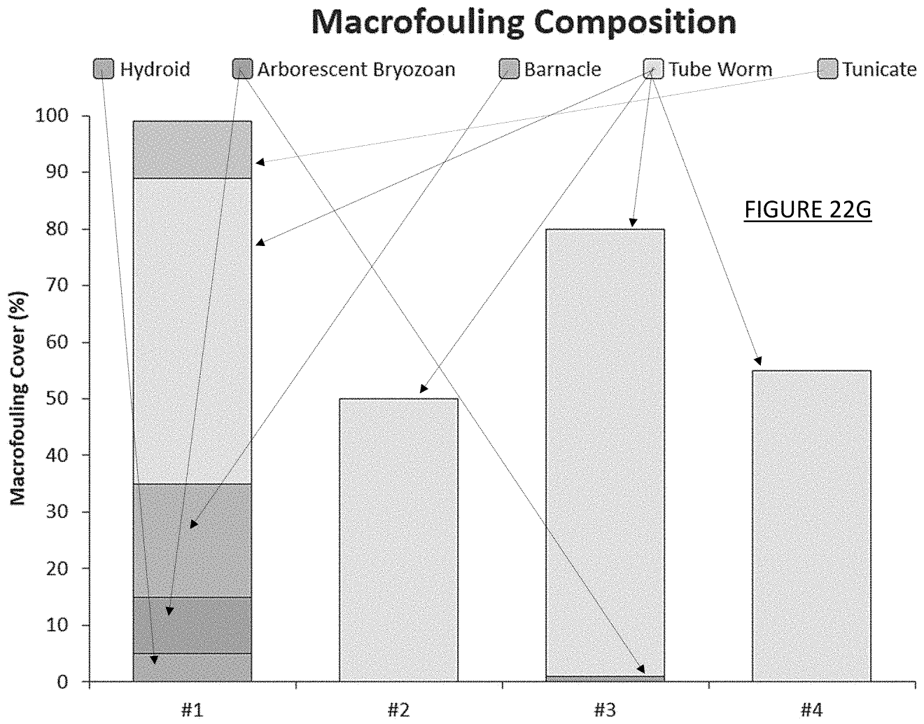

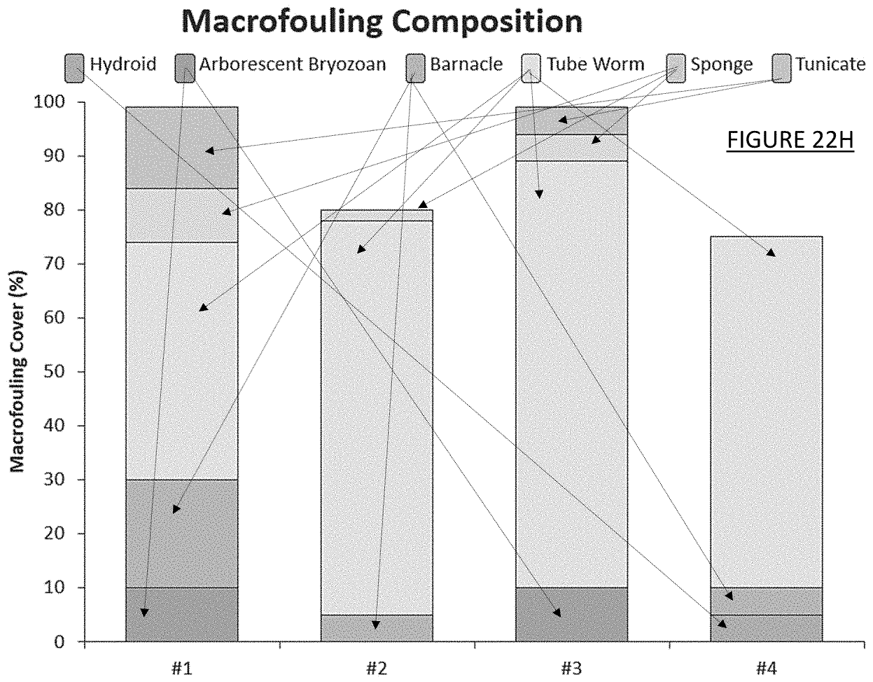

In this experiment, in front of 3 of the 4 raceways (two regular-sized, and one large), were boxes with coated structure on all sides. These boxes were completely submerged in the water. A pump was installed using flex tubing downstream of the boxes, so that water was pulled through the boxes and then pushed into the raceways (see FIG. 19). The control and standard pump are the same size and pull approximately 200 gal/hr. The fast and large raceways have a larger pump and pull approximately 600 gal/hr (See FIG. 22A). The raceways were set in the water and pumping started in early March.

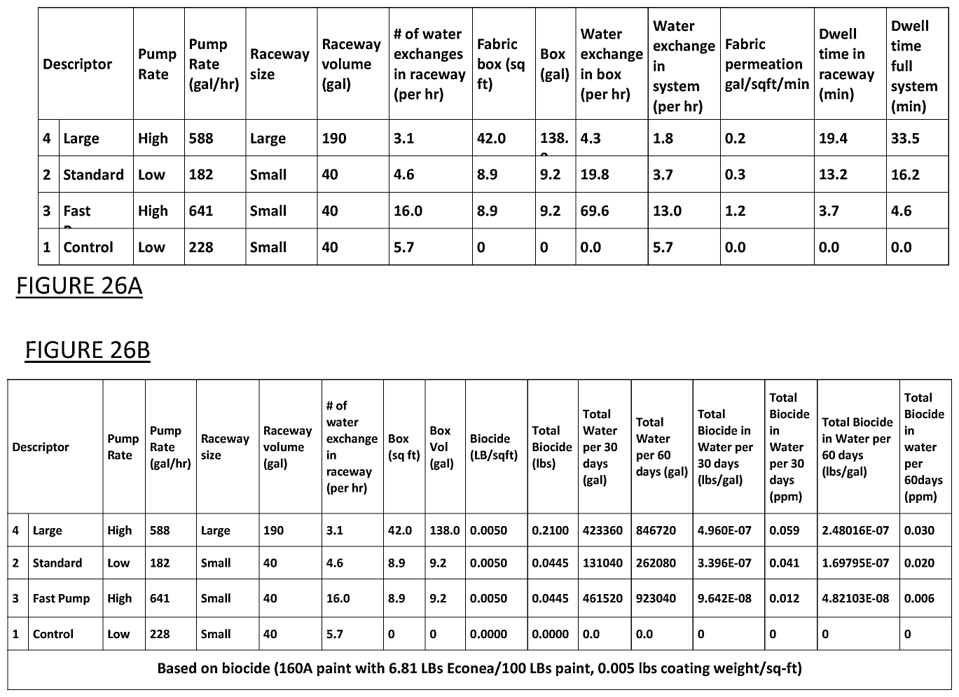

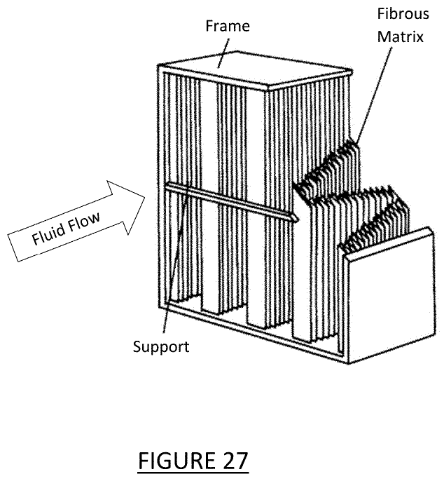

FIGS. 26A and 26B provide additional description regarding the various raceways of the test setup. For these experiments, the actual pump rates for the various experimental test sets were determined, as well as volumes of the respective raceways and surface area and volumes of the permeable structure boxes forming the water intakes. The number of complete water exchanges per hour in each intake box were calculated, along with the number of water exchanges in the raceways per hour for each test setup. In addition, FIG. 26A depicts amounts of water being drawn through each square foot of the fibrous structure media of each enclosure box, as well as water exchanges within the enclosures, within each box and within the full length of each test setup. Exemplary dwell times are also shown for the raceways and a full average dwell time for water in each antifouling system. FIG. 26B includes additional disclosure of the amount of biocide that can be released over a 30 day period of water immersion and waterflow in each exemplary enclosure (assuming full release of biocide over the 30 day period), with an overall total amount of biocide released per gallon of water.

In at least one alternative embodiment, a similar amount of biocide could be suspended in an “extended release” coating resin which releases the biocide over a 60 day period (or other desirable period), which could provide approximately 2 the final concentration of biocide for double the total waterflow over a 60 day period of time (i.e., 846,720 gallons and/or 262,080 gallons for comparable 60 day antifouling system examples 4 and 2 of FIG. 26B).

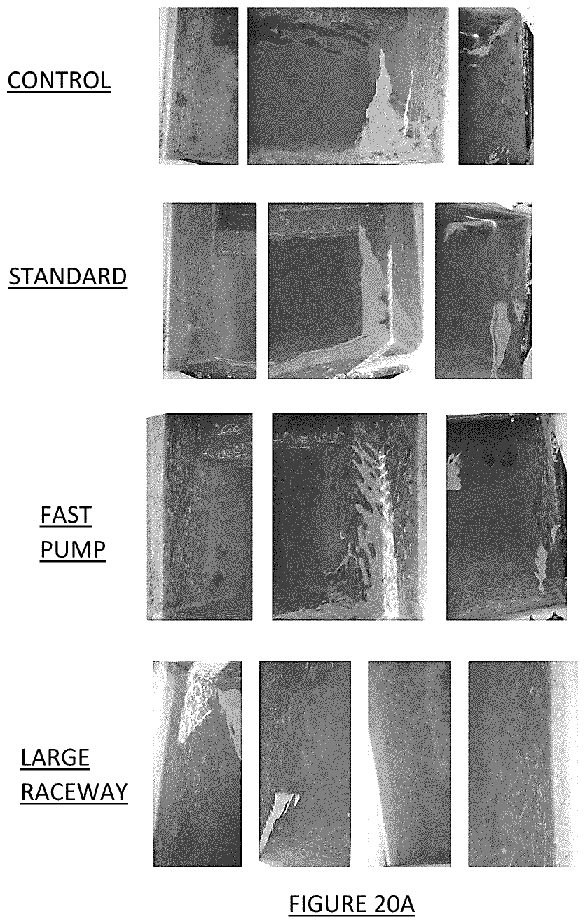

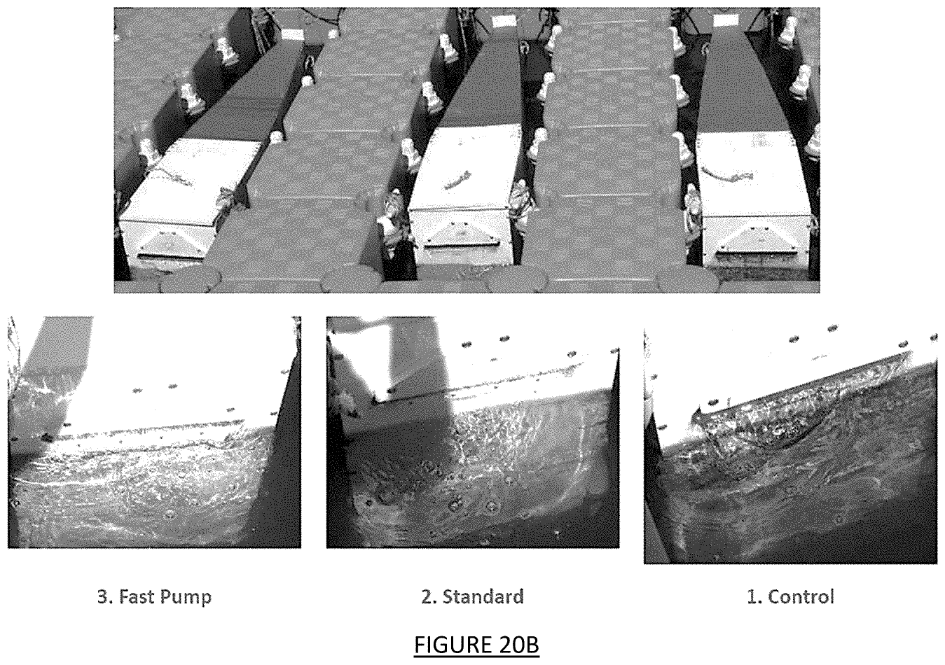

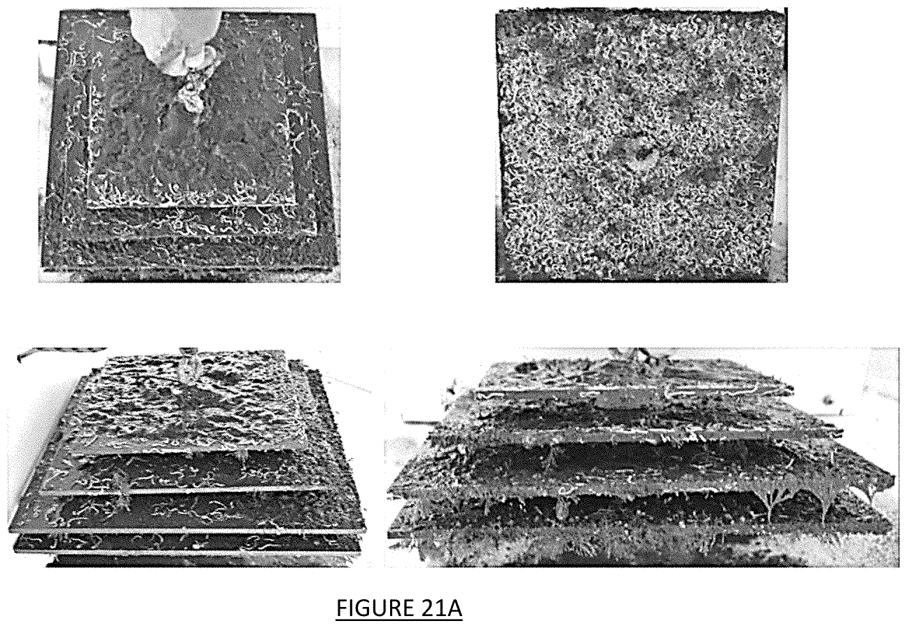

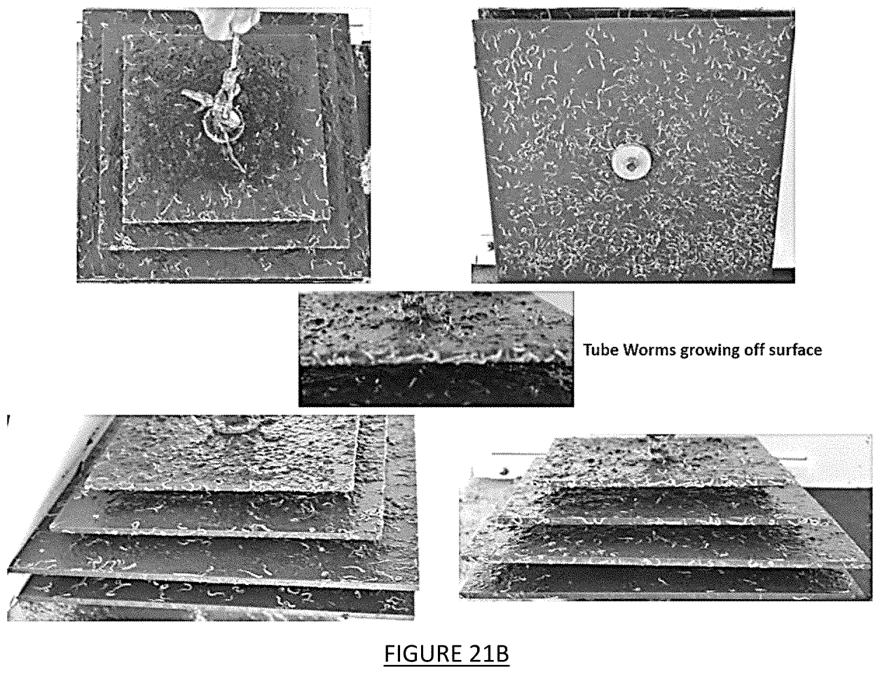

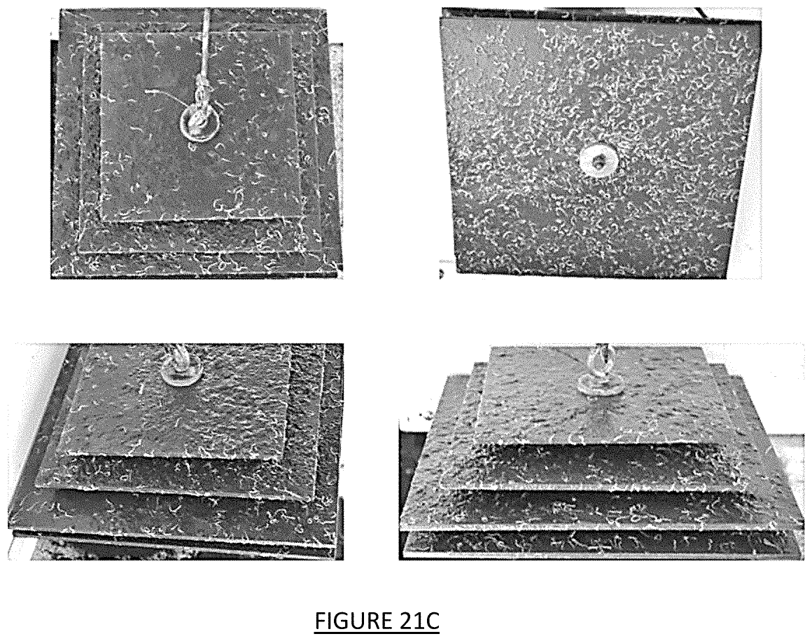

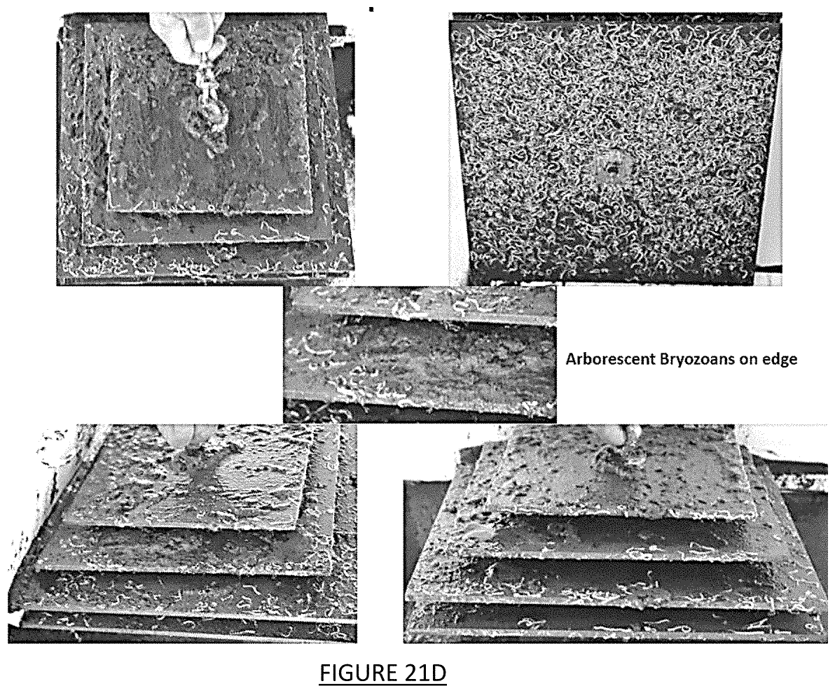

After 30 days of immersion, the protected raceways had visible light fouling consisting on tubeworms on the Christmas tree substrates, while the control had significantly more fouling that became visible after a couple of days of immersion (see FIGS. 22E and 22G). As best seen in FIGS. 20A, 21A and summarized in FIGS. 22E and 22G, fouling in the control raceway was heavier and consisted of arborescent bryozoans, barnacles and tube worms on the raceway and Christmas trees and hydroids and tunicates on the Christmas tree. Fouling in the protected (i.e., treated water) standard (FIGS. 20 and 21B) and protected large raceways (FIGS. 20A and 21C) was similar and consisted of a half the amount of coverage on the substrates exposed to unprotected or nontreated water. This reduction in biofouling coverage consisted of tube worms. Fouling in the fast pump raceway (FIGS. 20A and 21D—also containing treated water) was heavier and consisted primarily of tube worms, with one arborescent bryozoan on the edge of the panels in the Christmas tree array. Thick sediment had accumulated on the top plate in all raceways. In some instances, this led to the tube worms growing vertically off the surface to get their heads above the silt.

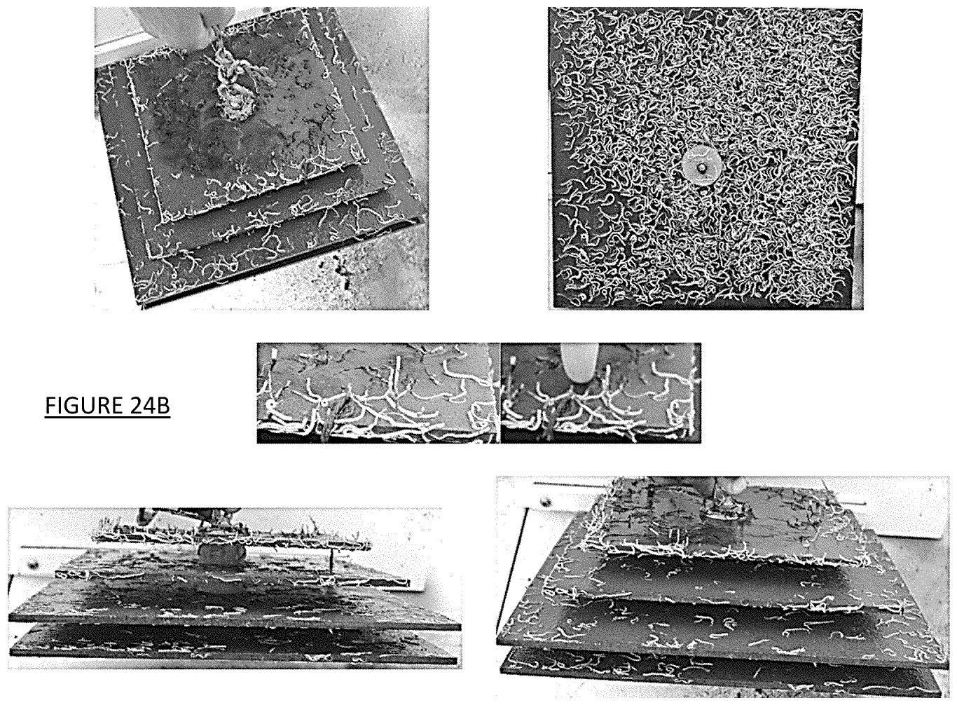

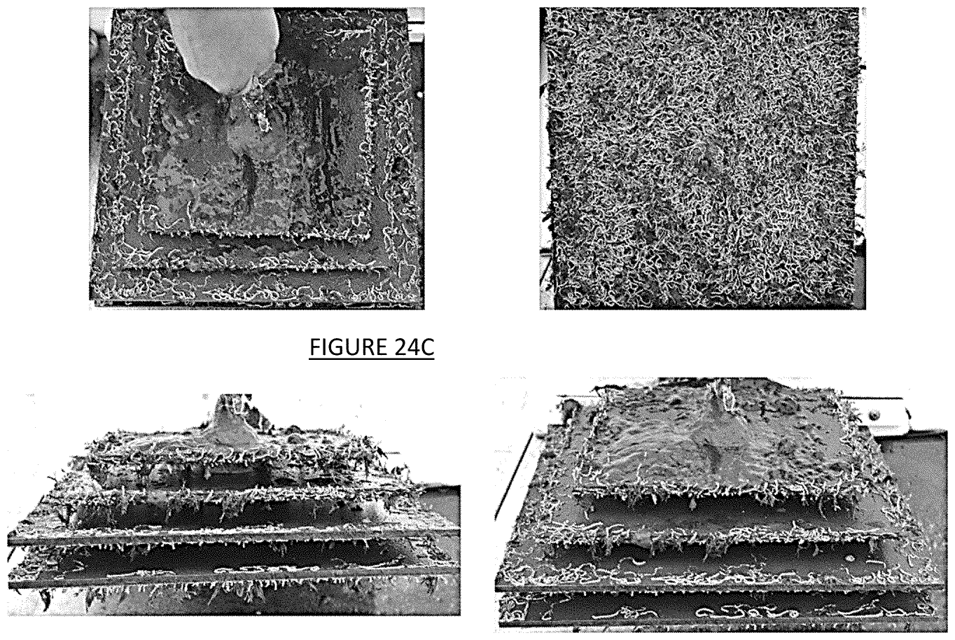

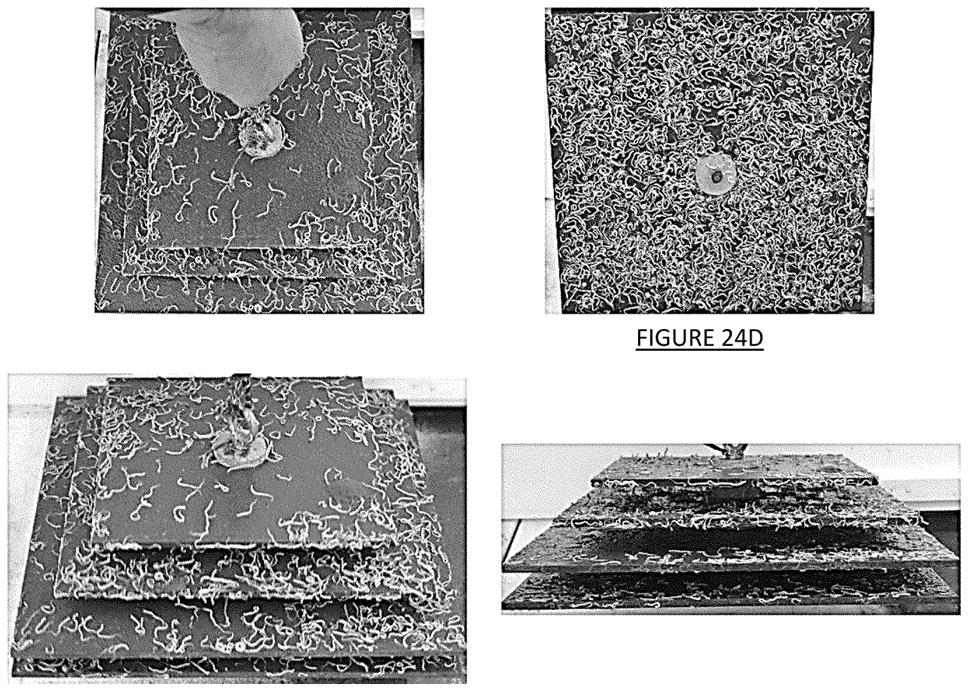

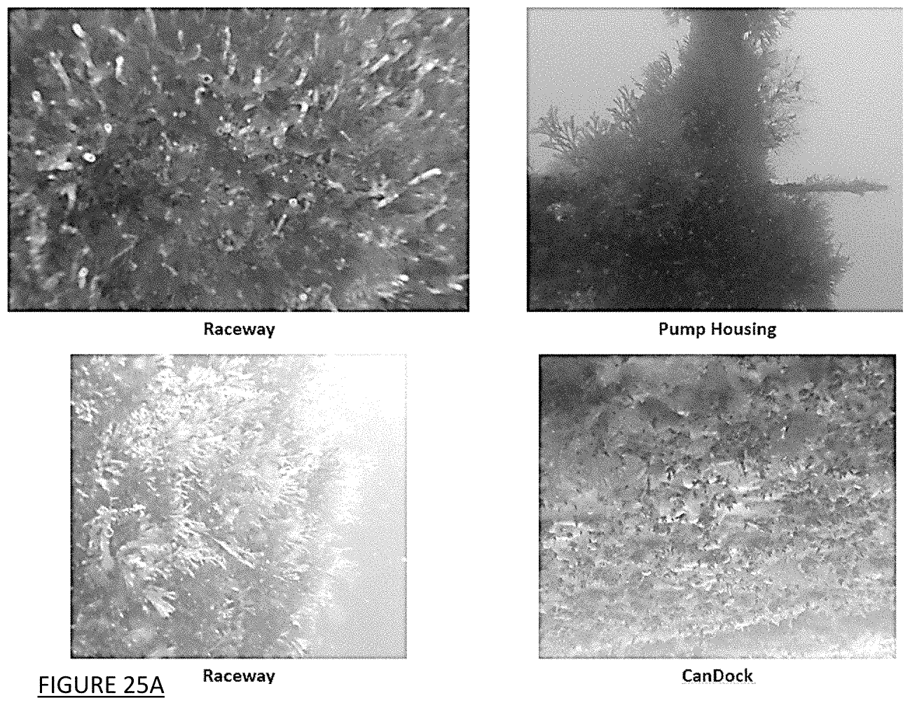

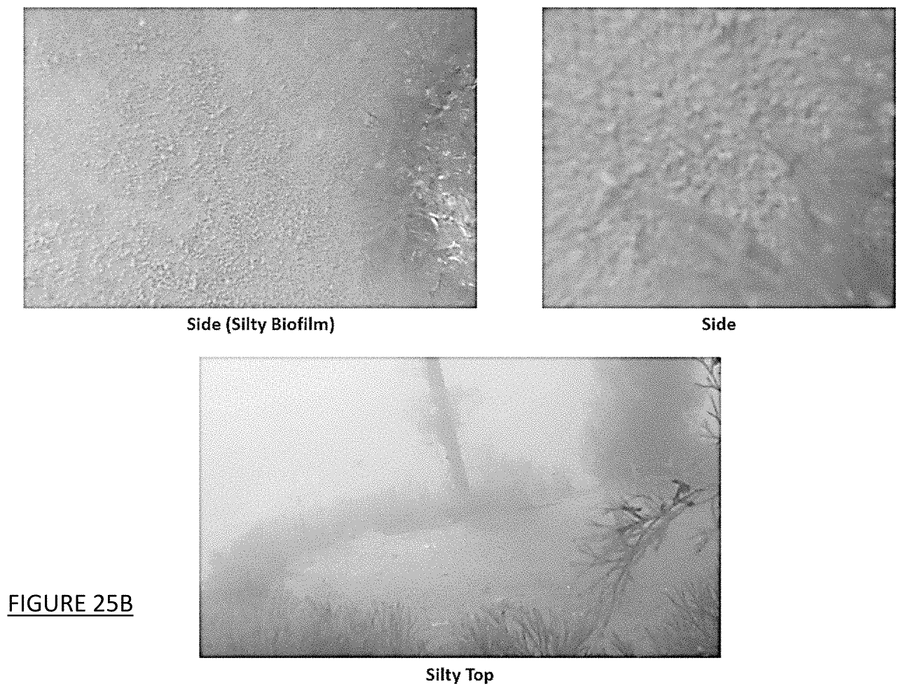

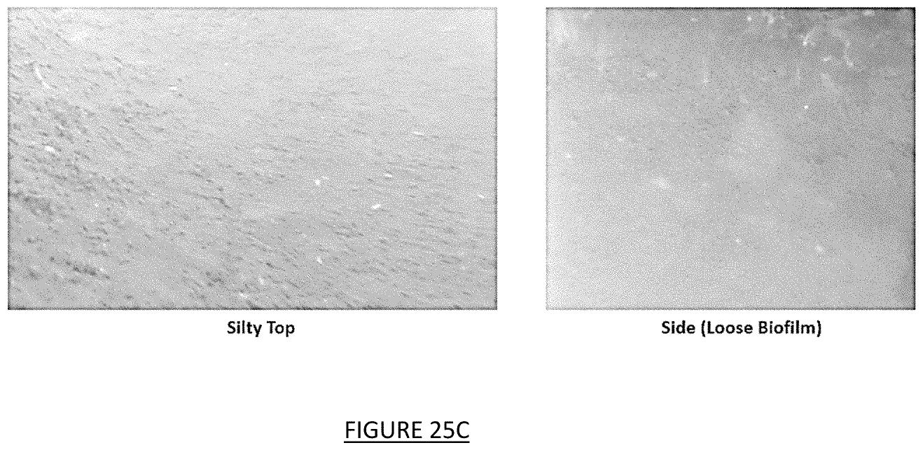

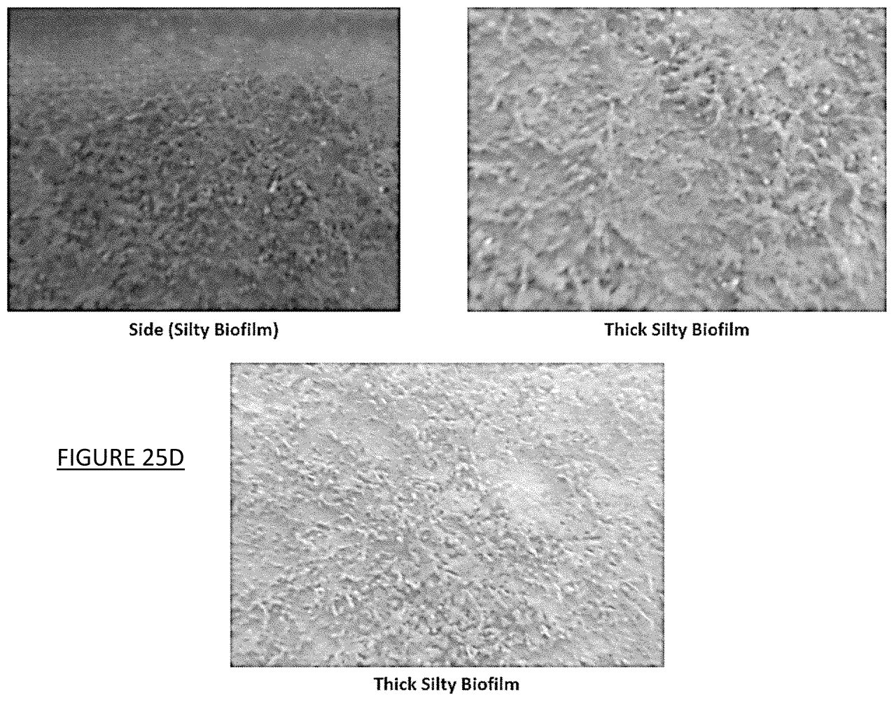

After 2 months of immersion, visual assessment showed a different biofouling community composition (see FIGS. 22F and 22H) and less biofouling accumulation on metal substrates within treated waters (i.e., standard pump FIG. 24B, fast pump FIG. 24C and large raceway FIG. 24D) compared to metal substrates within the nontreated waters (control FIG. 24A). Underwater assessments of the treatment bags after 2 months show different biofilm structure and thickness, no micro or macro biofouling (i.e., standard pump FIG. 25B, fast pump FIG. 25C and large raceway FIG. 25D) compared to microfouling, macrofouling and biofilms grown on an unprotected control pump (control FIG. 25A). Tube worms are the most prominent organism on the metal substrates within the treated waters. The enclosures may contain a biocide or component to reduce tube worm health or reproduction. The substrates may be preconditioned or conditioned with a hydrogel system containing biocide or other composition to prevent tube worm settlement. The treated water may be conditioned to reduce the dissolved oxygen, water chemistry, pH and/or temperature to a “toxic” level for tube worm survival and reproductivity.

In addition to the difference of biofouling on the substrates (unprotected or protected), visual differences between the protected and unprotected back wall of the raceways were noted. The control raceway wall which contained the spillway at the back of the raceway showed an extensive about of fouling after 30 days, whereas the raceways with treated water flow did not have a visible fouling accumulation on the spillway (See FIG. 20B). Water quality seemed to vary among treatments (See FIGS. 22B through 22D). Temperature was similar for all treatments at all sampling times. Salinity in the pumped treatments was very stable, while that in the static open water was more variable. Dissolved oxygen was similar among the treatments until week 4, when it began to decrease from the static open in all raceways, possibly due to fouling in the pumps causing water to slow and/or to a lack of photosynthesis in the covered raceways. Levels of dissolved oxygen (DO) after 2 months in treated waters were lower when compared to open/non-treated waters. It is believed that DO differences take longer to develop in high velocity waters compared to static waters, with various DO differences depend on dwell time (in some embodiments, preferably a longer dwell time), velocity of water and/or volume of water.

As best seen in FIG. 22D, water chemistry differences were determined after 1 month for treated waters compared to open/non-treated waters. Ammonium, total dissolved nitrogen, phosphates were higher in the treated waters compared to the non-treated water. It is believed that the nitrates, ammonium and phosphates may be nutrients for biofouling organisms, with too high a concentration of one or more being “toxic” or otherwise undesirable to the organisms and creating a negative effect on the organisms. Similarly, increased ammonium levels may be more “toxic” to organisms in waters with increased pH. The testing results showed more “toxic” ammonium levels in treated waters as compared to the open water. Test results also potentially showed that increased phosphates may cause organisms to have excess stimulation. Many of these water chemistry differences may depend on dwell time (i.e., preferably a longer dwell time in some embodiments), volume of water and/or velocity of water past a substrate.

Experimental Results—Test 3

In another exemplary set of experiments, preconditioning of water using multilayers of enclosures was examined, including one layer of enclosure, two layers of enclosures and three layers of enclosures. This setup represented an enclosure bag within ab enclosure bag. With this experimental setup, any number of layers of enclosures may be utilized.

In this experiment, four raceways were constructed to channel various amounts of treated and/or protected environmental water flowing through three of the raceways, with untreated water flowing through a fourth raceway (the “control”). The water for the control raceway was not pretreated with an enclosure. Test setup 2 water was pretreated before flowing through the raceway with one enclosure. Water in test setup 3 was pretreated with two layers of enclosures and water in test setup 4 was pretreated with three layers of enclosures before the water was pumped into the raceway. The raceways were attached to pumps (setup 1 with no enclosure and setup 2-4 with enclosures protecting the pumps) by flexible tubing. Each raceway contained a PVC “Christmas tree” settlement substrate, chosen because this configuration is very attractive to settling larvae. All four raceways contained 50 gallons of water with about 240 gal/hour pump speed and initial dwell time of the water in the raceway was 12.3-12.6 min.

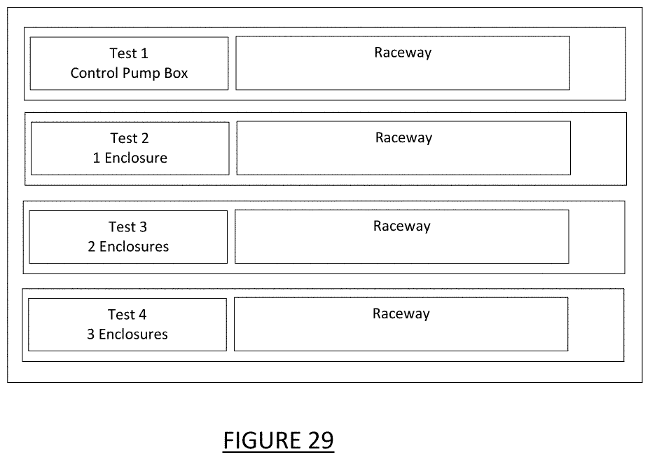

In this experiment, in front of 3 of the 4 raceways, were enclosure boxes with coated fabric enclosure structure on all sides. These boxes were completely submerged in the water. A pump was installed using flex tubing inside of each box, so that water was pulled through the boxes and then pushed into the raceways (see FIG. 29). The raceways were set in the water and pumping started in early October.

Below, Table 11 provides additional description regarding the various raceways of the test setup.

TABLE 11
Experimental pumping calculations for design setup with 1 enclosure, 2 enclosures and 3 enclosures.

| | Pump Rate | Raceway | | | gal/sq- | Raceway Dwell | Filter Box Dwell |
|---|---|---|---|---|---|---|---|
| Treatment | (gal/hr) | Volume (gal) | Box (sq ft) | | ft/min | Time (min) | Time (min) |
| 2. 1 Enclosure | 234 | 50 | 12.1 | | 0.32 | 12.8 | 7 |
| 3. 2 Enclosure | 213 | 50 | 12.1 | (large) | 0.29 | 14.1 | 2.8 |
| | | | 9.2 | (med) | 0.39 | | 4.9 |
| | | | 21.3 | (total fabric) | 0.17 (total) | | |
| 4. 3 Enclosure | 207 | 50 | 12.1 | (large) | 0.29 | 14.5 | 2.9 |
| | | | 9.2 | (med) | 0.38 | | 2.1 |
| | | | 6.6 | (small) | 0.52 | | 2.9 |
| | | | 29.7 | (total fabric) | 0.12 (total) | | |

For these experiments, the actual pump rates for the various experimental test sets were determined, as well as volumes of the respective raceways and surface area and volumes of the permeable structure boxes forming the water intakes. The number of complete water exchanges per hour in each intake box were calculated, along with the number of water exchanges in the raceways per hour for each test setup. In addition, Table 7 depicts amounts of water being drawn through each square foot of the fibrous structure media of each enclosure box, as well as water exchanges within the enclosures, within each box and within the full length of each test setup. Exemplary dwell times are also shown for the raceways and a full average dwell time for water in each antifouling system. Table 7 includes additional disclosure of the amount of biocide that can be released over a 30 day period of water immersion and waterflow in each exemplary enclosure (assuming full release of biocide over the 30 day period), with an overall total amount of biocide released per gallon of water.

After 3 weeks of immersion, the protected raceways had visible light fouling consisting on tubeworms on the Christmas tree substrates, while the control had significantly more fouling, tube worms and hydroids, that became visible after a couple of days of immersion. Unprotected raceways (no enclosure) began to show signs of fouling after 1 week. Raceways with water preconditioned with one enclosure began to show signs of fouling after 2 weeks. Raceways with water pretreated with multilayers of enclosures (two and three layers of enclosures) began to show signs of fouling after 2.5 weeks. After 3 weeks, unprotected raceways and raceways with water preconditioned with one, two and three enclosures all contained tube worms on the substrate and raceway. Unprotected raceways contain hydroids on the substrate and raceway. Fouling in the control raceway was heavier and consisted of arborescent bryozoans, barnacles and tube worms on the raceway and Christmas trees and hydroids and tunicates on the Christmas tree. Fouling in the protected (i.e., treated water) was similar and consisted of more than half the amount of coverage on the substrates exposed to unprotected or nontreated water. This reduction in biofouling coverage consisted of tube worms. All treatments (unprotected, one enclosure, two enclosures, three enclosures) had similar water quality, water chemistry and flow characteristics after two weeks. All treatments (unprotected, one enclosure, two enclosures, three enclosures) contain plankton, including copepods and other holoplankton, within the water after one week.

In addition to the difference of biofouling on the substrates (unprotected or protected), visual differences between the protected and unprotected back wall of the raceways were noted. The control raceway wall which contained the spillway at the back of the raceway showed an extensive about of fouling after 3 weeks, whereas the raceways with treated water flow did not have a visible fouling accumulation on the spillway (Similar to FIG. 20B).

Desirable Biofilm Formation

Where a system is being utilized to protect a water system, such as disclosed herein, the biological colonizing sequence on the water system components may significantly vary from the normally expected open water sequence. For example, where system such as described herein is utilized, the biological colonizing sequence on the substrate may be interrupted (disrupted, altered, etc.) to reduce and/or minimize the settlement, recruitment and ultimate macrofouling of the substrate. Once positioned upstream of the water system intakes, the permeable, protective structure walls of the antifouling media and/or other system components can desirably impede the passage of various micro- and/or macro-organisms into the system, and the different water conditions created can prevent some and/or all of the organisms from settling on and/or colonizing the substrate if they are already located within the system and/or if they ultimately pass through the enclosure. For example, when microscopic plankton and other traditional non-settling organisms and other settling organisms transit a permeable structure membrane, the different water conditions within the system may impair or injure some of the plankton, while other plankton which remain alive and active will avoid settling and/or colonizing the substrate surface.

In various embodiments, the initial placement of a system upstream from a substrate can cause and/or induce the formation of a “protective” biofilm layer on the surface of the substrate, with this biofilm layer having various desirable properties such as (1) forming a biofilm layer which minimizes biofilm interference with heat transfer through an underlying surface and/or (2) forming a biofilm layer which subsequently protects the substrate from significant additional fouling, which may even include the provision of biofouling protection after the integrity of an enclosure may be violated and the substrate potentially directly exposed to the outside environment. In various embodiments, a proactive or non-settling biofilm may contain one or more of the following as compared to a “natural” biofilm: (1) a different amount of life and/or organisms, (2) a different variation of composition of organisms, (3) a different thickness of the biofilm and/or (4) a different structural integrity of the biofilm.

In various aspects of the invention, the proper design and use of a protective system, such as described herein, can create a “different environment” within the water system that influences and/or induces the formation of a biological coating, layer and/or biofilm on a surface of the substrate that effectively reduces and/or prevents the settlement of biofouling organisms on the substrate. In some aspects of the invention, this reduction and/or prevention may be due to one or more local settlement cues that discourage (e.g., lessen, minimize, or prevent) the settlement of larvae of biofouling organisms, which may include the discouragement of settlement on the substrate, while in other aspects of the invention the reduction and/or prevention may be due to the absence of one or more positive settlement cues that encourage the settlement of larvae of biofouling organisms, which may similarly reduce settlement on the substrate (and/or various combinations of the presence and/or absence of settlement cues thereof may be involved in various embodiments). In another aspect of the invention, the system components may encourage the growth of microorganisms that create one or more local settlement cues that discourage the settlement of larvae of biofouling organisms within the differentiated aquatic environment formed by the system. In a further aspect of the invention, the system may encourage the growth of microorganisms that create one or more local cues that discourage the settlement of larvae of biofouling organisms onto and/or within the fibrous matrix material itself. Accordingly, in these aspects of the invention, larvae of biofouling organisms may be unable or less likely to settle or attach to the submerged substrate or substrate portion(s) protected by the enclosure.

In various embodiments, biofilms can be on the protected substrate, can be formed outside of the enclosure, and/or inside of the enclosure itself. Biofilms on each location can be different based on variable amounts and/or distributions of bacteria, cyanobacteria, diatoms, different bacteria phyla, diversity, thickness, insulative ability and/or integrity, as well as by other measures. In some embodiments, the relatively high velocity of the treated waterflow can “supercharge” the protective or artificial biofilm, which in some embodiments may “grow” faster as higher amounts of “protective” biofilm are added to the substrate. In various embodiments the enclosure desirably creates an artificial aquatic environment to “grow” one or more “protective” biofilms on substrates, which may inhibit and/or delay the ability for organisms to attach to substrate surfaces. In various alternative embodiments, an “artificial” biofilm created herewith may smooth the surface of a substrate such that there are fewer rough or sharp zones for fouling organisms to settle or be trapped within.

In various embodiments, an antifouling biofilm can be created on substrate surfaces within a water circuit of a manufacturing or power plant, wherein a water flowing within said water circuit periodically passes through an enclosure unit comprising at least one layer of a permeable structure having an outer surface, an inner surface and a plurality of pores extending therebetween, wherein the enclosure creates one of more water chemistry changes that inhibits a plurality of organisms from colonizing one or more substrate surfaces positioned within or downstream from the enclosure unit, wherein said antifouling biofilm comprises a reduction in diversity of at least one cyanobacteria, diatom or bacteria compared to a naturally created biofilm in water outside of the water circuit. In various alternative embodiments, the permeable structure may have a biocide coating on the outer surface which extends at least partially into the plurality of pores of the media, wherein the biocide elutes into the water and that inhibits a plurality of organisms from colonizing one or more substrate surfaces positioned within or downstream from the enclosure unit, wherein said antifouling biofilm comprises a reduction in diversity of at least one cyanobacteria, diatom or bacteria compared to a naturally created biofilm in water outside of the water circuit.

There are many generally accepted “standard” progressions or colonizing sequences typically leading to the establishment of a fouling community on a substrate immersed in an aqueous medium such as sea water, brine and/or fresh water. In the typical sequence, immersion of the substrate into the aqueous medium immediately initiates a physical process of macromolecular adsorption, followed by prokaryotic cells and bacteria that rapidly land, attach and form colonies on any surface in the marine environment. In some cases, the subsequent formation of a microbial biofilm may then promote the attachment of algal spores, protozoa, barnacle cyprids and marine fungi, followed by the settlement of other marine invertebrate larvae and macroalgae, while in other cases macrofoulers may settle without a biofilm while still some other macrofoulers may prefer a cleaner surface.

Marine fouling is typically described as following four stages of ecosystem development. The chemistry of biofilm formation describes the initial steps prior to colonization. Within the first minute the van der Waals interaction causes the submerged surface to be covered with a conditioning film of organic polymers. In the next 24 hours, this layer allows the process of bacterial adhesion to occur, with both diatoms and bacteria (e.g. Vibrio alginolyticus, Pseudomonas putrefaciens) attaching, initiating the formation of a biofilm. By the end of the first week, the rich nutrients and ease of attachment into the biofilm allow secondary colonizers of spores of macroalgae (e.g. Enteromorpha intestinalis, Ulothrix) and protozoans (e.g. Vorticella, Zoothamnium sp.) to attach themselves. Within 2 to 3 weeks, the tertiary colonizers- the macrofoulers- have attached. These include tunicates, mollusks and sessile Cnidarians.

Where a system such as described herein is utilized, however, the biological colonizing sequence on the substrate can vary. For example, the biological colonizing sequence on the substrate may be interrupted (disrupted, altered, etc.) to reduce and/or minimize the settlement, recruitment and ultimate macrofouling of the protected substrate. Once positioned around the substrate, the permeable, protective structure walls of the enclosure can desirably impede the passage of various micro- and/or macro-organisms into the enclosure, as well as potentially alter various aspects of the water chemistry within the enclosure.

In one exemplary water system protected by a system, bacterial biofilms that formed on a substrate or other article was meaningfully different from any natural biofilm that forms on a substrate or other object in the open ocean or other aqueous environment in the proximity to that protected article. In various embodiments, the proper system design and operation will desirably induce and/or promote the growth and replication of certain combinations of microorganisms, many of which are normally found in different (i.e., often relatively low) levels in the natural environment, and these combinations of microorganisms may have an ability to promote a certain “recruitment and settlement” behavior to other organisms, identifying the surface of the substrate as inhospitable and/or “less desirable” (and signaling this fact through a variety of means).

DNA analysis confirmed that the surface biofilms that form on PVC and bronze substrates downstream of various system embodiments were significantly different from those formed on similar substrates in open waters, and this is also true of the biofilm forming communities present within the system as well as the biofilms that form in/on an inner wall surface of the system components. For example, biofilms that appeared on PVC and bronze article coupons in open waters were thicker and more diverse compared to biofilms appearing on PVC and bronze article coupons protected by embodiments of the present invention. In addition, macrofouling was observed on the articles in open water, whereas little to no macrofouling was present on the protected substrates. In some embodiments, the biofilm on the protected substrates was less diverse that the open biofilms, with different amounts of diatoms, bacteria, cyanobacteria and differing distributions of bacterial phyla. In addition, the dominant bacterial phyla and bacterial distribution on each protected substrate were markedly different for each system design. For example, the PVC substrate within a spun poly structure system (three rightmost bars) were dominated by Proteobacteria (large grouping at top of bar) and Bacteriodetes (second largest grouping towards the bottom of the bar). In contrast, the bronze substrate within a spun poly structure system (bars 6 through 9) were dominated by Proteobacteria, with a much smaller remainder portion being dominated by Bacteriodetes. This distribution chart of the dominant bacterial phyla in the biofilms are for open bronze bars (first through third columns), open PVC bars (fourth through sixth columns), protected bronze bars (seventh through ninth columns) and protected PVC bars (tenth through twelfth columns). Additionally, the biofilm “integrity” for the protected substrates was different from the open samples, in that the biofilm on some of the protected substrates appeared easier to remove and/or clean from the substrate surfaces as compared to the open substrates. In various embodiments, the bacterial phyla shown below and distributions thereof may be similar for higher velocity water flows and/or other antifouling system designs.

TABLE 12
DISTRIBUTIONS OF BACTERIAL PHYLA IN BIOFILMS

| | | | | | | | Spun | Spun | Spun | | | |
|---|---|---|---|---|---|---|---|---|---|---|---|---|
| | Open | Open | Open | | | | Poly | Poly | Poly | Spun | Spun | Spun |
| | Bronze | Bronze | Bronze | Open | Open | Open | Bronze | Bronze | Bronze | Poly | Poly | Poly |
| Bacterial Taxa | 1 | 2 | 3 | PVC 1 | PVC 2 | PVC 3 | 1 | 2 | 3 | PVC 1 | PVC 2 | PVC 3 |
| Other | 1.2 | 0.3 | 0.5 | 0.8 | 0.5 | 0.1 | 0.1 | 0 | 0.1 | 0.9 | 0.2 | 0.7 |
| Actinobacteria | 7.2 | 1.5 | 3.1 | 6.6 | 9.4 | 10.5 | 0.1 | 0.1 | 0.2 | 1 | 1.1 | 1 |
| Bacteroidetes | 8.5 | 15.4 | 19.1 | 14.9 | 13 | 15.7 | 6.3 | 2.5 | 8 | 33.2 | 37.2 | 31 |
| Chloroflexi | 1.8 | 0.4 | 0.9 | 2.3 | 2.1 | 2.5 | 0 | 0 | 0 | 0.5 | 0.4 | 0.4 |
| Cyanobacteria | 4.6 | 1.3 | 3.3 | 13.7 | 6.9 | 9.3 | 0.3 | 0.1 | 0.3 | 0.8 | 0.6 | 0.7 |
| Firmicutes | 1.1 | 0.2 | 0.4 | 0.5 | 0.8 | 1 | 0 | 0 | 0 | 0.1 | 0.1 | 0.8 |
| Planktomycetes | 0.2 | 0 | 0.1 | 0.2 | 0.3 | 0.2 | 0 | 0 | 0 | 0 | 0 | 0 |
| Proteobacteria | 65.9 | 80.5 | 69.9 | 57.6 | 61.7 | 57.2 | 93.1 | 97.2 | 91.5 | 63.3 | 60.3 | 65.2 |
| Verrucomicrobia | 9.6 | 0.5 | 2.8 | 3.5 | 5.2 | 3.6 | 0 | 0 | 0 | 0.1 | 0 | 0 |
| TOTAL | 100.1 | 100.1 | 100.1 | 100.1 | 99.9 | 100.1 | 99.9 | 99.9 | 100.1 | 99.9 | 99.9 | 99.8 |

Conditioning of Aqueous Environment and Modification Compounds

In some embodiments, it may be desirous to provide supplemental modification of an aqueous environment proximate to a substrate/object to be protected, including such modification prior to, during and/or after the antifouling system has been placed upstream from the object as previously described. In some embodiments, such modification may include the use of natural and/or artificial mechanisms and/or compounds to alter various components of the water chemistry, such as by causing an accelerated depletion and/or replacement of the dissolved oxygen or other change in water chemistry in the aqueous environment by the introduction of one or more aerobic microbes, chemicals and/or compounds (including oxygen depleting compounds) into the aqueous environment proximate to the substrate. For example, in one embodiment an object to be protected from biofouling could comprise the water inlet piping of a water system, where a system as described herein is positioned upstream of the water intake, and then a supplemental oxygen depleting compound or substance comprising one or more species of aerobic bacteria, such as aerobic bacteroides, can be artificially introduced into the aqueous environment of the reservoir in large numbers and/or quantities, desirably accelerating the reduction in dissolved oxygen levels. Such introduction could be by way of liquid, powdered, solid and/or aerosolized supplement thrown or deployed into the seawater and/or enclosed/bounded aqueous environment, or alternatively the oxygen depleting bacteria or other constituents could be incorporated into a layer or biofilm formed in or on an inner surface of the enclosure walls prior to deployment. Desirably, the aerobic bacteroides could comprise a bacterial species already present in the aqueous environments, wherein eventual release of such bacteria through the bottom and/or walls/openings in the sides of the enclosure would not be detrimental and/or consequential to the surrounding environment. In other embodiments, a chemical compound may be introduced into the reservoir to desirably absorb dissolved oxygen from the water, such as powdered iron (i.e., zero-valent iron FeO or partially oxidized ferrous iron Fe2+), nitrogen gas or liquid nitrogen, or additives such as salt may be added to the aqueous environment to reduce the amount of dissolved oxygen the water can hold for a limited period of time.

In various embodiments, the modification compound could comprise a solid, a powder, a liquid, a gas or gaseous compound and/or an aerosol compound which is introduced into the enclosed or bounded aqueous environment prior to and/or concurrent with the water contacting the substrate. In some embodiments, the modification compound may be positioned within the bounded aqueous environment for a limited or desired period of time, and then removed from the environment after the desired modification and/or conditioning of the water has occurred (i.e., creation of the “differentiated” aqueous environment). In other embodiments, the modification compound may be distributed into the bounded aqueous environment, with some embodiments of the compound potentially dissolving and/or distributing into the water while other compounds may remain in a solid and/or granular state. If desired, the modification compound may include buoyancy features which desirably maintain some or all of the compound within the enclosure and/or at a desired level within the water column, while other embodiments may allow the compound to exit from the bottom and/or sides of the system components and/or rest on the bottom of a harbor or other seafloor feature within and/or proximate to the enclosure. In still other embodiments, the modification compound may alter the density and/or salinity of the water or other liquids within the differentiated environment, which may reduce and/or eliminate the natural tendency for liquids within and/or outside of the differentiated environment to mix together and/or otherwise flow.

In at least one alternative embodiment, a modification compound or compounds may be released into the external, non-enclosed waters adjacent or near the antifouling system, which may flow into and/or through the enclosure, if desired. In still other embodiments, the modification compound and/or constituents thereof may be deployed in combination with some components placed outside of the differentiated environment, which other components could be placed within the enclosed or differentiated environment.

In some embodiments, the modification compound may be attached to and/or integrated into the walls of the system, including within the material construction and/or any coatings therein/thereon. If desired, the compound could include a water and/or salt-activated and/or ablative material which reacts with the aqueous medium, having a limited duration such as 10 minutes, 1 hour, 12 hours and/or 2 days for which the compound affects the dissolved oxygen level and/or other water chemistry level(s) within the enclosure, or could be effective for longer periods of time such as 1 week or 1 month or 1 year. If desired, the modification compound or other material could be positioned within replaceable bags that can be positioned within and/or outside of the system, with the material in the bags “depleting” over time and potentially requiring replacement as needed.

In one exemplary embodiment, the modification compound could comprise a crystalline material that absorbs oxygen from the aqueous environment within the enclosure, such as a crystalline salt of cationic multi-metallic cobalt complexes (described in “Oxygen chemisorption/desorption in a reversible single-crystal-to-single-crystal transformation,” published in CHEMICAL SCIENCE, the Royal Society for Chemistry, 2014). This material has the capability of absorbing dissolved oxygen (O₂) from air and/or water, and releasing the absorbed oxygen when heated (i.e., such as being left out in ambient sunlight) and/or when subjected to low oxygen pressures. If desired, this oxygen absorptive material could be incorporated into the wall material of the system such that oxygen is immediately absorbed when the enclosure is placed within the water in proximity to the protected substrate, but such oxygen absorption would taper off after a period of time after placement. Subsequently, the enclosure could be removed from the water (such as after protection is no longer desired) and left in the sunlight to release the absorbed oxygen and “recharge” for the next use.

In another exemplary embodiment, the modification compound could comprise a gas or gaseous compound such as nitrogen or carbon dioxide (or some other gas or compound) that could be introduced into the system in gaseous form or which could be released from a pellet or other liquid or solid compound (including potentially the “dry ice” form of CO2). Such introduction or “sparging” could comprise injection of nitrogen and/or N2 bubbles into the water inside the system, or within/along the walls of the system. In some embodiments a system such as described herein can be combined with an installed nitrogen dosing system and monitoring probe for oxygen levels that controls the periodic renewal of the nitrogen flush when needed. In various embodiments, nitrogen injection may be accomplished using a small nitrogen tank with a porous weighted dispenser (i.e., an aquarium aeration stone) while other embodiments may utilize an on-site nitrogen generator to purify nitrogen from the air, and then dispense this nitrogen through a pumping system. If desired, the nitrogen dispensing system could include a bubble dispensing system that releases bubbles of a single range of sizes or of varying size ranges, if desired. In at least one embodiment, a nitrogen nanobubble infusing system may be utilized.

Desirably, the biocide coating can provide some desirable level of fouling protection for the substrate and/or the water treatment system components, which may include protection for the surface(s), pores and/or other openings in filtration and/or dosing media through which water can flow. For example, in one exemplary embodiment, an antifouling system can include a water treatment unit comprising at least one layer of a permeable structure media having an outer surface, an inner surface and a plurality of pores extending therebetween, the permeable structure media having a biocide coating on the outer surface which extends at least partially into the plurality of pores, the water treatment unit further having an oxygen removal system that removes at least a portion of the dissolved oxygen in a water having passed through the treatment unit, the water treatment unit positioned at a water intake location of the water circuit, wherein all of the water entering the water circuit passes through the water treatment unit, the water requiring an average dwell time to travel through the water circuit and be expelled from a water discharge of the water circuit, wherein the biocide coating elutes a biocide into the water passing through the water treatment unit, the biocide contacting a plurality of fouling organisms in the water and inhibiting an ability of the plurality of fouling organisms to colonize one or more substrate surfaces within the water circuit for at least the average dwell time. In another exemplary embodiment, an antifouling system can include a water treatment unit comprising at least one layer of a permeable structure having an outer surface, an inner surface and a plurality of pores extending therebetween, the permeable structure having a biocide coating on the outer surface, and an oxygen removal system that removes at least a portion of the dissolved oxygen in a water passing through the water treatment unit; the water treatment unit positioned at a water intake location of the water circuit, wherein all of the water entering the water circuit passes through the water treatment unit, wherein the biocide coating elutes a biocide into the water in proximity to the outer surface of the permeable structure, the biocide contacting a plurality of fouling organisms in the water and inhibiting an ability of the plurality of fouling organisms to colonize the outer surface of the permeable structure. In still another embodiment, the antifouling system can include a water treatment unit comprising at least one layer of a permeable structure having an outer surface, an inner surface and a plurality of pores extending therebetween, the permeable structure having a biocide coating on the outer surface which extends at least partially into the plurality of pores; the water treatment unit positioned at a water intake location of the water circuit, wherein all of the water entering the water circuit passes through the water treatment unit, wherein the biocide coating elutes a biocide into the water in proximity to the pores of the permeable structure, the biocide contacting a plurality of fouling organisms in the water and inhibiting an ability of the plurality of fouling organisms to colonize the plurality of pores of the permeable structure. If desired, the system could similarly include an oxygen removal component that removes at least a portion of the dissolved oxygen in a water passing through the system.

In at least one alternative embodiment, a gaseous compound injection suitable for use in the various systems described herein could comprise an ozone injection system such as the Ozonix® system, commercially available from Ecosphere Technologies, Inc. of Stuart Fla., USA.

In various embodiments, the modification compounds described herein will desirably induce a reduction in the dissolved oxygen levels of the enclosed or bounded aqueous environment within/after a few seconds or application and/or within/after a few minutes of application (i.e., 1 minute to 5 minutes to 10 minutes to 20 minutes to 40 minutes to 60 minutes of applied nitrogen bubbling) and/or within/after a few hours of application by at least 10%, by at least 15%, by at least 20%, by at least 25%, by at least 50%, by at least 70%, and/or by at least 90% or greater.

Water Chemistry Differences

In some embodiments, the disclosed antifouling systems and/or associated reservoir systems will desirably provide (1) a barrier to significant levels of oxygen transport into the water supply system, and/or (2) a potential reduction of available energy and/or nutrient supplies within the reservoir for organisms and/or chemical reactions, which may reduce and/or prevent natural photosynthesis or other metabolic processes of microorganisms and/or undesirably chemical reactions from occurring within the reservoir. Desirably, once the disclosed antifouling system is in a desired position, the natural biological processes within the reservoir will desirably utilize much of the dissolved oxygen contained in the liquid within the reservoir, thereby significantly lowering the dissolved oxygen levels within the reservoir to levels that may approach anoxic levels, but which desirably do not exceed anoxic levels for extended periods of time (with some level of dissolved oxygen being replenished via the antifouling system).

In various embodiments, the systems described herein will desirably induce a differential in the dissolved oxygen levels and/or other water chemistry levels of the enclosed aqueous environment (i.e., within the enclosure as compared to dissolved oxygen levels—or other water chemistry constituent—outside of the enclosure) after a period of at least 1 or 2 hours by at least 10%, by at least 15%, by at least 20%, by at least 25% by at least 50% by at least 70% by at least 90% or greater.

In various embodiments, the devices of the present invention will desirably provide a reduction, cessation and/or reversal of biofouling and/or the creation of a desired enclosed environment that deters settling of biofouling organisms and/or that is conducive to formation of a desired anti-fouling layer and/or biofilm on the substrate—i.e., initiating the creation of a desired local aquatic environment (i.e., the “differentiated environment”) upon being deployed to influence the formation of an advantageous biofilm which results in decreased biofouling on the protected substrate or article. In various embodiments, this “differentiated environment” may be created within seconds, minutes and/or hours of system deployment upstream from a substrate, while in other embodiments it may take days, weeks or even months to create a desired “differentiated environment.” If desired, a system may be deployed long before a substrate to be protected is placed therein, while in other embodiments the system components can be deployed concurrently with the substrate or water supply intake or the system can be deployed long after the substrate has been immersed and/or maintained in the aqueous environment. In various embodiments, the creation of significant water chemistry differences and/or other unique aspects of the differentiated environment may begin immediately upon deployment or may be created within 1 hour of the system being placed in the aqueous environment (which could include the system being placed alone in the environment and/or in proximity to the substrate to be protected), while in other embodiments the initiation and/or creation of a desired differentiated environment (which may include creation of the complete differentiated environment as well as creation of various fouling inhibiting conditions which may alter and/or be supplemented as further aspects of the differentiated environment are induced) may require the system to be in operation upstream from the substrate for at least 2 hours, at least 3 hours, at least 6 hours, at least 12 hours, at least 18 hours, at least 1 day at least 2 days, at least 3 days, at least 4 days, at least 5 days, at least 6 days, at least 1 week, at least 2 weeks, at least 3 weeks, at least 4 weeks, at least a month, at least 2 months, at least 3 months and/or at least 6 months or longer. In various embodiments, the various water chemistry differences which may be created in these various time periods may include dissolved oxygen, pH, total dissolved nitrogen, ammonium, ammoniacal nitrogen, nitrates, nitrites, orthophosphates, total dissolved phosphates, silica, salinity, temperature, turbidity, chlorophyll, etc.), the various concentrations of which may increase and/or decrease at differing times, including differing concentrations of individual constituents at different durations of enclosure immersion.

In some cases, the devices and/or components thereof of the present invention may degrade and/or no longer provide a desired level of antifouling and/or environment creating effects after a certain period of time. In various embodiments, the amount of time until the antifouling system loses its antifouling affect can vary based on numerous factors, including the particular aquatic environment, the season, the temperature, the makeup of marine organisms present, temperature, light, salinity, wind, water speed, etc. It should be noted that, based on the conditions of the aquatic environment, the system may temporarily lose antifouling and/or environment creating effects, only to regain its antifouling/environment creating effect(s) when the conditions return to normal or to some desired measure. “Useful life,” as used herein, can mean the amount of time from the deployment of the system to the time when the level of macro-fouling becomes problematic on the substrate, while “system life” can mean the amount of time the system itself, or the various components thereof (which may include the useful life of the individual enclosure components and well as the estimated system life in-toto where the enclosure and/or various components thereof are regularly cleaned, maintained and/or replaced on a periodic basis) remains physically intact and effective upstream from the substrate itself (which may be exceeded by the “useful life” of the biofouling protection provided by the system in some embodiments enclosure). In various aspects of the present invention, one or both of the useful life and/or enclosure life of the system and/or individual enclosure components can be: not less than 3 days, not less than 7 days, not less than 15 days, not less than 30 days, not less than 60 days, not less than 90 days, not less than 120 days, not less than 150 days, not less than 180 days, not less than 270 days, not less than 1 year, not less than 1.5 years, not less than 2 years, not less than 3 years, not less than 4 years, or not less than 5 years.

Alteration of the Colonizing Sequence

In various embodiments, when a system such as described herein is utilized, the biological colonizing sequence on the downstream substrates may be interrupted (disrupted, altered, etc.) to reduce and/or minimize the settlement, recruitment and ultimate macrofouling of the substrates. Desirably, the permeable, protective structure walls of the enclosure can desirably impede the passage of various micro- and/or macro-organisms into the water system, and the biocide coating will prevent fouling of the enclosure and/or might injure and/or impair some and/or all of the organisms as they contact and/or pass through the structure. If desired, the biocidal coating may experience significant biocidal elution upon initial placement around the substrate to establish an initial higher “kill level” affecting fouling organisms, with the biocidal elution levels significantly reducing over a period of time.

In many of the embodiments described herein, the disclosed biofouling protective systems may provide significant levels of protection for substrates once the enclosure treats the environmental water, which may then be held in a reservoir or may travel directly into an intake of the water system. Desirably, the design and positioning of the system upstream from the substrate may optionally alter various water chemistry features and/or components of the liquid in contact with the substrate to a meaningful degree, as compared to those of the open aqueous environment. In various instances, the system may induce some water chemistry features to be “different” as compared to the surrounding aqueous environment, while other water chemistry features may remain the same as in the surrounding aqueous environment. For example, where dissolved oxygen levels may often be “different” between the differentiated environment and the open environment, the temperature, salinity and/or pH levels within the differentiated and open environments may be similar or the same. Desirably, the system can affect some water chemistry features in a desired manner, while leaving other water chemistry features minimally affected and/or “untouched” in comparison to those of the surrounding open aqueous environment. Some exemplary water chemistry features that could potentially be “different” and/or which might remain the same (i.e., depending upon enclosure design and/or other environmental factors such as location and/or season) can include dissolved oxygen, pH, total dissolved nitrogen, ammonium, nitrates, nitrites, orthophosphates, total dissolved phosphates, silica, salinity, temperature, turbidity, chlorophyll, etc.

In some exemplary embodiments, a measure of one or more water chemistry features may be “different” inside of the water system as compared to an equivalent measurement outside of the system (which may include measurement at some distance removed from the system. Such “difference” may include a difference of 0.1% or greater between inside/outside measurements, or a difference of 2% or greater between inside/outside measurements, or a difference of 5% or greater between inside/outside measurements, or a difference of 8% or greater between inside/outside measurements, or a difference of 10% or greater between inside/outside measurements, or a difference of 15% or greater, or a difference of 25% or greater, or a difference of 50% or greater, or a difference of 100% or greater. In addition, such differences may be for multiple chemistry factors with unequal differences or may include an increase of one factor and a decrease of another factor. Combinations of all such described water chemistry factors are contemplated, including situations where some water chemistry factors remain essentially the same for some factors, while various differences may be noted for other factors.

In various embodiments of the present invention, the system can create a “differentiated aqueous environment” downstream from the system components. Desirably, the artificial environmental conditions created by the system will thereby inhibit and/or prevent the settlement, recruitment, growth and/or colonization of the substrate by fouling organisms. In various embodiments, the artificial environmental conditions created by the system may include a reduced dissolved oxygen level which can significantly contribute to the reduction of biofouling of the substrate, in that the reduced availability of oxygen can render it difficult for some fouling organisms to colonize and/or thrive within the enclosure and/or on the substrate. In addition, the reduction in dissolved oxygen levels can increase the creation of, and/or greatly reduce the opportunity for other organisms to process and/or eliminate, waste materials such as hydrogen sulfide and/or ammoniacal nitrogen (i.e., free ammonium nitrogen, Nitrogen—Ammonia or NH₃—N), which are both detrimental and/or even toxic to a variety of aquatic organisms and/or microorganisms. For example, the biologically driven nitrogen cycle, which occurs in various bodies of water, can contribute greatly to the reduction of free Oxygen within the enclosure, with NH₃—N levels being at least partially dependent on available dissolved Oxygen levels. In addition, in some embodiments an anammox reaction may potentially be initiated and/or sustained by bacteria within the enclosure, which may produce hydrazine and/or other byproducts that similarly inhibit marine growth. In general, the concentrations of these byproducts will be greater inside of the water system than outside of the enclosure, and in some embodiments the individual concentrations and/or comparative ratios of these byproducts within the enclosure may fluctuate for a variety of reasons.

For example, in various embodiments the systems described herein can induce the creation of metabolic wastes, toxins or other inhibitory compounds such as NH₃—N in concentrations ranging from 0.53 mg/L to 22.8 mg/L within the water system, which can be toxic to various freshwater organisms (typically dependent upon pH and/or temperature). In other embodiments, the concentrations of NH₃—N created in the differentiated environment may range from 0.053 to 2.28 mg/L, which may inhibit biofouling formation within the water system. In addition, at levels as low as 0.002 mg/L or greater of NH₃—N, the ability of various aquatic flora and/or fauna to colonize and/or reproduce can be significantly degraded.

It is further proposed that, in some exemplary embodiments, the fluctuations and/or variations in the individual levels of water chemistry constituents, such as dissolved oxygen, ammonium, total dissolved nitrogen, nitrates, nitrites, orthophosphates, total dissolved phosphates and/or silica (as well as various others of the chemistry components described herein), forms an important aspect of some embodiments of the present invention, in that the artificial environments created downstream from the system components will desirably “promote” and/or “inhibit” the thriving of different macrofouling and microflora and/or macrofouling and microfauna at different periods of time. Such continuous changes in the differentiated environment desirably may force the various organisms present within and/or in proximity to the water system to constantly adapt and/or change to accommodate new environmental conditions, which tends to inhibit predominance of a single species or species grouping within and/or in proximity to the enclosure. This can have the effect of enhancing competition between various of the flora and/or fauna within the system, which may inhibit and/or prevent the by a single variety, species and/or distribution of flora and/or fauna, and thereby reduce the potential for a predominant species of bacteria or other micro or macro entities to have an opportunity to thrive and/or devote energy to fouling the substrate or forming a base to which other fouling organisms may attach.

In various embodiments, the system may induce the formation of a water chemistry factor which inhibits fouling such as ammoniacal nitrogen in higher concentrations within the system than in the outside aqueous environment. If desired, a concentration of ammoniacal nitrogen may be obtained that may be equal to or greater than 0.1 parts per billion (ppb), may be equal to or greater than 1 parts per billion (ppb), may be equal to or greater than 10 parts per billion (ppb) and/or may be equal to or greater than 100 parts per billion (ppb). In various embodiments, the system may induce the formation of a water chemistry factor which inhibits fouling such as nitrite in higher concentrations than outside of the system. If desired, a concentration of nitrite within the water system may be obtained that may be equal to or greater than 0.1 parts per billion (ppb), may be equal to or greater than 0.1 parts per million (ppm), may be equal to or greater than 0.5 parts per million (ppm) and/or may be equal to or greater than 1 parts per million (ppm).

In various embodiments, the placement of a system upstream from a substrate will desirably “modulate” the dissolved oxygen and create a dissolved oxygen differential between waters inside of and outside of the water system, which desirably provides a significant improvement in preventing fouling of the protected system components. In many cases, dissolved oxygen modulation of the differentiated environment can encompass the creation of a meaningfully lower dissolved oxygen level within the water system versus the external environment, with this dissolved oxygen level fluctuating by varying degrees in response to internal oxygen consumption and external dissolved oxygen levels. In addition, a secondary gradient between the dissolved oxygen of the “bulk water” within the differentiated environment and the dissolved oxygen in the water within a “boundary layer” at the surface of the protected substrate or article may also exist, at least in part due to the lower energy environment within the enclosure compared to the external environment and/or the absence of significant turbulence and/or eddy flow currents that can “mix” the water within the enclosure. These localized differential conditions may be caused by the consumption of oxygen and/or nutrients by organisms and/or other factors at the substrate's or article's surface and/or in the water column, which can lead to a further depleted “boundary layer” that contributes to the lack of biofouling and/or creation of an anti-fouling biofilm on the protected article.

In place of and/or in addition to a reduction of the dissolved oxygen levels in the water contained in the water system, a wide variety of other water chemistry factors may be affected by the design and placement of the system embodiments described herein, including water chemistry factors which may significantly retard and/or prevent fouling of a protected substrate. For example, when oxygen is depleted in a water system, some species of naturally occurring bacteria within the enclosure will typically first turn to a second-best electron acceptor, which in sea water is nitrate. Denitrification will occur, and the nitrate will be consumed rather rapidly. After reducing some other minor elements, these bacteria eventually turn to reducing sulfate, which results in the byproduct of hydrogen sulfide (H₂S), a chemical toxic to most biota and responsible for a characteristic “rotten egg” smell. This elevated level of hydrogen sulfide within the enclosure, among other chemicals, can then inhibit fouling of the substrate in a desired manner as described herein. Moreover, the hydrogen sulfide within the enclosure can also elute through the walls of the enclosure (i.e., with bulk flow of water out of the enclosure) and potentially inhibit fouling growth in the pores of and/or on the external surfaces of the enclosure.

In addition to creating localized conditions that inhibit fouling of a protected substrate, the various embodiments described herein are also extremely environmentally friendly, in that any toxic and/or inhospitable conditions created within the system are quickly neutralized outside of the system. For example, when fluid is expelled from the system, this displaced fluid may contain components that are toxic and/or inhospitable to marine life (which desirably reduce and/or prevent fouling from attaching to the substrate within the system). Once outside the system, however, these components are quickly degraded, oxidized, neutralized, metabolized and/or diluted in the external aqueous environment by a wide variety of naturally-occurring mechanisms, which generally cause no lasting effect on the aquatic environment, even in close proximity to the system discharge itself. This is highly preferable to existing antifouling devices and/or paints that incorporate high levels of biocides and/or other agents, some of which are highly toxic to many forms of life (including fish and humans and/or other mammals), and which can persist for decades in the marine environment.

Antifouling Structures with Optional Biocide

In various embodiments, disclosed are highly effective devices and/or systems for applying and/or “dosing” biocides into a fluid stream or fluid flow to desirably inhibit the attachment, settling and/or growth of biofouling organisms within fluid streams or flow is disclosed herein. In various embodiments, an enclosure or structure is disclosed, a structure having a top surface, a bottom surface and a plurality of pores extending through the structure from the top surface to the bottom surface, with a coating or “paint” containing at least one biocidal or toxic agent applied thereto. In at least one exemplary embodiment, the coating can be applied to the top surface of the structure, with some portion of the coating passing into and/or or through the pores. If desired, the coating application process can include the application of a suction or vacuum to the bottom surface of the structure, which desirably can draw some portion of the coating into the pores while desirably maintaining patency (i.e., an “open” condition) of the pore openings through the structure (i.e., the coating desirably will not “clog” a majority of the pores through the structure after application thereto). Once the coating dries or otherwise cures to a desired state, the coated structure can be formed into a desired shape and/or configuration, and then placed into a water stream wherein the fluid passes through the pores of the structure, wherein amounts of the biocidal and/or toxic agent elutes or is otherwise dispensed into the individual fluid streams passing through the pores. Because the spores, propulgates, larvae and/or juvenile forms of fouling organisms are also passing though these individual pores, these organisms are exposed to a relatively higher dosage of the biocidal and/or toxic agent, which desirably inactivates and/or inhibits their abilities to attach, settle and/or grow within the pores of the enclosure and/or on wetted surfaces further downstream in the fluid flow.

In various exemplary embodiments, the disclosed enclosures may optionally include the use of supplemental biocidal and/or antifouling agent(s) for the media to provide adequate biofouling protection for the enclosure materials, water intakes and/or protected substrates, which might also include the periodic use of uncoated structure enclosure components during certain immersion periods when the fouling pressure may be such that unprotected structures could be free of macrofouling and/or where an uncoated enclosure might be sufficient to provide protection to the contained substrate for a desired period of time. In many embodiments, at least a portion of a surface of the enclosure wall structure may be impregnated by, infused with and/or coated with a biocidal paint, coating and/or additive. In some additional embodiments, biocidal and/or antifouling agent(s) may be integrated into the enclosure and/or other system components and/or other portions thereof to desirably protect the system itself from unwanted fouling. In some exemplary embodiments, the structure or material may act as a carrier for the biocide. In general, a biocide or some other chemical, compound and/or microorganism having the capacity to destroy, deter, render harmless and/or exert a controlling effect on any unwanted or undesired organism by chemical or biological means may optionally be incorporated into and/or onto some portion(s) of the material, such as during manufacture of the material or material components, or the biocide et al can be introduced to the material after manufacture. Desirably, the one or more biocides in/on the material will inhibit and/or prevent colonization of aquatic organisms on the outer surface and/or within openings within the enclosure or other system components, as well as to repulse, incapacitate, compromise and/or weaken biofouling organisms small enough to attempt or successfully penetrate through the openings in the enclosure, such that they are less able to thrive within the artificial or synthetic local aquatic environment downstream of the enclosure. In various embodiments, the enclosure desirably incorporates a material which maintains sufficient strength and/or integrity to allow the protection and/or inhibition of biofouling (and/or enables the creation of the desired artificial local aquatic environment or synthetic local aqueous environment) for a useful life of not less than about 3 to 7 days, 7 to 15 days, 3 to 15 days, at least 1 month, at least 2 months, at least 3 months, at least 6 months at least 12 months, at least 2 years, at least 3 years, at least 4 years and/or at least 5 years or longer. In some embodiments, a coating containing water soluble and/or degradable resins or other degradable material which encapsulate one or more biocides may be used. In such a coating, the resin or degradable material (i.e. PLA or similar) may encapsulate the biocide, and once the resin or material is contacted by water, the water can penetrate and break up the resin structure, allowing the biocide to be released into the environment. In another preferred embodiment, a degradable material, similar to a film or sheet material maybe impregnated with at least one biocide causing the biocide to release when the material degrades. This arrangement will desirably provide a highly effective base or structure for controlled biocide dosing of water passing through the matrix, which may currently improve the mixing of the biocide with the water within the pores and/or other areas of the fibrous matrix and/or other areas of the protected environment.

In at least one exemplary embodiment, an enclosure system contains at least one coating or paint with at least one active ingredient or biocide in which the coating elutes at some rate for the useful life of the enclosure. In some exemplary embodiments, the biocide elution can first occur at a front or face of the structure and/or within the structure pores, with the breakdown of the water soluble resign in some embodiments allowing the pores to increase in size, which may allow the structure to continue allowing water through these pores without clogging quickly via biofilm or biofouling growth. As the pores increase in size, the effective surface area of the resin in each of the pores may increase, which may increase elution of biocide and the effectiveness of the biocide treatment in some embodiments. A desired biocide content within a given fluid flow may be dependent upon a variety of factors including the levels and/or concentration of the biocide within a resin, the speed at which the resin degrades and the biocide is released, a biocide contact ratio which can be the surface area of the coating in the pores relative to the pore volume, the speed and/or volume of water flowing through the matrix and/or the temperature of the flowing water, among others.

In another exemplary example, biocide or active ingredient levels may be tuned or optimized to the environment parameters, water chemistry, and/or types and amounts of organisms. Biocide concentrations, elution rates and release profiles may vary based on water flow rates, water dwell times, water exchange, water mixing, water turbulence, or similar. Total biocide released or eluted may be calculated based on the total active ingredient or biocide per total volume of water consumption or water flow through, on or around the structure over a set time within a water system. In a preferred embodiment, total biocide released in flowing water after 30 days may be at least 500 parts per million (ppm), at least 100 ppm, at least 80 ppm, at least 50 ppm, at least 40 ppm, at least 30 ppm, at least 25 ppm, at least 20 ppm, at least 15 ppm, at least 10 ppm, at least 5 ppm, at least 1 ppm, at least 75 parts per billion (ppb), at least 50 ppb, at least 10 ppb, at least 5 ppb, at least 1 ppb, or at least 0.1 ppb. In some embodiments, total biocide released in flowing water after 60 days may be at least 500 ppm, at least 100 ppm, at least 50 ppm, at least 50 ppm, at least 40 ppm, at least 30 ppm, at least 25 ppm, at least 20 ppm, at least 15 ppm, at least 10 ppm, at least 5 ppm, at least 1 ppm, at least 75 ppb, at least 50 ppb, at least 30 ppb, at least 10 ppb, at least 5 ppb, at least 1 ppb, or at least 0.01 ppb.

A coating containing biocide and/or other chemicals may be applied to a fibrous medium in a multitude of ways, including by adding the coating to one or both sides of a structure, injecting the coating within the structure, extruding a coating onto a structure, submerging a structure within a coating bath, or other coating techniques well known in the art.

In at least one exemplary embodiment of an system, the enclosure can comprise a material which is coated, painted and/or impregnated with a biocide coating, which desirably adheres to and/or penetrates the material to a desired depth (which could include surface coatings of the material on only one side of the structure, as well as coatings that may penetrate from 1% to 99%, or 25%, or 50%, or 75% of the way through the structure, as well as coatings that may fully penetrate through the structure and coat some or all of the opposing side of the structure), coat one side, coat two sides, or coat all sides of the structure. In at least one embodiment, the coating may be on or embedded within the surface facing the substrate or article that needs protection or on the surface opposite of the substrate or article. In some embodiments, the biocide coating or paint will contain at least one (i.e. 2, 3, 4, 5, 6 or more) biocide and/or active ingredient to reduce biofouling and biofilm accumulation. Desirably, the biocide will reduce and/or prevent the type, speed and/or extent of biofouling on the fibrous matrix material itself, and/or will also have some deleterious effect on microorganisms attempting to pass through openings in the material into the downstream aqueous environment (and may also have some effect on microorganisms already resident within the reservoir and/or the downstream water system). In various embodiments, the presence of the biocide coating or paint along the 3-dimensional “entry path” through the enclosure (i.e., as the microorganisms pass through the openings and/or pores of the material) will desirably provide a larger surface area and prove more effective than the standard 2-dimensional “planar” paint biocide coverage (i.e., a hard-planar coating) utilized on rigid, submerged surfaces in marine use today. In various aspects, especially where the structure matrix material is highly fibrillated and/or ciliated, the coating of such materials can desirably provide a higher “functional surface area” of the structure for the biocide coating to adhere to, which desirably increases the potential for anti-biofouling efficacy as organisms are more likely to be located near to and/or in contact with these small fibers (and the biocide paint, coating or additive resident thereupon or therein) as they pass through the structure.

In various alternative embodiments, the enclosure can incorporate a material which is coated, painted and/or impregnated with a biocide coating (which could include surface coatings of the material on only one side of the structure, as well as surface coatings from the front and/or back of the structure which may extend some amount into the pores of the structure), which may include coatings on one surface of the structure that penetrate up to 5% into the pores of the structure, up to 10% into the pores of the structure, up to 15% into the pores of the structure, up to 20% into the pores of the structure, up to 25% into the pores of the structure, up to 30% into the pores of the structure, up to 35% into the pores of the structure, up to 40% into the pores of the structure, up to 45% into the pores of the structure, up to 50% into the pores of the structure, up to 55% into the pores of the structure, up to 60% into the pores of the structure, up to 65% into the pores of the structure, up to 70% into the pores of the structure, up to 75% into the pores of the structure, up to 80% into the pores of the structure, up to 85% into the pores of the structure, up to 90% into the pores of the structure, up to 95% into the pores of the structure, up to 99% into the pores of the structure, up to 100% of the way through the pores of the structure and/or extending out of the pores onto the opposing surface of the structure.

In various embodiments, the additional incorporation of a biocide coating or other coating/additives in some embodiments also desirably improves durability and functional life of the enclosure, the system and/or its components, in that biofouling organisms and/or other detrimental agents should be inhibited and/or prevented from colonizing the flexible structure and/or perforations therein for a period of time after immersion, thereby desirably preserving the flexible, perforated nature of the system walls and the advantages attendant therewith. Where the biocide is primarily retained proximate to the structure matrix (i.e., where the biocide may have very low or no biocide elution levels outside of the structure or the enclosure), the biocide will desirably significantly inhibit biofouling of the enclosure and/or system walls, while the presence of the system and the “differentiated aqueous environment” created downstream thereof will reduce and/or inhibit biofouling of the protected water system or other substrate. In various exemplary embodiments, it is possible for the biocide to have extremely low and/or no detectable levels in water downstream from the enclosure and/or in water released from the water system (i.e., below 30 ng/L) and still remain highly effective in protecting the water system and/or system components from biofouling. In one example, biocide release rates from a coated fibrous matrix material was detected as 0.2-2 ppm and/or lower between 7 days in artificial sea waters and low local concentrations (i.e. biocide release rates) were detected as 0.2-2 ppm and/or lower between 7 days in artificial sea waters, and these release rates were effective at protecting the fibrous matrix materials from biofouling.

A wide variety of supplemental coatings incorporating various biocides and/or other dispensing and/or eluting materials may be incorporated into a given system design to provide various anti-fouling advantages. For example, coatings which release econea and/or pyrithione in varying amounts and/or timing can be useful in combatting biofouling (with Econea primarily targeting “hard shell” organisms and zinc pyrithione or copper pyrithione primarily targeting “soft or no shell” organisms), including embodiments having initially high release rates which significantly reduce after only a few hours, days and/or weeks after immersion, as well as other embodiments having initially low release rates which increase over time of immersion. An exemplary coating can incorporate a single biocide or formulation that targets one of more fouling species, or a coating can incorporate two or more biocides in varying ratios, with each biocide targeting one or more different fouling species and/or differing life stages of a similar fouling organism. The selected biocides and their concentrations may vary based on a given application and type of biofouling, which may be dependent upon a variety of factors including the geographic location of fouling protection, the season of the year, various local fouling pressures, the specific water application for the antifouling enclosure, the design and features of the antifouling system, the desired duration of fouling protection and/or the structure and/or type of substrate(s) for which protection is desired. In some exemplary embodiments, a ratio of a first biocide to a second biocide in a coating formulation can be approximately 1:1, approximately 1:2, approximately 1:3, approximately 1:4, approximately 1:5 approximately 1:10. Approximately 1:15, approximately 1:20, approximately 1:255, approximately 1:50, approximately 1:100 or greater. In one particularly useful embodiment, a ratio of Econea to zinc pyrithione (or copper pyrithione) can be approximately 3:1 (i.e., 75% Econea to 25% zinc or copper pyrithione) in an exemplary coating formulation that targets both hard and soft shell organisms.

In at least one exemplary embodiment, an enclosure can comprise a spun polyester structure having a surface and/or subsurface coating of a commercially available biocide coating, including water-based and/or solvent-based coatings containing registered biocides, with the coating applied to the structure by virtually any means known in the art, including by brushing, rolling, painting, dipping, spray, production printing, encapsulation and/or screen coating (with and/or without vacuum assist). Coating of the material may be accomplished on one or both sides of the material, as well as single-sided coating on the inner facing side of the materials, although single-sided coating on the outwardly facing side of the material (i.e., away from the substrate and towards the open aqueous environment) has demonstrated significant levels of effectiveness while minimizing biocide content, cost, and maintaining advantageous flexibility. While water-based (“WB”) biocidal coatings are primarily discussed in various embodiments herein, solvent-based (“SB”) biocidal coatings could alternatively be used in a variety of applications (and/or in combination with water-based paints), if desired.

In various embodiments, the use of various printing processes for the coating could have an added benefit of allowing the incorporation of visible patterns and/or logos into and/or on the system components, which could include marketing and/or advertising materials to identify the source of the system (i.e., system manufacturer) as well as identification of one or more users (i.e., a particular marina and/or boat owner/boat name) and/or identification of the anticipated use area and/or conditions (i.e., “salt water immersion only” or “use only in Jacksonville Harbor” or “summer use only”). If desired, various indicators could be incorporated to identify the age and/or condition of the system components, including the printing of a “replace by” date on the outside of a replaceable modular filter unit, for example. If desired, the visible patterns could be printed using the biocide coating itself, which could incorporate supplemental inks and/or dyes into the coating mix, or the additional logos, etc. could be printed using a separate additive.

In various embodiments, a biocide coating or paint can desirably be applied to the material in an amount ranging from 220 grams per square meter to 235 grams per square meter, although applications of less than 220 grams per square meter, including 100 grams per square meter or less, as well as applications of more than 235 grams per square meter, including 300 grams per square meter and greater, show significant potential. In various alternative embodiments, the coating mixture could comprise one or more biocides in various percentage weights of the mixture, including weights of 10% biocide or less, such as 2%, 5% and/or 7% of the mixture, or greater amounts of biocide, including 10%, 20%, 30%, 40% 50% and/or more biocide by weight of the coating mixture, as well as ranges encompassing virtually any combination thereof (i.e., 2% to 10% and/or 5% to 50%, etc). Where the enclosure design may be particularly large, it may be desirous to significantly increase the percentage of biocide in the coating mixture, which would desirably reduce the total amount of coating required for protection of the enclosure and/or substrate.

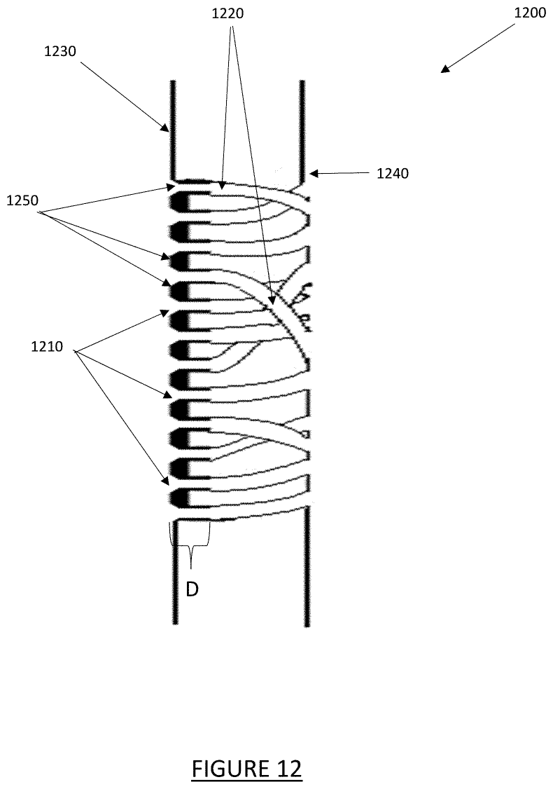

FIG. 12 depicts a cross-sectional view of an exemplary permeable structure 1200, with various pore openings 21210 and simplified passages 1220 extending from a front face 1230 to a back face 1240 of the structure 1200. A coating substance 1250, optionally containing a biocide or other debilitating substance, is also shown, wherein some portions of this coating substance extends from the front face 1230 at least some distance “D” into the pore openings 1210 and/or passages 1220 of the structure 1200. In various embodiments, the coating substances will desirably penetrate some average distance “D” into the structure of the material and/or structure wall openings/pores (i.e., a 3%, 5%. 10%, 15%, 20%, 25%, 50%, 75% or greater depth of penetration into the structure—see FIG. 12). Desirably, the coating substance, which is often “stiffer” in a dried configuration than the structure to which is it applied, will be applied in such a manner as to allow the structure to be bent and/or molded to some degree (i.e., the coating will desirably not appreciably or severely “stiffen” the structure to an undesirable degree), allowing the structure to be formed into a desired enclosure shape and/or to be wrapped around structures and/or formed into flexible bags and/or containers (if desired). Where a bag or similar enclosure (i.e. a closable shape) is provided, the coating may desirably be applied onto/into the item after manufacture thereof, which may include the coating and/or encapsulation of any seams and/or stitched/adhered areas beneath one or more coating layers. In various embodiments, the coating penetration depth will average no more than half of the depth through the material.

Another significant advantage provided by various features of the present invention relates to the construction and arrangement of the individual fibers of the disclosed permeable structures, which grant the structure an ability to “mix” and/or otherwise agitate environmental water within the pores, apertures, voids and/or various openings in the structure weave or knit. This mixing effect can greatly enhance the homogeneity and/or uniformity of the water within and/or after passing through the enclosure. In some embodiments where a biocide coating is provided, this mixing effect can greatly enhance the effectiveness of the eluting biocide, in that the concentration of the biocide may be greatest in water proximate to the pore walls, but can be efficiently mixed into the water stream even before the water leaves the enclosure walls. Such an arrangement can ensure high dosing of biocide to fouling organisms proximate to the pore walls, and also ensures sufficient biocide contact other fouling organisms in the water stream, even at very lower overall biocide dosing levels.

Once coated with the coating or paint, the material and/or enclosure can be allowed to cure and/or air dry for a desired period of time (which may take less than two minutes for some commercial applications, or up to an hour or longer in other embodiments) or may be force dried utilizing gas, oil or electric heating elements. The material and/or enclosure can then be used as described herein.

In at least one exemplary embodiment, an antifouling enclosure can include a flexible fibrous material and/or structure having a coating comprising a biocide which is applied to a first surface of the flexible fibrous material, the flexible fibrous material having a plurality of pores, gaps and/or other openings extending from the first surface to a second surface of the flexible fibrous material, wherein the coating extends into the pores such that the plurality of pores have an average pre-coating minimum pore opening of at least 25 micrometers and an average post-coating minimum pore opening between 75 and 25 micrometers. When this material is placed in a water stream or other liquid flow, the water stream flows through the plurality of pores from the first surface to the second surface and the biocide elutes from the coating into the water stream, the biocide contacting a plurality of biofouling organisms and inhibiting one or more species of the plurality of biofouling organisms from colonizing a substrate surface positioned downstream from the coated structure.

In various embodiments, the enclosure may include an optional biocide agent that is attached to, coated on, encapsulated, integrated into and/or “woven into” the threads of the material. For example, the biocide could be incorporated into strips containing various concentrations of one or more biocides, thus desirably preventing the various plant and animal species from attaching or establishing a presence on and/or in the enclosure. In various embodiments the use of on e or more biocides can provide one of more of the following: (1) biocide to protect the enclosure from fouling, (2) biocide to protect a substrate from fouling, (3) biocide which induces environmental conditions that create an “artificial” biofilm on a substrate and/or within an protected environment, (4) biocide to dose water within the protected environment, and/or (5) biocide that reduces fouling “buildup” on surfaces and/or within pores of a fibrous structure matrix and/or “filter” element.

Other methods of inserting and/or applying a coating or anti-fouling agent, such as the use of spray-on applications as known to one of skill in the coating art, are contemplated. Additionally, the enclosure need not contain individual fibrous elements, but may instead be made of a perforated and/or pliable sheet which contains an agent embedded therein and/or coated on the material. To provide a securing mechanism, the enclosure can include fastening elements, such as but not limited to loop and hook type fasteners, such as VELCRO®, snaps, buttons, clasps, clips, buttons, glue strips, or zippers. If desired, a system can desirably comprise a plurality of wall structures, with each wall structure attached to one or more adjacent wall structures (if any) by stitching, weaving or the like, which may include the coating and/or encapsulation of any seams and/or stitched/adhered areas beneath one or more coating layers to form a modular enclosure. If desired, enclosure material may be added to expand beyond and/or on to the enclosure fastening element to protect the fastening element from fouling.

In alternative embodiments, the enclosure may include closeable and/or openable features such as Velcro or hook and loop fastener components, zippers, magnetic closures and/or cross-stitched features. Similar connection types could be utilized to connect the side edges of individual sheets together or allow removal and replacement of fibrous matrix media from a support frame or other structure.

In various embodiments, the enclosure desirably includes anti-biofouling characteristics, attached to and/or embedded within the threads and/or fibers (i.e., the various elements of the fibrous matrix) to inhibit and/or prevent biofouling of the system. In a preferred embodiment, the anti-biofouling agent is a biocide coating comprising Econea™ (tralopyril—commercially available from Janssen Pharmaceutical NV of Belgium) and/or zinc omadine (i.e., pyrithione), but other anti-biofouling agents currently available and/or developed in the future, such as zinc, copper or derivatives thereof, known to one of skill in the art, may be used. Moreover, antifouling compounds from microorganisms and their synthetic analogs could be utilized, with these different sources typically categorized into ten types, including fatty acids, lactones, terpenes, steroids, benzenoids, phenyl ethers, polyketides, alkaloids, nucleosides and peptides. These compounds may be isolated from seaweeds, algae, fungus, bacteria, and marine invertebrates, including larvae, sponges, worms, snails, mussels, and others. One or more (or various combination thereof) of any of the previously described compounds and/or equivalents thereof (and/or any future developed compounds and/or equivalents thereof) may be utilized to create an anti-biofouling structure which prevents both microfouling, such as biofilm formation and bacterial attachment, and macrofouling, such as attachment of large organisms, including barnacles or mussels, for one or more targeted species, or may be utilized as a more “broad-spectrum” antifoulant for multiple biofouling organisms, if desired.

In one exemplary embodiment, a desirable spun polyester fiber based woven structure can be utilized as an enclosure material, with the structure having a BASIS WEIGHT (weight of the base structure before any coating or modifications are included) of approximately 410 Grams/Meter² (See Table 13).

TABLE 13
Exemplary Structure Specifications

| Structure Name | 100% polyester woven canvas structure (loomstate) | |
|---|---|---|
| Content | 100 Polyester (virgin) | |
| Yarn Count | Warp | 10 s/4 |
| | Filing | 10 s/4 |
| Density | Warp | 20/inch ± 3 |
| | Filing | 20/inch ± 2 |
| Weight | 410 gsm ± 10 g (12.09 OZ/sqy) | |
| Width | 64/65″ | |
| | Overroll | 64/65″ |
| | Cuttable | 63″ |
| | Edge | Plain selvage |

| | |
|---|---|
| Color | Nature white |
| Finishing | None |
| Dyeing | None |
| Washing | None |
| Packing | Rolling with plastic bag inside and weave bag outside |

Table 14 depicts some alternative structure specifications that can be utilized as enclosure materials with varying levels of utility.

TABLE 14
Additional Exemplary Structure Specifications

| | | | | | Weight | Thickness |
|---|---|---|---|---|---|---|
| Style | Yarn size and type | Ends/Courses | Picks/Wales | | oz/yd | inches |
| 61598 | 75.4% 70/36 SD Rd Text Nat Polyester, | 36 cpi | 36 | wpi | 3.68 | 0.0571 |
| | 24.6% 40/24 SD Rd Flat at Polyester | | | | | |
| 61588 | 75.4% 70/36 SD Rd Text Nat Polyester, | 37 cpi | 33.7 | wpi | 3.26 | 0.0205 |
| | 24.6% 40/24 SD Rd Flat at Polyester | | | | | |
| 410G/SM2 | 100% 10 singles, 4 ply spun polyester | 20 epi | 20 | ppi | 12.09 | 0.0482 |
| 235GSM | 100% - 300 den, 4 ply textured polyester | 24 epi | 20 | ppi | 6.93 | 0.0319 |

For various structure or enclosure embodiments, a target add-on weight on the paint/coating could be set from approximately about 5 grams/meter² to 500 grams/meter², from about 50 grams/meter² to 480 grams/meter², from about 100 grams/meter² to 300 grams/meter², from about 120 grams/meter² to 280 grams/meter², from approximately 224 grams/Meter² (or up to ±10% thereof).

In various embodiments where the addition of a biocide or other coating may be desirous, it should be understood that in some embodiments the coating may be applied to the enclosure after the system has been fully assembled and/or constructed, while in other embodiments the coating may be applied to some or all of the components of the system prior to assembly and/or construction. In still other embodiments, some portions of the enclosure could be pre-coated and/or pretreated, while other portions could be coated after assembly. Moreover, where processing and/or treatment steps during the manufacture and/or assembly of the may involve techniques that may negatively affect the quality and/or performance of the biocide or other coating characteristics, it may be desirous to perform those processing and/or treatment steps to the enclosure and/or enclosure components prior to application of the coating thereof. For example, where a heat sensitive biocide and/or coating may be desired, material processing techniques involving elevated temperatures might be employed to create and/or process the structure and/or the enclosure walls before application of the biocide coating thereof (i.e., to reduce the opportunity for heat-related degradation of the biocide and/or coating).

In various embodiments, a coating material or other additive (including a biocide coating or other material) may be applied to and/or incorporated into the structure of the enclosure, potentially resulting in an altered level of permeability, which may convert a material that may be less suitable for protecting a substrate from biofouling to one that is more desirable for protecting a substrate from biofouling once in a coated condition. For example, an uncoated polyester structure, which experimentally demonstrates a relatively high permeability to liquids (i.e., 150 mL of a liquid passed through a test structure in less than 50 seconds), which may be less desirable for forming an enclosure to protect a substrate from biofouling, as described herein. However, when properly coated to a desired level with a biocidal coating, the permeability of the coated structure can be substantially reduced to a much more desirable level, such as a moderately permeable level (i.e., 100 mL of a liquid passed through a test structure in between 50 to 80 seconds) and/or a very low permeability level (i.e., little to no liquid passed through the test structure). In this manner, a deliberate permeability level can optionally be “dialed into” or tuned for each selected structure, if desired.

During immersion testing in an aqueous environment over an extended period of time, one embodiment of an enclosure incorporating a polyester coated structure developed no macrofouling and/or a very minimal coating of macrofouling. Moreover, one example the polyester structure became more permeable during the immersion period, while another example became less permeable during the immersion period.

Fibrous Matrix Materials and/or Dosing Media

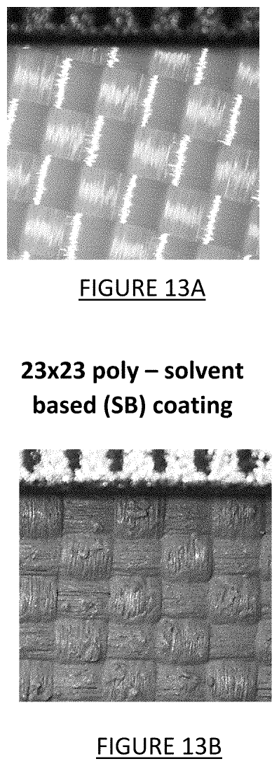

FIG. 13A depicts an exemplary embodiment of an uncoated 23×23 polyester woven structure, which experimentally demonstrated a relatively low permeability to liquids (i.e., 100 mL of a liquid passed through a test structure in approximately 396 seconds), which may be on a low end of a desirable permeability range for forming some enclosure designs to protect a substrate from biofouling, as described herein, depending upon local conditions. When coated (See FIG. 13B), these materials became essentially non-permeable prior to immersion, but became more permeable after immersion. As previously noted, the desired permeability level could be “dialed into” or tuned for each selected structure, if desired. In various embodiment, the permeability of a given structure and/or enclosure components can change or be different in wet or dry conditions, if desired.

During immersion testing in an aqueous environment over an extended period of time, the uncoated 23×23 polyester and coated polyester structures all had no macrofouling on the enclosure and/or the substrate. Moreover, each of these materials experienced a significant increase in permeability during immersion, with the 23×23 uncoated polyester structure allowing passage of 150 mL of liquid in 120 seconds, while the first 23×23 coated polyester structure allowed 150 mL of liquid in 160 seconds and the second 23×23 coated polyester allowed 150 mL of liquid in 180 seconds.

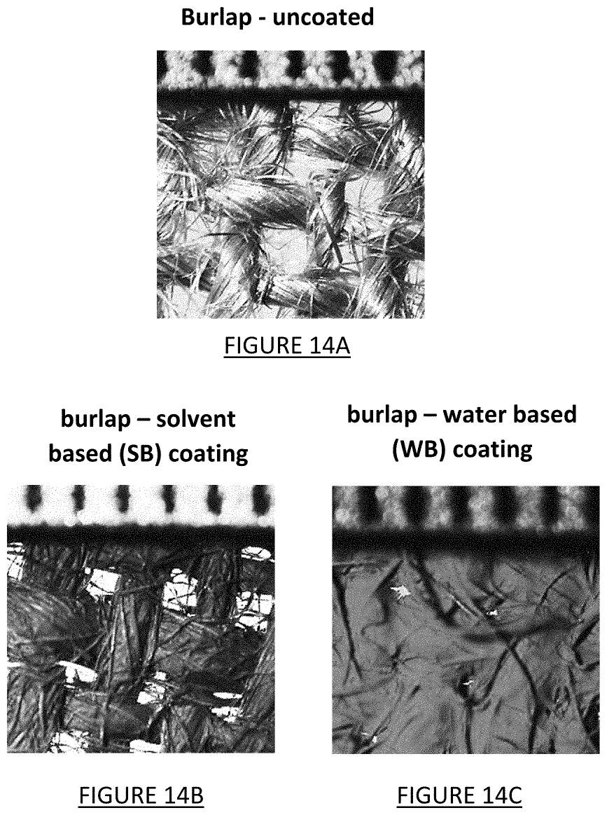

In other alternative embodiments, FIGS. 14A through 14C depict a natural material, burlap, uncoated (FIG. 14A), coated with a solvent based biocidal coating (FIG. 14B) and coated with a water based biocidal coating (FIG. 14C). During permeability testing, the uncoated burlap structure demonstrated a permeability of 50.99 ml/s/cm2, while the coated burlap structures had permeabilities of 52.32 ml/s/cm2 and 38.23 ml/s/cm2, for solvent based biocidal coating and water based biocidal coating, respectively. After 32 days of immersion in salt water, the permeability for both coated structures significantly increased to 85.23 ml/s/cm2 and 87.28 ml/s/cm2, whereas the uncoated burlap structure decreased permeability to 20.42 ml/s/cm2. For fouling observations, uncoated burlap structures experienced very minimal fouling and the coated burlap structures experiencing virtually no macrofouling.

Additionally, in another alternative embodiment, a 1/64 polyester uncoated structure was coated with a solvent based biocidal coating, and alternatively coated with a water based biocidal coating. During permeability testing, the uncoated 1/64 polyester structure demonstrated a permeability of 26.82 ml/s/cm2, while the coated 1/64 polyester structures had permeabilities of 44.49 ml/s/cm2 and 29.25 ml/s/cm2, for solvent based biocidal coating and water based biocidal coating, respectively. After 32 days of immersion in salt water, the permeability for all 1/64 polyester structures significantly decreased to 10.99 ml/s/cm2, 13.78 ml/s/cm2 and 13.31 ml/s/cm2, respectively. For fouling observations, uncoated 1/16 polyester structures experienced some fouling, whereas the coated 1/64 polyester structures experiencing virtually no macrofouling.

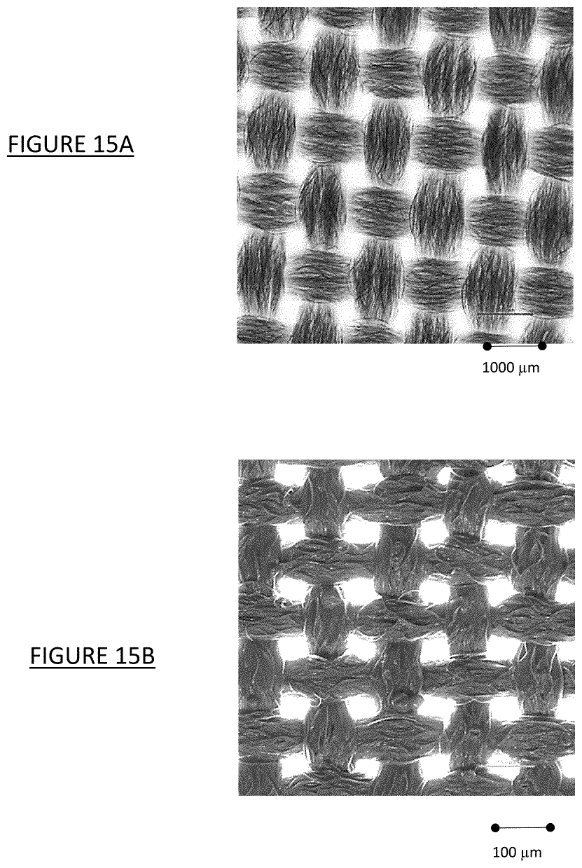

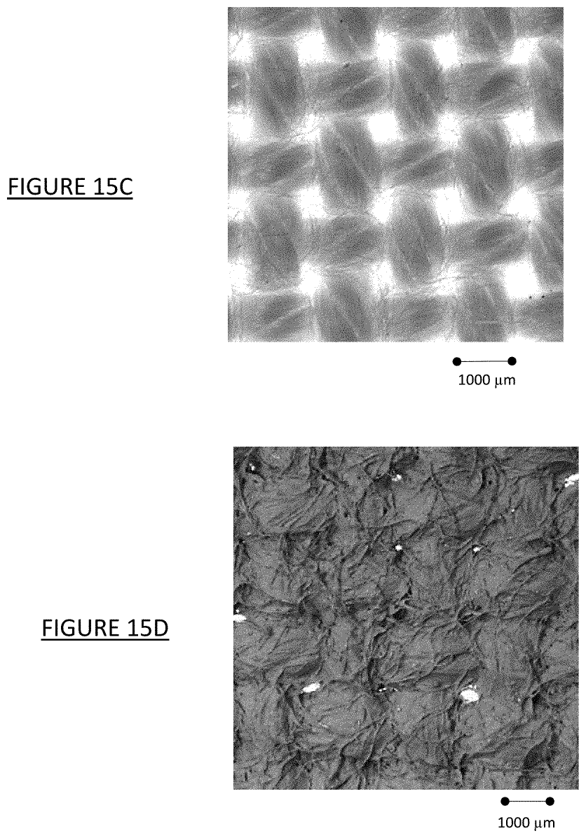

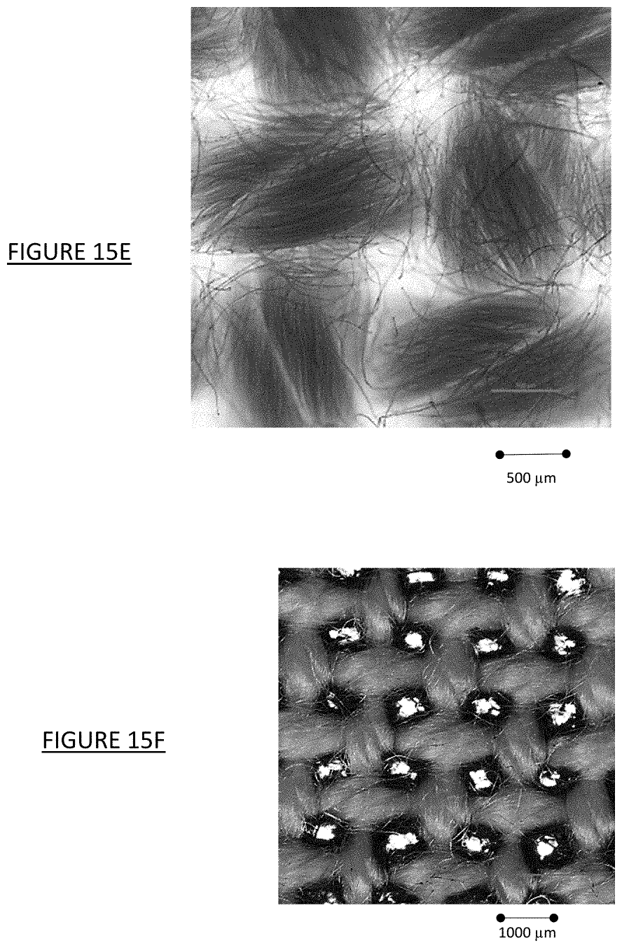

Different varieties of structure cloth were manufactured, coated and utilized in the construction and testing of anti-biofouling enclosures. In a first embodiment (shown in FIG. 15A with a scale bar of 1000 μm), a textured polyester cloth was coated with a biocide coating on a first surface, with a significant amount of this coating penetrating completely through the cloth to the opposing second surface (with some areas of coating on the second surface being thinner than in other areas). FIG. 15B depicts this coated cloth at a bar scale of 1000 μm. On average, this coated cloth had 523.54 (±2.33) pores/in², with approximately less than 5 percent of the pores occluded (on average).

FIG. 15C depicts another preferred embodiment of a 100% spun polyester structure, with FIG. 15D depicting this structure coated with a biocidal coating. During testing, the uncoated 100% polyester structure demonstrated a permeability of 10.17 ml/s/cm² of the structure, while the coated poly structures had permeabilities of 0.32 ml/s/cm² and 1.08 ml/s/cm². After 23 days of immersion, the permeability for both coated structures were not significantly changed, with the uncoated poly structure experiencing very minimal fouling and the coated poly structures experiencing virtually no macrofouling. In various other embodiments, however, other approaches to preparing spun polyester yarn, such as core-spinning staple fiber around a continuous core, open end spinning, ring spinning, and/or air jet spinning are anticipated to yield favorable results as well.

In another embodiment (the uncoated structure shown in FIG. 15E with a scale bar of 500 μm), a spun polyester cloth was subsequently coated with a biocide coating on a first surface, with a significant amount of this coating penetrating partially through the fibers and/or pores of the cloth (in some embodiments, up to or exceeding 50% penetration through the cloth). FIG. 15F shows the opposing uncoated side of the structure at 1000 μm, with this figure also demonstrating the significant pore size reduction that can be accomplished using this coating technique, if desired. On average, this coated cloth had 493 (±3.53) pores/in², with approximately 7 to 10 percent of the pores fully occluded by the coating material (on average).

Experimentally, all of these structure embodiments demonstrated desirable levels of permeability, which may be due to the high number of small pores, the smaller size of the fibers, and or various combinations thereof. The various coating methods were very effective in coating and penetrating the structure to a desired level and produced a highly effective material for incorporation into a protective enclosure.

Disclosed herein are a variety of structures potentially suitable for use in various embodiments of the present invention, with exemplary permeabilities of these structures in uncoated and coated states. For example, in Port Canaveral Harbor (Port Canaveral, Fla., USA), it was experimentally determined that a permeability range of 0.5 ml/s/cm² to 25 ml/s/cm² to 50 ml/s/cm² to 75 ml/s/cm² to 100 ml/s/cm² or from about 0.1 ml/s/cm² to about 100 ml/s/cm², cm² or from about 1 ml/s/cm² to about 75 ml/s/cm², or from about 1 ml/s/cm² to about 10 ml/s/cm², or from about 1 ml/s/cm² to about 5 ml/s/cm², or from about 5 ml/s/cm² to about 10 ml/s/cm², or from about 10 ml/s/cm² to about 20 ml/s/cm², or from about 10 ml/s/cm² to about 25 ml/s/cm², or from about 10 ml/s/cm² to about 50 ml/s/cm², or from about 20 ml/s/cm² to about 70 ml/s/cm², or from about 10 ml/s/cm² to about 40 ml/s/cm², or from about 20 ml/s/cm² to about 60 ml/s/cm², or from about 75 ml/s/cm² to about 100 ml/s/cm², or from about 60 ml/s/cm² to about 100 ml/s/cm², or from about 10 ml/s/cm² to about 30 ml/s/cm², might be sufficient (depending upon local conditions) to prevent significant amounts of fouling from occurring on and/or within the enclosure and/or on the protected substrate, while still allowing sufficient water flow. In another exemplary embodiment, a permeability range of at least 0.32 ml/s/cm², and up to 10.17 ml/s/cm² was determined to be an optimal range of desirable permeability characteristics and/or a desired range of anticipated permeability changes during the life of the enclosure. In other embodiments, a range of at least 1.5 ml/s/cm², and up to 8.0 ml/s/cm² may be desirous (as well as any combination of the various ranges disclosed herein). In many cases, because the specific fouling organisms, the incidence of fouling incursion and/or rate of fouling growth in a given region and/or water body can be highly dependent upon a multiplicity of interrelated factors, as well as the local and/or seasonal conditions of the intended area of use (and the intended substrate to be protected, among other things), the acceptable ranges of permeability for a given structure in a given enclosure design may vary widely—thus a structure permeability that may be optimal and/or suitable for one enclosure design and/or location may be less optimal and/or unsuitable for another enclosure design and/or location. Accordingly, the desired permeability values and ranges thereof should be interpreted as general trends of the ability of a given structure and/or permeability to provide antifouling protection while avoiding extended periods of anoxic conditions, and anerobic corrosion, in a given body of water, but should not be interpreted as precluding the use of a given structure in other enclosure designs and/or water conditions.

In various embodiments, the permeability of fibrous matrix media and/or enclosure materials can desirably be maintained within a desired range of permeabilities over its useful life in situ (or until the desired biofilm layer has been established, if desired), such that any potential increases in the permeability of the material due to changes in the structure and/or materials of the enclosure (as one example) would desirably approximate various expected decreases in the material's permeability due to clogging of the pores by organic and/or inorganic debris (including any biofouling of the material and/or its pores that may occur). This equilibrium will desirably maintain the integrity and/or functioning of the enclosure and the characteristics of the differentiated environment over an extended period of time, providing significant protection for the enclosure and/or the protected substrate.

In various embodiments, the enclosure walls may incorporate a variety of materials that experience permeability changes during immersion testing in an aqueous environment over an extended period of time. For example, uncoated synthetic materials may generally become less permeable over time (which may be due to progressive fouling of the structure once positioned around a substrate; however, discounting initial swelling of structure and biocide, and biofouling the permeability should be maintained or increase as the coating sloughs or dissolute), while some materials coated with biocidal coatings can undergo a variety of permeability changes, including some embodiments becoming less permeable over time. In addition, a natural test fiber (Burlap) in an uncoated state became more permeable, while biocide coated burlap became less permeable over time. In various embodiments, varying of coating parameters (i.e., coating add-on/thickness, application methods, vacuum application to maintain and/or increase pore size, drying parameters, etc.) and varying textile parameters (i.e., construction, materials, initial permeability, constrained during drying or not, heat set or not, etc.) can make it possible to produce a broad range of desirable permeability characteristics as well as anticipated permeability changes during the life of a given enclosure design. When deployed into the aqueous environment, it is thus possible to influence (and/or control) whether the permeability increases or decreases over time for some extended period(s), as well as the associated correlation with product life cycle.

In various embodiments, the enclosure can desirably inhibit biofouling on a substrate at least partially submerged in an aquatic environment, with the enclosure including a material which is or becomes water permeable during use, said enclosure adapted to receive said substrate and form a differentiated aquatic environment which extends from a surface of the substrate to at least an interior/exterior surface of the structure, wherein said structure or portions thereof has a water permeability, upon positioning the structure about the substrate or thereafter, with a flux of about 100 milliliters of water per second per square centimeter of substrate, of about 100 milliliters of water per minute per square centimeter of substrate, or values therebetween, or greater/lesser permeabilities.

In various embodiments, water permeability of a structure may be achieved by forming the structure to allow water to permeate there through, such as by weaving a textile to have a desired permeability and/or optionally coating a textile with a biocide coating (or non-biocide containing coating) that provides the textile with a desired permeability. In some embodiments, the structure may be designed to become water permeable over time as it is used. For example, an otherwise water permeable structure may have a coating that initially makes it substantially non-permeable, but as the coating ablates, erodes, or dissolves, the underlying permeability increases and/or becomes useful.

System Component Assembly

In various embodiments, a system may comprise a single enclosure or may comprise multiple modular pieces that can be assembled in a variety of system shapes, sizes and/or capabilities. For example, a system design can desirably comprise a plurality of antifouling wall structures, with each wall structure attached and/or assembled to one or more adjacent wall structures (if any) by stitching, weaving, hook and loop fasteners, Velcro, and/or the like, which may include the coating and/or encapsulation of any seams and/or stitched/adhered areas. Alternatively, other connecting techniques such as heat bonding, ultrasonic welding and/or other energy-based bonding techniques, gluing or adhesives, as well as other stitching and/or two-dimensional weaving/knitting techniques, may be utilized as desired. In other alternative embodiments, three-dimensional structure forming techniques may be used to create a “tube” or bag of material for the enclosure which has no external facing seams on the sides and/or which only has one or more seams and/or openings at the top and/or bottom. In some particularly desirable embodiments, the attachment and/or adhering of various wall section of the enclosure will preferably be accomplished such that some level of flexibility in the attachment region is maintained.

In a similar manner, various embodiments of the enclosure will desirably incorporate permeable and/or flexible attachment mechanisms and/or closures, such that relatively hard, unbroken and/or impermeable surfaces will desirably not be presented externally to the surrounding aqueous environment by the enclosure. In many cases, biofouling entities may prefer a hard, unbroken surface for settlement and/or colonization, which can provide such entities a “foothold” for subsequent colonization on adjacent flexible structure sections such as those of the enclosures described herein. By reducing the potential for such “foothold” locations, many of the disclosed enclosure designs can significantly improve the biofouling resistance of various of the disclosed embodiments and/or the substrate protection provided thereof. In at least one embodiment, an enclosure can be particularized for a substrate that is made as a single construction with no seams and/or no impermeable wall sections.

In the case of hook and loop or “Velcro” fasteners, the employment of such connecting devices may be particularly well suited for various enclosure embodiments, in that such fasteners can be permeable to the aqueous medium in a manner similar to the permeable enclosure walls. Such design features may allow liquid within the enclosure to elute through the fastener components and/or enclosure walls in a similar manner, thereby inhibiting fouling of the fastener surfaces as described herein. Alternatively, the connective “flap” of a flexible hook and loop fastener may be placed over a corresponding flexible or non-flexible attachment surface to provide additional protection to the attachment surface.

In various embodiments, structure permeability may be affected and/or altered by a variety of techniques, including mechanical processing, such as by the use of piercing devices (i.e., needles, laser cutting, stretching to create micropores, etc.), abrading materials and/or the effects of pressure and/or vacuum (i.e., water and/or air jets), or chemical means (i.e., etching chemistry). In a similar manner, a low permeability structure could be treated to desirably increase permeability of the structure to within a desired range, while in other embodiments a higher permeability structure could be modified (by using a paint, coating, clogging or clotting agent, for example) to lower permeability a desired amount.

In many embodiments, the type and/or level of permeability of a selected enclosure wall material or materials will be a significant consideration in the design and placement of the enclosure and/or various enclosure components. At the time of initial placement of the enclosure in the aqueous medium, the permeable material will desirably allow sufficient water exchange to occur between the open environment and the enclosed and/or bounded environment to allow the differentiated environment which protects against the formation of biofouling. However, because various fouling pressures and/or other factors can potentially alter and/or otherwise affect the permeability and/or porousness of a given enclosure wall material over time in the aqueous medium, it is often important that the permeable material continues to allow a desired level of water exchange that maintains the differentiated environment—and which also desirably avoids long term anoxia from occurring within some enclosure embodiments. In accordance with these concerns, it may be desirable to select a higher level of permeability for an enclosure wall material, such that clogging and/or closure of some of the pores in the material should not significantly affect the anti-fouling performance of the enclosure, even though the rate of water exchange may decrease, increase and/or remain the same at different time during the useful life of the enclosure.

System Placement and Spacing

In use, a system such as described herein will desirably be positioned upstream and/or within a fluid flow path in contact with and/or around a substrate immersed in an aqueous medium. This could include the protection of an object before the object is initially immersed in the aqueous medium for the first time (i.e., an object's “virgin” immersion into the aqueous environment), as well as the protection of a previously immersed object that was removed from the aqueous medium and cleaned and/or descaled. In other embodiments, the system may be installed to protect an object already immersed in the aqueous environment, including objects that may have been previously immersed for extended periods of time and/or already having significant amounts of biofouling thereupon.

Non-limiting examples of substrates include, any substrate or material used with or in combination or in conjunction with any consumption of water, such as, large water consumption using a water intake system. Non-limiting examples of substrate uses with water consumption include any water intake system for commercial or industrial applications or any material or substrate downstream from a water intakes, such as, filtration system equipment, such as, marine or fresh water filtration systems, membrane filters, water inlet filters, piping and/or storage tanks; lifts and boat storage structures; irrigation water storage tanks and irrigation piping and/or equipment; and/or any portions thereof, including water management systems and/or system components, such as locks, dams, valves, flood gates and seawalls; waste water systems; reserve osmosis water systems; commercial water plants; water systems used for structure heating, injecting, processing, washing, diluting, cooling, and/or transporting; smelting facility systems, petroleum refineries and industries producing chemical products, food, and paper products. Other mechanisms impacted by biofouling that may be addressed using the present disclosure include microelectrochemical drug delivery devices, papermaking and pulp industry machines, underwater instruments, fire protection system piping, and sprinkler system nozzles. Besides interfering with mechanisms, biofouling also occurs on the surfaces of living marine organisms, when it is known as epibiosis. Biofouling is also found in almost all circumstances where water-based liquids are in contact with other materials. Industrially important impacts are on the maintenance of agriculture, membrane systems (e.g., membrane bioreactors and reverse osmosis spiral wound membranes) and water cycles of large equipment and power stations. Biofouling can also occur in oil pipelines carrying oils with entrained water, especially those carrying used oils, cutting oils, oils rendered water-soluble through emulsification, and hydraulic oils.

In various embodiments, the substrate(s) to be protected may be a surface or subsurface portion made of any material, including but not limited to metal surfaces, fiberglass surfaces, PVC surfaces, plastic surfaces, rubber surfaces, wood surfaces, concrete surfaces, glass surfaces, ceramic surfaces, natural structure surfaces, synthetic structure surfaces and/or any combinations thereof.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

All references, including publications, patent applications, and patents, cited herein are hereby incorporated by reference to the same extent as if each reference were individually and specifically indicated to be incorporated by reference and were set forth in its entirety herein.

The various headings and titles used herein are for the convenience of the reader and should not be construed to limit or constrain any of the features or disclosures thereunder to a specific embodiment or embodiments. It should be understood that various exemplary embodiments could incorporate numerous combinations of the various advantages and/or features described, all manner of combinations of which are contemplated and expressly incorporated hereunder.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., i.e., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A device for reducing biofouling in a water system, the device comprising:
a treatment unit comprising:
a reservoir for holding a volume of water therein;
at least one layer of a permeable fabric structure positioned within or defining a portion of a wall of the reservoir, wherein the permeable fabric structure comprises an outer surface, an inner surface and a plurality of pores extending therebetween, the permeable fabric structure having a biocide coating on one or more of the outer surface or the inner surface and extending within at least a portion of at least one of the plurality of pores; and
an outlet for providing conditioned water from the reservoir to a water intake of the water system, wherein all of the water passing through the water system passes through the treatment unit,
the conditioned water requiring an average dwell time to stay within the reservoir of the treatment unit before traveling through the outlet and into the water system,
wherein the biocide coating contacts the water entering into or within the reservoir of the treatment unit so as to cause changes in the water chemistry and form the conditioned water prior to the conditioned water traveling through the outlet and into the water system such that biofouling is reduced in the water system downstream of the treatment unit.

2. The device of claim 1, wherein the coated permeable fabric structure within the treatment unit has a permeability with the range of 5 milliliters of water per second per square centimeter to 100 milliliters of water per second per square centimeter.

3. The device of claim 1, wherein the at least one layer of the permeable fabric structure comprises a 3-dimensional flexible material selected from the group consisting of natural and synthetic fabrics, natural and synthetic membranes, natural and synthetic sheets, and fabrics, membranes, films and sheets made from a combination of natural and synthetic materials.

4. The device of claim 1, wherein a dissolved oxygen content of the water entering the reservoir of the treatment unit is similar to a dissolved oxygen content of the conditioned water travelling through the outlet and into the water system.

5. The device of claim 1, wherein a dissolved oxygen content of the water entering the reservoir of the treatment unit is higher than a dissolved oxygen content of the conditioned water travelling through the outlet and into the water system.

6. The device of claim 1, wherein the water system comprises a once-through system.

7. The device of claim 1, wherein the water system comprises a recirculation system.

8. The device of claim 1, wherein the water system comprises a make-up water circuit of a recirculation system.

9. The device of claim 1, wherein the average dwell time is an average amount of time a molecule of the water spends within the reservoir between entering the reservoir and traveling through the outlet.

10. The device of claim 1, wherein the average dwell time is determined based on a size of the reservoir divided by an average flow rate through the outlet determined over a period of an hour during operation of the water system.

11. The device of claim 10, wherein the average dwell time is within a range of 1 minute to 6 hours.

12. The device of claim 10, wherein the average dwell time is 1 minute or less.

13. The device of claim 10, wherein the average dwell time is greater than 6 hours.

14. The device of claim 1, wherein at least a portion of the conditioned water does not necessarily pass through any of the plurality of pores of the permeable fabric structure.

15. The device of claim 1, wherein the reservoir is positioned within a body of water and the outlet is configured to draw conditioned water from within the reservoir such that water from the body of water is pulled into the reservoir to fill the reservoir to replace the conditioned water taken through the outlet.

16. The device of claim 15, wherein the reservoir defines an inlet portion for which the water from the body of water is pulled through, wherein the inlet portion comprises the at least one layer of the permeable fabric structure such that the water from the body of water is pulled through the at least one layer of the permeable fabric structure.

17. The device of claim 16, wherein the at least one layer of the permeable fabric structure forms the inlet portion of the reservoir and is replaceable.

18. The device of claim 1, wherein the treatment unit further includes one or more preconditioning features that are configured to adjust water chemistry of the water within the reservoir.

19. The device of claim 1, wherein the at least one layer of the permeable fabric structure comprises a plurality of permeable fabric structures positioned in a tortious path leading to the outlet.

20. The device of claim 1, wherein the permeable fabric structure is attached to a floatable device such that the permeable fabric structure extends downwardly from the floatable device into the water.

21. The device of claim 20, wherein the reservoir is formed within a body of water by at least partial enclosure formed by the at least one layer of permeable fabric structure that is attached to a floatable device.

22. A method for reducing biofouling in a water system, the method comprising:
providing a treatment unit comprising:
a reservoir for holding a volume of water therein;
at least one layer of a permeable fabric structure positioned within or defining a portion of a wall of the reservoir, wherein the permeable fabric structure comprises an outer surface, an inner surface and a plurality of pores extending therebetween, the permeable fabric structure having a biocide coating on one or more of the outer surface or the inner surface and extending within at least a portion of at least one of plurality of pores; and
an outlet for providing conditioned water from the reservoir to a water intake of the water system, wherein all of the water passing through the water system passes through the treatment unit,
the conditioned water requiring an average dwell time to stay within the reservoir of the treatment unit before traveling through the outlet and into the water system,
wherein the biocide coating contacts the water entering into or within the reservoir of the treatment unit so as to cause changes in the water chemistry and form the conditioned water prior to the conditioned water traveling through the outlet and into the water system such that biofouling is reduced in the water system downstream of the treatment unit; and
causing conditioned water to travel through the outlet of the treatment unit and into the water intake of the water system.

23. The method of claim 22, wherein a dissolved oxygen content of water entering the reservoir of the treatment unit is higher than a dissolved oxygen content of the conditioned water travelling through the outlet and into the water system.

24. A water system comprising:
a treatment unit comprising:
a reservoir for holding a volume of water therein;
at least one layer of a permeable fabric structure positioned within or defining a portion of a wall of the reservoir, wherein the permeable fabric structure comprises an outer surface, an inner surface and a plurality of pores extending therebetween, the permeable fabric structure having a biocide coating on one or more of the outer surface or the inner surface and extending within at least a portion of at least one of plurality of pores; and
an outlet for providing conditioned water from the reservoir to a water intake of the water system, wherein all of the water passing through the water system passes through the treatment unit,
the conditioned water requiring an average dwell time to stay within the reservoir of the treatment unit before traveling through the outlet and into the water system,
wherein the biocide coating contacts the water entering into or within the reservoir of the treatment unit so as to cause changes in the water chemistry and form the conditioned water prior to the conditioned water traveling through the outlet and into the water system such that biofouling is reduced in the water system downstream of the treatment unit.
